(19) United States
(12) Patent Application Publication
(10) Pub. No.: US 2026/0038433 A1
(43) Pub. Date: Feb. 5, 2026

(54) DRIVING CIRCUIT, DISPLAY SUBSTRATE AND DISPLAY DEVICE

(71) Applicant: BOE TECHNOLOGY GROUP CO., LTD., Beijing (CN)

(72) Inventors: Xiyu ZHAO, Beijing (CN); Tuo SUN, Beijing (CN); Li WANG, Beijing (CN); Xuliang ZHAO, Beijing (CN)

(73) Assignee: BOE TECHNOLOGY GROUP CO., LTD., Beijing (CN)

(21) Appl. No.: 18/997,053

(22) PCT Filed: Apr. 18, 2024
(86) PCT No.: PCT/CN2024/088485

§ 371 Date: Jan. 18, 2025

(30) Foreign Application Priority Data
May 29, 2023 (CN) 202310621409.4

(51) Int. Cl. G09G 3/3225

(52) U.S. Cl. CPC G09G 3/3225; G09G 2300/0426; G09G 2300/0852; G09G 2310/0245; G09G 2310/08; G09G 2320/041

(57) ABSTRACT

A drive circuit, a display substrate and a display device. The drive circuit includes a driving signal generating circuit, a control signal generating circuit and a control circuit. The driving signal generating circuit is used to generate an n-th stage driving signal, n is a positive integer; the control signal generating circuit is used to generate a control signal according to an enable signal; the control circuit is used to output the n-th stage driving signal or invalid voltage signal to the n-th stage driving output terminal under control of the control signal. According to the present disclosure, the n-th stage driving signal or the invalid voltage signal can be accurately output to the n-th stage driving output terminal, thereby accurately performing local refresh.

### CROSS-REFERENCE TO RELATED APPLICATION

The present application is filed based on and claims the priority of Chinese Application No. 202310621409.4 filed on May 29, 2023, the disclosure of which are incorporated in their entireties by reference herein.

### TECHNICAL FIELD

The present disclosure relates to the field of display technologies, and in particular to a driving circuit, a display substrate and a display device.

### BACKGROUND

In the related art, a driving circuit usually includes a driving signal generating circuit and a control circuit directly controlled by an enable signal. When a pulse width of an n-th stage driving signal provided by the driving signal generating circuit is 1H (1H is a row scanning time), the control circuit directly controlled by the enable signal can be used to control an output of the n-th stage driving signal or an invalid voltage signal. However, with development of pixels, signals for controlling pixels are diversified, and the pulse width of the n-th stage driving signal will exceed 1H, causing waveform of the n-th stage driving signal to cross a changing edge (rising edge or falling edge) of the enable signal, resulting in only part of the n-th stage driving signal being able to be output, which will cause abnormal pixel operation.

### SUMMARY

A main object of the present disclosure is to provide a driving circuit, a display substrate and a display device, which can solve the problem that local refresh cannot be accurately performed in related display panels.

In a first aspect, one embodiment of the present disclosure provides a driving circuit, including: a driving signal generating circuit, a control signal generating circuit and a control circuit;
wherein the driving signal generating circuit is electrically connected to an n-th stage driving signal output terminal, and is used to generate and output an n-th stage driving signal through the n-th stage driving signal output terminal; n is a positive integer;
the control signal generating circuit is electrically connected to an enable signal line and a control signal terminal, and is used to generate a control signal according to an enable signal provided by the enable signal line and output the control signal through the control signal terminal;
the control circuit is electrically connected to the control signal terminal, the n-th stage driving signal output terminal and an n-th stage driving output terminal respectively, and is used to output the n-th stage driving signal or invalid voltage signal to the n-th stage driving output terminal under control of the control signal.

Optionally, the driving circuit according to at least one embodiment of the present disclosure further includes an output inverting circuit;
wherein the output inverting circuit is electrically connected to the n-th stage driving signal output terminal and the n-th stage inverting signal output terminal respectively, and is used to invert the n-th stage driving signal to obtain and output an n-th stage inverting driving signal through the n-th stage inverting signal output terminal.

Optionally, the control circuit includes a first control circuit, a second control circuit, a third control circuit, a first energy storage circuit, and a second energy storage circuit;
the first control circuit is electrically connected to the control signal terminal, a first-voltage line, a second-voltage line and a first control output terminal respectively, and is used to invert the control signal to obtain an inverting control signal, and output the inverting control signal through the first control output terminal;
the second control circuit is electrically connected to the n-th stage driving signal output terminal, the first-voltage line, the first control output terminal and the second control output terminal respectively, and is used to control the second control output terminal to be coupled to the first-voltage line or the first control output terminal under control of the n-th stage driving signal; or, the second control circuit is electrically connected to the n-th stage driving signal output terminal, the first control output terminal, the second control output terminal and the second-voltage line respectively, and is used to control the second control output terminal to be coupled to the second-voltage line or the first control output terminal under control of the n-th stage driving signal;
the third control circuit is electrically connected to the second control output terminal, the first-voltage line, the second-voltage line and the n-th stage driving output terminal respectively, and is used to invert a signal output by the second control output terminal, and output an inverting signal through the n-th stage driving output terminal;
the first energy storage circuit is electrically connected to the control signal terminal and is used to maintain a potential of the control signal terminal;
the second energy storage circuit is electrically connected to the second control output terminal, and is used to maintain a potential of the second control output terminal.

Optionally, the control circuit includes a first control circuit, a second control circuit, a third control circuit, a fourth control circuit, and a second energy storage circuit;
the first control circuit is electrically connected to the control signal terminal, a first-voltage line, a second-voltage line and a first control output terminal respectively, and is used to invert the control signal to obtain an inverting control signal, and output the inverting control signal through the first control output terminal;
the second control circuit is electrically connected to the n-th stage driving signal output terminal, the first control output terminal, a second control output terminal and a second-voltage line respectively, and is used to control the second control output terminal to be connected to the second-voltage line or the first control output terminal under control of the n-th stage driving signal;
the third control circuit is electrically connected to the second control output terminal, the first-voltage line, the second-voltage line and the n-th stage driving output terminal respectively, and is used to invert a signal output by the second control output terminal, and output an inverting signal through the n-th stage driving output terminal;
the second energy storage circuit is electrically connected to the second control output terminal, and is used to maintain a potential of the second control output terminal.

Optionally, the control signal generating circuit is further electrically connected to a (n−1)-th stage driving signal output terminal, a (n−1)-th stage inverting signal output terminal, an n-th stage driving signal output terminal and an n-th stage inverting signal output terminal, respectively, and is used to control connection or disconnection between the enable signal line and the control signal terminal under control of a (n−1)-th stage driving signal, a (n−1)-th stage inverting driving signal, an n-th stage driving signal and an n-th stage inverting driving signal.

Optionally, the first control circuit includes a first control transistor, a second control transistor, a third control transistor and a fourth control transistor; the second control circuit includes a fifth control transistor and a sixth control transistor; the third control circuit includes a seventh control transistor and an eighth control transistor; the first energy storage circuit includes a first capacitor; and the second energy storage circuit includes a second capacitor;
a gate electrode of the first control transistor is electrically connected to the control signal terminal, a first electrode of the first control transistor is electrically connected to the first-voltage line, and a second electrode of the first control transistor is electrically connected to the first control output terminal;
a gate electrode of the second control transistor is electrically connected to the control signal terminal, a first electrode of the second control transistor is electrically connected to the first control output terminal, and a second electrode of the second control transistor is electrically connected to the second-voltage line;
a gate electrode of the third control transistor is electrically connected to the first control output terminal, a first electrode of the third control transistor is electrically connected to the first-voltage line, and a second electrode of the third control transistor is electrically connected to the control signal terminal;
a gate electrode of the fourth control transistor is electrically connected to the first control output terminal, a first electrode of the fourth control transistor is electrically connected to the control signal terminal, and a second electrode of the fourth control transistor is electrically connected to the second-voltage line;
a gate electrode of the fifth control transistor and a gate electrode of the sixth control transistor are both electrically connected to an n-th stage driving signal output terminal, a first electrode of the fifth control transistor is electrically connected to the first-voltage line, and a second electrode of the fifth control transistor is electrically connected to the second control output terminal;
a first electrode of the sixth control transistor is electrically connected to the second control output terminal, and a second electrode of the sixth control transistor is electrically connected to the first control output terminal;
a gate electrode of the seventh control transistor is electrically connected to the second control output terminal, a first electrode of the seventh control transistor is electrically connected to the first-voltage line, and a second electrode of the seventh control transistor is electrically connected to the n-th stage driving output terminal;
a gate electrode of the eighth control transistor is electrically connected to the second control output terminal, a first electrode of the eighth control transistor is electrically connected to the n-th stage driving output terminal, and a second electrode of the eighth control transistor is electrically connected to the second-voltage line;
a first electrode plate of the first capacitor is electrically connected to the second-voltage line, and a second electrode plate of the first capacitor is electrically connected to the control signal terminal;
a first electrode plate of the second capacitor is electrically connected to the second control output terminal, and a second electrode plate of the second capacitor is electrically connected to the second-voltage line;
the first control transistor, the third control transistor, the fifth control transistor and the seventh control transistor are all p-type transistors, and the second control transistor, the fourth control transistor, the sixth control transistor and the eighth control transistor are all n-type transistors.

Optionally, the control signal generating circuit includes a ninth control transistor, a tenth control transistor, an eleventh control transistor and a twelfth control transistor;
a gate electrode of the ninth control transistor is electrically connected to the (n−1)-th stage inverting signal output terminal, a first electrode of the ninth control transistor is electrically connected to the enable signal line, and a second electrode of the ninth control transistor is electrically connected to a first electrode of the eleventh control transistor;
a gate electrode of the tenth control transistor is electrically connected to the (n−1)-th stage driving signal output terminal, a first electrode of the tenth control transistor is electrically connected to the enable signal line, and a second electrode of the tenth control transistor is electrically connected to a first electrode of the eleventh control transistor;
a gate electrode of the eleventh control transistor is electrically connected to the n-th stage driving signal output terminal, and a second electrode of the eleventh control transistor is electrically connected to the control signal terminal;
a gate electrode of the twelfth control transistor is electrically connected to the n-th stage inverting signal output terminal, a first electrode of the twelfth control transistor is electrically connected to a first electrode of the eleventh control transistor, and a second electrode of the twelfth control transistor is electrically connected to the control signal terminal;
the ninth control transistor and the eleventh control transistor are p-type transistors, and the tenth control transistor and the twelfth control transistor are n-type transistors.

Optionally, the first control circuit includes a first control transistor, a second control transistor, a third control transistor and a fourth control transistor; the second control circuit includes a fifth control transistor and a sixth control transistor; the third control circuit includes a seventh control transistor and an eighth control transistor; the first energy storage circuit includes a first capacitor; and the second energy storage circuit includes a second capacitor;
a gate electrode of the first control transistor is electrically connected to the control signal terminal, a first electrode of the first control transistor is electrically connected to the first-voltage line, and a second electrode of the first control transistor is electrically connected to the first control output terminal;
a gate electrode of the second control transistor is electrically connected to the control signal terminal, a first electrode of the second control transistor is electrically connected to the first control output terminal, and a second electrode of the second control transistor is electrically connected to the second-voltage line;
a gate electrode of the third control transistor is electrically connected to the first control output terminal, a first electrode of the third control transistor is electrically connected to the first-voltage line, and a second electrode of the third control transistor is electrically connected to the control signal terminal;
a gate electrode of the fourth control transistor is electrically connected to the first control output terminal, a first electrode of the fourth control transistor is electrically connected to the control signal terminal, and a second electrode of the fourth control transistor is electrically connected to the second-voltage line;
a gate electrode of the fifth control transistor and a gate electrode of the sixth control transistor are both electrically connected to the n-th stage driving signal output terminal, a first electrode of the fifth control transistor is electrically connected to the first control output terminal, and a second electrode of the fifth control transistor is electrically connected to the second control output terminal;
a first electrode of the sixth control transistor is electrically connected to the second control output terminal, and a second electrode of the sixth control transistor is electrically connected to the second-voltage line;
a gate electrode of the seventh control transistor is electrically connected to the second control output terminal, a first electrode of the seventh control transistor is electrically connected to the first-voltage line, and a second electrode of the seventh control transistor is electrically connected to the n-th stage driving output terminal;
a gate electrode of the eighth control transistor is electrically connected to the second control output terminal, a first electrode of the eighth control transistor is electrically connected to the n-th stage driving output terminal, and a second electrode of the eighth control transistor is electrically connected to the second-voltage line;
a first electrode plate of the first capacitor is electrically connected to the second-voltage line, and a second electrode plate of the first capacitor is electrically connected to the control signal terminal;
a first electrode plate of the second capacitor is electrically connected to the second control output terminal, and a second electrode plate of the second capacitor is electrically connected to the second-voltage line;
the first control transistor, the third control transistor, the fifth control transistor and the seventh control transistor are all p-type transistors, and the second control transistor, the fourth control transistor, the sixth control transistor and the eighth control transistor are all n-type transistors.

Optionally, the control signal generating circuit includes a ninth control transistor, a tenth control transistor, an eleventh control transistor and a twelfth control transistor;
a gate electrode of the ninth control transistor is electrically connected to the n-th stage inverting signal output terminal, a first electrode of the ninth control transistor is electrically connected to the enable signal line, and a second electrode of the ninth control transistor is electrically connected to a first electrode of the eleventh control transistor;
a gate electrode of the tenth control transistor is electrically connected to the n-th stage driving signal output terminal, a first electrode of the tenth control transistor is electrically connected to the enable signal line, and a second electrode of the tenth control transistor is electrically connected to a first electrode of the eleventh control transistor;
a gate electrode of the eleventh control transistor is electrically connected to the (n−1)-th stage driving signal output terminal, and a second electrode of the eleventh control transistor is electrically connected to the control signal terminal;
a gate electrode of the twelfth control transistor is electrically connected to the (n−1)-th stage inverting signal output terminal, a first electrode of the twelfth control transistor is electrically connected to the first electrode of the eleventh control transistor, and a second electrode of the twelfth control transistor is electrically connected to the control signal terminal;
the ninth control transistor and the eleventh control transistor are p-type transistors, and the tenth control transistor and the twelfth control transistor are n-type transistors.

Optionally, the control signal generating circuit is used to invert the enable signal to generate an inverting enable signal, and output the inverting enable signal through the control signal terminal.

Optionally, the first control circuit includes a first control transistor, a second control transistor, a third control transistor and a fourth control transistor; the second control circuit includes a fifth control transistor and a sixth control transistor; the third control circuit includes a seventh control transistor and an eighth control transistor; and the second energy storage circuit includes a second capacitor;
a gate electrode of the first control transistor is electrically connected to the control signal terminal, a first electrode of the first control transistor is electrically connected to the first-voltage line, and a second electrode of the first control transistor is electrically connected to the first control output terminal;
a gate electrode of the second control transistor is electrically connected to the control signal terminal, a first electrode of the second control transistor is electrically connected to the first control output terminal, and a second electrode of the second control transistor is electrically connected to the second-voltage line;
a gate electrode of the third control transistor is electrically connected to the first control output terminal, a first electrode of the third control transistor is electrically connected to the first-voltage line, and a second electrode of the third control transistor is electrically connected to the control signal terminal;
a gate electrode of the fourth control transistor is electrically connected to the first control output terminal, a first electrode of the fourth control transistor is electrically connected to the control signal terminal, and a second electrode of the fourth control transistor is electrically connected to the second-voltage line;
a gate electrode of the fifth control transistor and a gate electrode of the sixth control transistor are both electrically connected to the n-th stage driving signal output terminal, a first electrode of the fifth control transistor is electrically connected to the first control output terminal, and a second electrode of the fifth control transistor is electrically connected to the second control output terminal;
a first electrode of the sixth control transistor is electrically connected to the second control output terminal, and a second electrode of the sixth control transistor is electrically connected to the second-voltage line;
a gate electrode of the seventh control transistor is electrically connected to the second control output terminal; a first electrode of the seventh control transistor is electrically connected to the first-voltage line, and a second electrode of the seventh control transistor is electrically connected to the n-th stage driving output terminal;
a gate electrode of the eighth control transistor is electrically connected to the second control output terminal, a first electrode of the eighth control transistor is electrically connected to the n-th stage driving output terminal, and a second electrode of the eighth control transistor is electrically connected to the second-voltage line;
a first electrode plate of the second capacitor is electrically connected to the second control output terminal, and a second electrode plate of the second capacitor is electrically connected to the second-voltage line;
the first control transistor, the third control transistor, the fifth control transistor and the seventh control transistor are all p-type transistors, and the second control transistor, the fourth control transistor, the sixth control transistor and the eighth control transistor are all n-type transistors.

Optionally, the control signal generating circuit includes a ninth control transistor and a tenth control transistor;
a gate electrode of the ninth control transistor is electrically connected to the enable signal line, a first electrode of the ninth control transistor is electrically connected to the first-voltage line, and a second electrode of the ninth control transistor is electrically connected to the control signal terminal;
a gate electrode of the tenth control transistor is electrically connected to the enable signal line, a first electrode of the tenth control transistor is electrically connected to the control signal terminal, and a second electrode of the tenth control transistor is electrically connected to the second-voltage line;
the ninth control transistor is a p-type transistor, and the tenth control transistor is an n-type transistor.

Optionally, the output inverting circuit includes a thirteenth control transistor and a fourteenth control transistor;
a gate electrode of the thirteenth control transistor is electrically connected to the n-th stage driving signal output terminal, a first electrode of the thirteenth control transistor is electrically connected to the first-voltage line, and a second electrode of the thirteenth control transistor is electrically connected to the n-th stage inverting signal output terminal;
a gate electrode of the fourteenth control transistor is electrically connected to the n-th stage driving signal output terminal, a first electrode of the fourteenth control transistor is electrically connected to the n-th stage inverting signal output terminal, and a second electrode of the fourteenth control transistor is electrically connected to the second-voltage line;
the thirteenth control transistor is a p-type transistor, and the fourteenth control transistor is an n-type transistor.

Optionally, the driving signal generating circuit includes a first node control circuit, a second node control circuit, a first output node control circuit, a second output node control circuit, a potential maintaining circuit and an output circuit;
the first node control circuit is electrically connected to a first node, a first clock signal line, a second-voltage line and a second output node, respectively, and is used to control connection between the first node and the second-voltage line under control of a first clock signal provided by the first clock signal line, and to control connection or disconnection between the first node and the first clock signal line under control of a potential of the second output node;
the second node control circuit is electrically connected to the first node, a first intermediate node, a first-voltage line, a second clock signal line, a second node, an input terminal and a second-voltage line respectively, and is used to control connection between the first intermediate node and the first-voltage line under control of the potential of the first node, control connection between the first intermediate node and the second clock signal line under control of a potential of the second node, and control the potential of the second node according to the potential of the first intermediate node, and control connection between the input terminal and the second node under control of a second clock signal provided by the second clock signal line and a second-voltage signal provided by the second-voltage line;
the first output node control circuit is electrically connected to a first output node, the first node, the second clock signal line, a second intermediate node, a second output node and the first-voltage line respectively, and is used to control connection between the second intermediate node and the second clock signal line under control of a potential of the first node, control a potential of the second intermediate node according to the potential of the first node, control connection between the second intermediate node and the first output node under control of the second clock signal provided by the second clock signal line, and control connection between the first output node and the first-voltage line under control of a potential of the second output node;
the second output node control circuit is electrically connected to the second clock signal line, the input terminal, a control voltage line, the first-voltage line, the second node, and the second output node, respectively, and is used to control connection between the second output node and the input terminal under control of the second clock signal provided by the second clock signal line, and control the potential of the second output node according to the potential of the second node, and control connection between the second output node and the first-voltage line under control of a control voltage provided by the control voltage line;
the potential maintaining circuit is electrically connected to the first output node, and is used to maintain a potential of the first output node;
the output circuit is electrically connected to the first output node, the second output node, the first-voltage line, the second-voltage line and the n-th stage driving signal output terminal, respectively, and is used to control connection between the n-th stage driving signal output terminal and the first-voltage line under control of the potential of the first output node, and to control connection between the n-th stage driving signal output terminal and the second-voltage line under control of the potential of the second output node.

Optionally, the first node control circuit includes a first transistor, a second transistor and a third transistor; the second output node control circuit includes a fourth transistor, a fifth transistor, a sixth transistor and a seventh transistor;
a gate electrode of the first transistor is electrically connected to the first clock signal line, a first electrode of the first transistor is electrically connected to the second-voltage line, and a second electrode of the first transistor is electrically connected to a first electrode of the third transistor;
a gate electrode of the second transistor is electrically connected to a second electrode of the fourth transistor, a first electrode of the second transistor is electrically connected to the first clock signal line, and a second electrode of the second transistor is electrically connected to a first electrode of the third transistor;
a gate electrode of the third transistor is electrically connected to the second-voltage line, and a second electrode of the third transistor is electrically connected to the first node;
a gate electrode of the fourth transistor is electrically connected to the first clock signal line, and a first electrode of the fourth transistor is electrically connected to the input terminal;
a gate electrode of the fifth transistor is electrically connected to the second-voltage line, a first electrode of the fifth transistor is electrically connected to a second electrode of the fourth transistor, and a second electrode of the fifth transistor is electrically connected to the second output node;
a gate electrode of the sixth transistor and a first electrode of the sixth transistor are both electrically connected to the second node, and a second electrode of the sixth transistor is electrically connected to the second output node;
a gate electrode of the seventh transistor is electrically connected to the control voltage line, a first electrode of the seventh transistor is electrically connected to the first-voltage line, and a second electrode of the seventh transistor is electrically connected to the first electrode of the fifth transistor;
the second node control circuit includes an eighth transistor, a ninth transistor, a tenth transistor, an eleventh transistor and a third capacitor;
a gate electrode of the eighth transistor is electrically connected to the second node, a first electrode of the eighth transistor is electrically connected to the second clock signal line, and a second electrode of the eighth transistor is electrically connected to the first intermediate node;
a gate electrode of the ninth transistor is electrically connected to the second electrode of the first transistor, a first electrode of the ninth transistor is electrically connected to the first-voltage line, and a second electrode of the ninth transistor is electrically connected to the first intermediate node;
a gate electrode of the tenth transistor is electrically connected to the first clock signal line, a first electrode of the tenth transistor is electrically connected to the input terminal, and a second electrode of the tenth transistor is electrically connected to a first electrode of the eleventh transistor;
a gate electrode of the eleventh transistor is electrically connected to the second-voltage line, and a second electrode of the eleventh transistor is electrically connected to the second node;
a first electrode plate of the third capacitor is electrically connected to the second node, and a second electrode plate of the third capacitor is electrically connected to the first intermediate node;
the first output node control circuit includes a twelfth transistor, a thirteenth transistor, a fourteenth transistor and a fourth capacitor;
a gate electrode of the twelfth transistor is electrically connected to the first node, a first electrode of the twelfth transistor is electrically connected to the second clock signal line, and a second electrode of the twelfth transistor is electrically connected to the second intermediate node;
a gate electrode of the thirteenth transistor is electrically connected to the second clock signal line, a first electrode of the thirteenth transistor is electrically connected to the second intermediate node, and a second electrode of the thirteenth transistor is electrically connected to the first output node;
a gate electrode of the fourteenth transistor is electrically connected to the first electrode of the fifth transistor, a first electrode of the fourteenth transistor is electrically connected to the first-voltage line, and a second electrode of the fourteenth transistor is electrically connected to the first output node;
a first electrode plate of the fourth capacitor is electrically connected to the first node, and a second electrode plate of the fourth capacitor is electrically connected to the second intermediate node;
the potential maintaining circuit includes a fifth capacitor;
a first electrode plate of the fifth capacitor is electrically connected to the first output node, and a second electrode plate of the fifth capacitor is electrically connected to the first-voltage line;
the output circuit includes a fifteenth transistor and a sixteenth transistor;
a gate electrode of the fifteenth transistor is electrically connected to the first output node, a first electrode of the fifteenth transistor is electrically connected to the first-voltage line, and a second electrode of the fifteenth transistor is electrically connected to the n-th stage driving signal output terminal;
a gate electrode of the sixteenth transistor is electrically connected to the second output node, a first electrode of the sixteenth transistor is electrically connected to the n-th stage driving signal output terminal, and a second electrode of the sixteenth transistor is electrically connected to the second-voltage line.

Optionally, the driving signal generating circuit includes a first output node control circuit, a second output node control circuit, a third energy storage circuit and an output circuit;
the first output node control circuit is electrically connected to the first clock signal line, the second-voltage line, and the second output node, respectively, and is used to control connection between the first output node and the second-voltage line under control of the first clock signal provided by the first clock signal line, and control connection between the first output node and the first clock signal line under control of the potential of the second output node, and is used to maintain the potential of the first output node;
the second output node control circuit is electrically connected to the second output node, the first clock signal line, the input terminal, the second clock signal line, the first output node and the first-voltage line respectively, and is used to control connection between the second output node and the input terminal under control of the first clock signal, and control connection between the second output node and the first-voltage line under control of the potential of the first output node and a second clock signal provided by the second clock signal line;
a first end of the third energy storage circuit is electrically connected to the second output node, a second end of the third energy storage circuit is electrically connected to the n-th stage driving signal output terminal, and the third energy storage circuit is used to store electric energy;
the output circuit is electrically connected to the first output node, the second output node, the first-voltage line, the second clock signal and the n-th stage driving signal output terminal, respectively, and is used to control connection between the n-th stage driving signal output terminal and the first-voltage line under control of the potential of the first output node, and to control connection between the n-th stage driving signal output terminal and the second clock signal line under control of the potential of the second output node.

Optionally, the first output node control circuit includes a seventeenth transistor, an eighteenth transistor and a sixth capacitor;
a gate electrode of the seventeenth transistor is electrically connected to the first clock signal line, a first electrode of the seventeenth transistor is electrically connected to the second-voltage line, and a second electrode of the seventeenth transistor is electrically connected to the first output node;
a gate electrode of the eighteenth transistor is electrically connected to the second output node, a first electrode of the eighteenth transistor is electrically connected to the first clock signal line, and a second electrode of the eighteenth transistor is electrically connected to the first output node;
a first electrode plate of the sixth capacitor is electrically connected to the first output node, and a second electrode plate of the sixth capacitor is electrically connected to the first-voltage line;
the second output node control circuit includes a nineteenth transistor, a twentieth transistor, and a twenty-first transistor; the third energy storage circuit includes a seventh capacitor;
a gate electrode of the nineteenth transistor is electrically connected to the first clock signal line, a first electrode of the nineteenth transistor is electrically connected to the input terminal, and a second electrode of the nineteenth transistor is electrically connected to the second output node;
a gate electrode of the twentieth transistor is electrically connected to the first output node, a first electrode of the twentieth transistor is electrically connected to the first-voltage line, and a second electrode of the twentieth transistor is electrically connected to a first electrode of the twenty-first transistor;
a gate electrode of the twenty-first transistor is electrically connected to the second clock signal line, and a second electrode of the twenty-first transistor is electrically connected to the second output node;
a first electrode plate of the seventh capacitor is electrically connected to the second output node, and a second electrode plate of the seventh capacitor is electrically connected to the n-th stage driving signal output terminal;
the output circuit includes a twenty-second transistor and a twenty-third transistor;
a gate electrode of the twenty-second transistor is electrically connected to the first output node, a first electrode of the twenty-second transistor is electrically connected to the first-voltage line, and a second electrode of the twenty-second transistor is electrically connected to the n-th stage driving signal output terminal;
a gate electrode of the twenty-third transistor is electrically connected to the second output node, a first electrode of the twenty-third transistor is electrically connected to the n-th stage driving signal output terminal, and a second electrode of the twenty-third transistor is electrically connected to the second clock signal line;
the driving circuit further includes a twenty-fourth transistor;
a second electrode of the twenty-first transistor is electrically connected to the second output node through the twenty-fourth transistor; a gate electrode of the twenty-fourth transistor is electrically connected to the second-voltage line, a first electrode of the twenty-fourth transistor is electrically connected to the second electrode of the twenty-first transistor, and the second electrode of the twenty-fourth transistor is electrically connected to the second output node.

In a second aspect, one embodiment of the present disclosure provides a display substrate, including: a base substrate and the driving circuit according to claim 1 arranged on the base substrate;
wherein the display substrate includes a display area and a peripheral area; the driving circuit is arranged in the peripheral area.

Optionally, the driving circuit further includes an output inverting circuit;
the output inverting circuit is electrically connected to the n-th stage driving signal output terminal and an n-th stage inverting signal output terminal respectively, and is used to invert the n-th stage driving signal to obtain and output an n-th stage inverting driving signal through the n-th stage inverting signal output terminal;
the control signal generating circuit is further electrically connected to a (n−1)-th stage driving signal output terminal, an n-th stage inverting signal output terminal, an n-th stage driving signal output terminal and an n-th stage inverting signal output terminal, respectively, and is used to generate the control signal according to the enable signal under control of a (n−1)-th stage driving signal, a (n−1)-th stage inverting driving signal, an n-th stage driving signal and an n-th stage inverting driving signal;
the (n−1)-th stage driving signal output terminal is used to provide the (n−1)-th stage driving signal, and the (n−1)-th stage inverting signal output terminal is used to provide the (n−1)-th stage inverting driving signal.

Optionally, the control circuit in the driving circuit includes a first control circuit, a second control circuit, a third control circuit, a first energy storage circuit, and a second energy storage circuit;
the first control circuit is electrically connected to the control signal terminal, a first-voltage line, a second-voltage line and a first control output terminal respectively, and is used to invert the control signal to obtain an inverting control signal, and output the inverting control signal through the first control output terminal;
the second control circuit is electrically connected to the n-th stage driving signal output terminal, the first-voltage line, the first control output terminal and the second control output terminal respectively, and is used to control the second control output terminal to be coupled to the first-voltage line or the first control output terminal under control of the n-th stage driving signal; or, the second control circuit is electrically connected to the n-th stage driving signal output terminal, the first control output terminal, the second control output terminal and the second-voltage line respectively, and is used to control the second control output terminal to be coupled to the second-voltage line or the first control output terminal under control of the n-th stage driving signal;
the third control circuit is electrically connected to the second control output terminal, the first-voltage line, the second-voltage line and the n-th stage driving output terminal respectively, and is used to invert a signal output by the second control output terminal, and output an inverting signal through the n-th stage driving output terminal;
the first energy storage circuit is electrically connected to the control signal terminal and is used to maintain a potential of the control signal terminal;
the second energy storage circuit is electrically connected to the second control output terminal, and is used to maintain a potential of the second control output terminal.

Optionally, the control circuit in the driving circuit includes a first control circuit, a second control circuit, a third control circuit, a fourth control circuit, and a second energy storage circuit;
the first control circuit is electrically connected to the control signal terminal, a first-voltage line, a second-voltage line and a first control output terminal respectively, and is used to invert the control signal to obtain an inverting control signal, and output the inverting control signal through the first control output terminal;
the second control circuit is electrically connected to the n-th stage driving signal output terminal, the first control output terminal, a second control output terminal and a second-voltage line respectively, and is used to control the second control output terminal to be connected to the second-voltage line or the first control output terminal under control of the n-th stage driving signal;
the third control circuit is electrically connected to the second control output terminal, the first-voltage line, the second-voltage line and the n-th stage driving output terminal respectively, and is used to invert a signal output by the second control output terminal, and output an inverting signal through the n-th stage driving output terminal;
the second energy storage circuit is electrically connected to the second control output terminal, and is used to maintain a potential of the second control output terminal.

Optionally, the driving signal generating circuit includes a first node control circuit, a second node control circuit, a first output node control circuit, a second output node control circuit, a potential maintaining circuit and an output circuit;
the first node control circuit is electrically connected to a first node, a first clock signal line, a second-voltage line and a second output node, respectively, and is used to control connection between the first node and the second-voltage line under control of a first clock signal provided by the first clock signal line, and to control connection or disconnection between the first node and the first clock signal line under control of a potential of the second output node;
the second node control circuit is electrically connected to the first node, a first intermediate node, a first-voltage line, a second clock signal line, a second node, an input terminal and a second-voltage line respectively, and is used to control connection between the first intermediate node and the first-voltage line under control of the potential of the first node, control connection between the first intermediate node and the second clock signal line under control of a potential of the second node, and control the potential of the second node according to the potential of the first intermediate node, and control connection between the input terminal and the second node under control of a second clock signal provided by the second clock signal line and a second-voltage signal provided by the second-voltage line;
the first output node control circuit is electrically connected to a first output node, the first node, the second clock signal line, a second intermediate node, a second output node and the first-voltage line respectively, and is used to control connection between the second intermediate node and the second clock signal line under control of a potential of the first node, control a potential of the second intermediate node according to the potential of the first node, control connection between the second intermediate node and the first output node under control of the second clock signal provided by the second clock signal line, and control connection between the first output node and the first-voltage line under control of a potential of the second output node;
the second output node control circuit is electrically connected to the second clock signal line, the input terminal, a control voltage line, the first-voltage line, the second node, and the second output node, respectively, and is used to control connection between the second output node and the input terminal under control of the second clock signal provided by the second clock signal line, and control the potential of the second output node according to the potential of the second node, and control connection between the second output node and the first-voltage line under control of a control voltage provided by the control voltage line;
the potential maintaining circuit is electrically connected to the first output node, and is used to maintain a potential of the first output node;
the output circuit is electrically connected to the first output node, the second output node, the first-voltage line, the second-voltage line and the n-th stage driving signal output terminal, respectively, and is used to control connection between the n-th stage driving signal output terminal and the first-voltage line under control of the potential of the first output node, and to control connection between the n-th stage driving signal output terminal and the second-voltage line under control of the potential of the second output node.

Optionally, the driving signal generating circuit includes a first output node control circuit, a second output node control circuit, a third energy storage circuit and an output circuit;
the first output node control circuit is electrically connected to the first clock signal line, the second-voltage line, and the second output node, respectively, and is used to control connection between the first output node and the second-voltage line under control of the first clock signal provided by the first clock signal line, and control connection between the first output node and the first clock signal line under control of the potential of the second output node, and is used to maintain the potential of the first output node;
the second output node control circuit is electrically connected to the second output node, the first clock signal line, the input terminal, the second clock signal line, the first output node and the first-voltage line respectively, and is used to control connection between the second output node and the input terminal under control of the first clock signal, and control connection between the second output node and the first-voltage line under control of the potential of the first output node and a second clock signal provided by the second clock signal line;
a first end of the third energy storage circuit is electrically connected to the second output node, a second end of the third energy storage circuit is electrically connected to the n-th stage driving signal output terminal, and the third energy storage circuit is used to store electric energy;
the output circuit is electrically connected to the first output node, the second output node, the first-voltage line, the second clock signal and the n-th stage driving signal output terminal, respectively, and is used to control connection between the n-th stage driving signal output terminal and the first-voltage line under control of the potential of the first output node, and to control connection between the n-th stage driving signal output terminal and the second clock signal line under control of the potential of the second output node.

Optionally, the control signal generating circuit and the control circuit are arranged on a side of the driving signal generating circuit close to the display area.

Optionally, the first-voltage line includes a first first-voltage line and a second first-voltage line, and the second-voltage line includes a first second-voltage line and a second second-voltage line;
an orthographic projection of at least part of active patterns of transistors included in the third control circuit onto the base substrate at least partially overlaps with an orthographic projection of the first first-voltage line onto the base substrate;
the orthographic projection of at least part of active patterns of transistors included in the third control circuit onto the base substrate at least partially overlaps with an orthographic projection of the first second-voltage line onto the base substrate;
the orthographic projection of the first second-voltage line onto the base substrate at least partially overlaps with an orthographic projection of active patterns of at least part of transistors included in the second control circuit onto the base substrate;
the orthographic projection of the first second-voltage line onto the base substrate at least partially overlaps with an orthographic projection of an electrode plate of a capacitor included in the second energy storage circuit onto the base substrate;
an orthographic projection of the second second-voltage line onto the base substrate at least partially overlaps with an orthographic projection of an electrode plate of a capacitor included in the first energy storage circuit onto the base substrate;
the orthographic projection of the second second-voltage line onto the base substrate at least partially overlaps with an orthographic projection of active patterns of at least part of transistors included in the control signal generating circuit onto the base substrate;
an orthographic projection of the enable signal line onto the base substrate at least partially overlaps with an orthographic projection of active patterns of at least part of transistors included in the control signal generating circuit onto the base substrate.

Optionally, the first first-voltage line, the second first-voltage line, the first second-voltage line, the second second-voltage line and the enable signal line all extend along a first direction;
a width of the first first-voltage line along a second direction is greater than a width of the second first-voltage line along the second direction;
a width of the first second-voltage line along the second direction is greater than a width of the second second-voltage line along the second direction;
the first direction crosses the second direction.

Optionally, the transistor included in the third control circuit is arranged on a side of the transistor included in the first control circuit close to the display area;
the transistor included in the third control circuit is arranged on a side of the transistor included in the second control circuit close to the display area; and
the transistor included in the control signal generating circuit is arranged on a side of the control circuit away from the display area.

Optionally, the second-voltage line further includes a third second-voltage line;
an orthographic projection of the third second-voltage line onto the base substrate at least partially overlaps with an orthographic projection of an active pattern of at least one transistor included in the output inverter circuit onto the base substrate.

Optionally, the first-voltage line includes a third first-voltage line and a fourth first-voltage line; and the second-voltage line includes a third second-voltage line and a fourth second-voltage line;
an orthographic projection of the third second-voltage line onto the base substrate at least partially overlaps with the orthographic projection of the active pattern of at least one transistor included in the output circuit onto the base substrate;
an orthographic projection of the third first-voltage line onto the base substrate at least partially overlap with the orthographic projection of the active pattern of at least one transistor included in the output circuit on the base substrate;
the orthographic projection of the third first-voltage line onto the base substrate at least partially overlaps with an orthographic projection of an electrode plate of a capacitor included in the potential maintaining circuit onto the base substrate;
an orthographic projection of the fourth first-voltage line onto the base substrate at least partially overlaps with an orthographic projection of active patterns of at least part of transistors included in the second output node control circuit onto the base substrate.

Optionally, wherein an orthographic projection of the fourth second-voltage line onto the base substrate at least partially overlaps with an orthographic projection of an electrode plate of a capacitor included in the second node control circuit onto the base substrate;
the orthographic projection of the fourth second-voltage line onto the base substrate at least partially overlaps with an orthographic projection of active patterns of at least part of transistors included in the first node control circuit onto the base substrate;
the orthographic projection of the fourth second-voltage line onto the base substrate at least partially overlaps with an orthographic projection of active patterns of at least part of transistors included in the second node control circuit onto the base substrate;
the orthographic projection of the fourth second-voltage line onto the base substrate at least partially overlaps with an orthographic projection of active patterns of at least part of transistors included in the second output node control circuit onto the base substrate.

Optionally, an orthographic projection of the first clock signal line onto the base substrate at least partially overlaps with an orthographic projection of an electrode plate of a capacitor included in the first output node control circuit onto the base substrate;
an orthographic projection of the second clock signal line onto the base substrate at least partially overlaps with an orthographic projection of an electrode plate of a capacitor included in the first output node control circuit onto the base substrate;
the orthographic projection of the second clock signal line onto the base substrate at least partially overlaps with an orthographic projection of an electrode plate of a capacitor included in the second node control circuit onto the base substrate.

Optionally, the output inverting circuit and the output circuit are arranged along a first direction;
the potential maintaining circuit and the output circuit are arranged along the first direction;
the output inverting circuit and the potential maintaining circuit are arranged along a second direction;
transistors included in the output circuit are arranged in sequence along the first direction.

Optionally, the first-voltage line includes a first first-voltage line and a second first-voltage line;
an orthographic projection of the first first-voltage line onto the base substrate at least partially overlaps with an orthographic projection of active patterns of at least part of transistors included in the third control circuit onto the base substrate;
an orthographic projection of the second first-voltage line onto the base substrate at least partially overlaps with an orthographic projection of active patterns of some transistors included in the first control circuit onto the base substrate;
the orthographic projection of the second first-voltage line onto the base substrate at least partially overlaps with an orthographic projection of active patterns of some transistors included in the control signal generating circuit onto the base substrate;
at least part of an orthographic projection of active patterns of at least part of transistors included in the output inverting circuit onto the base substrate is arranged between an orthographic projection of the second first-voltage line onto the base substrate and an orthographic projection of the enable signal line onto the base substrate.

Optionally, an active pattern of at least part of transistors included in the third control circuit includes at least two active pattern portions that are independent of each other.

Optionally, the second-voltage line includes a first second-voltage line, a second second-voltage line, and a third second-voltage line;
an orthographic projection of the first second-voltage line onto the base substrate at least partially overlaps with an orthographic projection of active patterns of at least part of transistors included in the third control circuit onto the base substrate;
an orthographic projection of the second second-voltage line onto the base substrate at least partially overlaps with an orthographic projection of active patterns of at least part of transistors included in the first control circuit onto the base substrate;
the orthographic projection of the second second-voltage line onto the base substrate at least partially overlaps with an orthographic projection of an active pattern of at least part of transistors included in the control signal generating circuit onto the base substrate;
the orthographic projection of the second second-voltage line onto the base substrate at least partially overlaps with an orthographic projection of an electrode plate of a capacitor included in the first energy storage circuit onto the base substrate;
the orthographic projection of the second second-voltage line onto the base substrate at least partially overlaps with an orthographic projection of an electrode plate of a capacitor included in the second energy storage circuit onto the base substrate;
an orthographic projection of the third second-voltage line onto the base substrate at least partially overlaps with an orthographic projection of active patterns of some transistors included in the control signal generating circuit onto the base substrate;
the orthographic projection of the third second-voltage line onto the base substrate at least partially overlaps with an orthographic projection of active patterns of at least part of transistors included in the output circuit onto the base substrate.

Optionally, the first-voltage line includes a first first-voltage line, and the second-voltage line includes a first second-voltage line;
an orthographic projection of the first second-voltage line onto the base substrate at least partially overlaps with an orthographic projection of an active pattern of at least part of transistors included in the third control circuit onto the base substrate;
an orthographic projection of the first first-voltage line onto the base substrate at least partially overlaps with an orthographic projection of an active pattern of at least part of transistors included in the third control circuit onto the base substrate;
the orthographic projection of the first first-voltage line onto the base substrate at least partially overlaps with an orthographic projection of an active pattern of at least part of transistors included in the second control circuit onto the base substrate;
the orthographic projection of the first first-voltage line onto the base substrate at least partially overlaps with an orthographic projection of an electrode plate of a capacitor included in the second energy storage circuit onto the base substrate.

Optionally, an orthographic projection of the enable signal line onto the base substrate at least partially overlaps with an orthographic projection of active patterns of at least part of transistors included in the control signal generating circuit onto the base substrate.

Optionally, the first-voltage line includes a first first-voltage line and a second first-voltage line, and the second-voltage line includes a first second-voltage line and a second second-voltage line;
the first first-voltage line, the second first-voltage line, the first second-voltage line, and the second second-voltage line are arranged in sequence along a direction away from a display area;
a width of the first first-voltage line along a second direction is greater than a width of the second first-voltage line along the second direction;
a width of the first second-voltage line along the second direction is greater than a width of the second second-voltage line along the second direction;
the first direction crosses the second direction.

Optionally, at least two transistors included in the third control circuit are arranged sequentially along the second direction;
at least one transistor included in the third control circuit and a capacitor included in the second energy storage circuit are arranged in sequence along the first direction.

Optionally, the first-voltage line includes a third first-voltage line, and the second-voltage line includes a third second-voltage line and a fourth second-voltage line;
an orthographic projection of the third second-voltage line onto the base substrate at least partially overlaps with an orthographic projection of an electrode plate of a capacitor included in the first output node control circuit onto the base substrate;
the orthographic projection of the third second-voltage line onto the base substrate at least partially overlaps with an orthographic projection of an electrode plate of a capacitor included in the third energy storage circuit onto the base substrate;
an orthographic projection of the fourth second-voltage line onto the base substrate at least partially overlaps with an orthographic projection of active patterns of at least part of transistors included in the first output node control circuit onto the base substrate.

Optionally, an orthographic projection of the first clock signal line onto the base substrate at least partially overlaps with an orthographic projection of active patterns of at least part of transistors included in the second output node control circuit onto the base substrate;
an orthographic projection of the second clock signal line onto the base substrate at least partially overlaps with an orthographic projection of active patterns of at least part of transistors included in the second output node control circuit onto the base substrate.

Optionally, the first-voltage line includes a third first-voltage line, and the second-voltage line includes a third second-voltage line and a fourth second-voltage line;
at least a portion of an electrode plate of a capacitor included in the first output node control circuit is disposed between the third second-voltage line and the third first-voltage line;
at least a portion of an electrode plate of a capacitor included in the third energy storage circuit is disposed between the third second-voltage line and the third first-voltage line.

Optionally, the second-voltage line includes a first second-voltage line;
an orthographic projection of the first second-voltage line onto the base substrate at least partially overlaps with an orthographic projection of active patterns of at least part of transistors included in the third control circuit onto the base substrate.

Optionally, the third control circuit includes an eighth control transistor;
the orthographic projection of the first second-voltage line onto the base substrate partially overlaps with an active pattern of the eighth control transistor;
a gate electrode of the eighth control transistor is electrically connected to the second control output terminal, a first electrode of the eighth control transistor is electrically connected to the n-th stage driving output terminal, and a second electrode of the eighth control transistor is electrically connected to the second-voltage line;
the active pattern of the eighth control transistor includes at least two active pattern parts independent of each other;
the at least two mutually independent active pattern portions are arranged in sequence along the second direction.

Optionally, the first-voltage line includes a first first-voltage line;
an orthographic projection of the first first-voltage line onto the base substrate at least partially overlaps with an orthographic projection of an electrode plate of a capacitor included in the second energy storage circuit onto the base substrate;
the orthographic projection of the first first-voltage line onto the base substrate at least partially overlaps with an orthographic projection of an active pattern of at least part of transistors included in the first control circuit onto the base substrate;
the orthographic projection of the first first-voltage line onto the base substrate at least partially overlaps with an orthographic projection of active patterns of at least part of transistors included in the third control circuit onto the base substrate.

Optionally, the first-voltage line further includes a second first-voltage line and a third first-voltage line;
the first first-voltage line, the second first-voltage line and the third first-voltage line all extend along a first direction;
a width of the first first-voltage line along a second direction is greater than a width of the second first-voltage line along the second direction;
a width of the first first-voltage line along the second direction is greater than a width of the third first-voltage line along the second direction;
the first direction crosses the second direction.

Optionally, the second-voltage line includes a second second-voltage line and a third second-voltage line, and the first-voltage line includes a second first-voltage line;
an orthographic projection of the second second-voltage line onto the base substrate at least partially overlaps with an orthographic projection of an active pattern of at least part of transistors included in the third control circuit onto the base substrate;
the orthographic projection of the second first-voltage line onto the base substrate at least partially overlaps with an orthographic projection of an active pattern of at least part of transistors included in the control signal generating circuit onto the base substrate;
the orthographic projection of the second first-voltage line onto the base substrate at least partially overlaps with an orthographic projection of an active pattern of at least part of transistors included in the second control circuit onto the base substrate;
an orthographic projection of the third second-voltage line onto the base substrate at least partially overlaps with an orthographic projection of an active pattern of at least part of transistors included in the control signal generating circuit onto the base substrate;
an orthographic projection of the enable signal line onto the base substrate at least partially overlaps with an orthographic projection of the electrode plate of the capacitor included in the third energy storage circuit onto the base substrate.

Optionally, the second-voltage line includes a first second-voltage line;
a width of the first second-voltage line along the second direction is greater than a width of the second second-voltage line along the second direction;
a width of the first second-voltage line along the second direction is greater than a width of the third second-voltage line along the second direction;
the first direction crosses the second direction.

Optionally, the first-voltage line further includes a third first-voltage line;
at least a portion of an electrode plate of a capacitor included in the first output node control circuit is disposed between the enable signal line and the third first-voltage line;
at least a portion of an electrode plate of a capacitor included in the third energy storage circuit is disposed between the enable signal line and the third first-voltage line.

Optionally, an active pattern of a transistor included in the driving circuit is formed in a first semiconductor layer; or,
an active pattern of a p-type transistor included in the driving circuit is formed in a first semiconductor layer, and an active pattern of an n-type transistor included in the driving circuit is formed in a second semiconductor layer.

In a third aspect, one embodiment of the present disclosure provides a display device, including the above display substrate.

According to the present disclosure, the n-th stage driving signal or the invalid voltage signal can be accurately output to the n-th stage driving output terminal, thereby accurately performing local refresh.

### BRIEF DESCRIPTION OF THE DRAWINGS

FIG. 1 is a schematic diagram of a driving circuit according to an embodiment of the present disclosure;

FIG. 2 is a circuit diagram of a related pixel circuit;

FIG. 3 is a schematic diagram of a driving circuit according to at least one embodiment of the present disclosure;

FIG. 4 is a schematic diagram of a driving circuit according to at least one embodiment of the present disclosure;

FIG. 5 is a schematic diagram of a driving circuit according to at least one embodiment of the present disclosure;

FIG. 6 is a schematic diagram of a driving circuit according to at least one embodiment of the present disclosure;

FIG. 7 is a schematic diagram of a driving circuit according to at least one embodiment of the present disclosure;

FIG. 8 is a schematic diagram of a driving circuit according to at least one embodiment of the present disclosure;

FIG. 9 is a schematic diagram of a driving circuit according to at least one embodiment of the present disclosure;

FIG. 10 is a schematic diagram of a driving circuit according to at least one embodiment of the present disclosure;

FIG. 11 is a schematic diagram of a driving circuit according to at least one embodiment of the present disclosure;

FIG. 12 is a schematic diagram of a driving circuit according to at least one embodiment of the present disclosure;

FIG. 13 is an operation timing diagram of a driving signal generating circuit in at least one embodiment of the driving circuit shown in FIG. 12;

FIG. 14 is an operation timing diagram of at least one embodiment of a (n−1)-th stage driving circuit and at least one embodiment of an n-th stage driving circuit;

FIG. 15 is a schematic diagram of a driving circuit according to at least one embodiment of the present disclosure;

FIG. 16 is an operation timing diagram of a driving signal generating circuit in at least one embodiment of the driving circuit shown in FIG. 15;

FIG. 17 is an operation timing diagram of at least one embodiment of a (n−1)-th stage driving circuit and at least one embodiment of an n-th stage driving circuit;

FIG. 18 is a schematic diagram of a driving circuit according to at least one embodiment of the present disclosure;

FIG. 19 is an operation timing diagram of a driving signal generating circuit in at least one embodiment of the driving circuit shown in FIG. 18;

FIG. 20 is an operation timing diagram of at least one embodiment of a (n−1)-th stage driving circuit and at least one embodiment of an n-th stage driving circuit;

FIG. 21 is a schematic diagram of a display substrate according to at least one embodiment of the present disclosure;

FIG. 22A, FIG. 22B and FIG. 22C are first layout diagrams of a display substrate including at least one embodiment of the driving circuit shown in FIG. 12;

FIG. 23 is a layout diagram of a first semiconductor layer in FIG. 22A;

FIG. 24 is a layout diagram of a first gate metal layer in FIG. 22A;

FIG. 25 is a layout diagram of a second gate metal layer in FIG. 22A;

FIG. 26 is a layout diagram of a first source-drain metal layer in FIG. 22A;

FIG. 27 is a layout diagram of a second source-drain metal layer in FIG. 22A;

FIG. 28A is a layout diagram of a third source-drain metal layer in FIG. 22A;

FIG. 28B is a superimposed diagram of the first semiconductor layer and the first gate metal layer in FIG. 22A;

FIG. 28C is a superimposed diagram of the first gate metal layer and the second gate metal layer in FIG. 22A;

FIG. 28D is a superimposed diagram of the second gate metal layer and the first source-drain metal layer in FIG. 22A;

FIG. 28E is a superimposed diagram of the first source-drain metal layer and the second source-drain metal layer in FIG. 22A;

FIG. 28F is a superimposed diagram of the second source-drain metal layer and the third source-drain metal layer in FIG. 22A;

FIG. 29A, FIG. 29B and FIG. 29C are second layout diagrams of a display substrate including at least one embodiment of the driving circuit shown in FIG. 12;

FIG. 30 is a layout diagram of a first semiconductor layer in FIG. 29A;

FIG. 31 is a layout diagram of a first gate metal layer in FIG. 29A;

FIG. 32 is a layout diagram of a second gate metal layer in FIG. 29A;

FIG. 33 is a layout diagram of a second semiconductor layer in FIG. 29A;

FIG. 34 is a layout diagram of a third gate metal layer in FIG. 29A;

FIG. 35 is a layout diagram of a first source-drain metal layer in FIG. 29A;

FIG. 36 is a layout diagram of a second source-drain metal layer in FIG. 29A;

FIG. 37A is a layout diagram of a third source-drain metal layer in FIG. 29A;

FIG. 37B is a superimposed diagram of the first semiconductor layer and the first gate metal layer in FIG. 29A;

FIG. 37C is a superimposed diagram of the first gate metal layer and the second gate metal layer in FIG. 29A;

FIG. 37D is a superimposed diagram of the second gate metal layer and the second semiconductor layer in FIG. 29A;

FIG. 37E is a superimposed diagram of the third gate metal layer and the second semiconductor layer in FIG. 29A;

FIG. 37F is a layout diagram of the third gate metal layer and the first source-drain metal layer in FIG. 29A;

FIG. 37G is a layout diagram of the first source-drain metal layer and the second source-drain metal layer in FIG. 29A;

FIG. 38A, FIG. 38B and FIG. 38C are first layout diagrams of a display substrate including at least one embodiment of the driving circuit shown in FIG. 15;

FIG. 39 is a layout diagram of a first semiconductor layer in FIG. 38A;

FIG. 40 is a layout diagram of a first gate metal layer in FIG. 38A;

FIG. 41 is a layout diagram of a second gate metal layer in FIG. 38A;

FIG. 42 is a layout diagram of a first source-drain metal layer in FIG. 38A;

FIG. 43 is a layout diagram of a second source-drain metal layer in FIG. 38A;

FIG. 44A is a layout diagram of a third source-drain metal layer in FIG. 38A;

FIG. 44B is a superimposed diagram of the first semiconductor layer and the first gate metal layer in FIG. 38A;

FIG. 44C is a superimposed diagram of the first gate metal layer and the second gate metal layer in FIG. 38A;

FIG. 44D is a superimposed diagram of the second gate metal layer and the first source-drain metal layer in FIG. 38A;

FIG. 44E is a superimposed diagram of the first source-drain metal layer and the second source-drain metal layer in FIG. 38A;

FIG. 45A, FIG. 45B and FIG. 45C are second layout diagrams of a display substrate including at least one embodiment of the driving circuit shown in FIG. 15;

FIG. 46 is a layout diagram of a first semiconductor layer in FIG. 45A;

FIG. 47 is a layout diagram of a first gate metal layer in FIG. 45A;

FIG. 48 is a layout diagram of a second gate metal layer in FIG. 45A;

FIG. 49 is a layout diagram of a second semiconductor layer in FIG. 45A;

FIG. 50 is a layout diagram of a third gate metal layer in FIG. 45A;

FIG. 51 is a layout diagram of a first source-drain metal layer in FIG. 45A;

FIG. 52 is a layout diagram of a second source-drain metal layer in FIG. 45A;

FIG. 53A is a layout diagram of a third source-drain metal layer in FIG. 45A;

FIG. 53B is a superimposed diagram of the first semiconductor layer and the first gate metal layer in FIG. 45A;

FIG. 53C is a superimposed diagram of the first gate metal layer and the second gate metal layer in FIG. 45A;

FIG. 53D is a superimposed diagram of the second gate metal layer and the second semiconductor layer in FIG. 45A;

FIG. 53E is a superimposed diagram of the third gate metal layer and the second semiconductor layer in FIG. 45A;

FIG. 53F is a superimposed diagram of the third gate metal layer and the first source-drain metal layer in FIG. 45A;

FIG. 53G is a superimposed diagram of the first source-drain metal layer and the second source-drain metal layer in FIG. 45A;

FIG. 53H is a superimposed diagram of the second source-drain metal layer and the third source-drain metal layer in FIG. 45A;

FIG. 54A and FIG. 54B are first layout diagrams of a display substrate including at least one embodiment of the driving circuit shown in FIG. 18;

FIG. 55 is a layout diagram of a first semiconductor layer in FIG. 54A;

FIG. 56 is a layout diagram of a first gate metal layer in FIG. 54A;

FIG. 57 is a layout diagram of a second gate metal layer in FIG. 54A;

FIG. 58 is a layout diagram of a first source-drain metal layer in FIG. 54A;

FIG. 59A is a layout diagram of a second source-drain metal layer in FIG. 54A;

FIG. 59B is a superimposed diagram of the first semiconductor layer and the first gate metal layer in FIG. 54A;

FIG. 59C is a layout diagram of the first gate metal layer and the second gate metal layer in FIG. 54A;

FIG. 59D is a layout diagram of the second gate metal layer and the first source-drain metal layer in FIG. 54A;

FIG. 59E is a layout diagram of the first source-drain metal layer and the second source-drain metal layer in FIG. 54A;

FIG. 60A, FIG. 60B and FIG. 60C are second layout diagrams of a display substrate including at least one embodiment of the driving circuit shown in FIG. 18;

FIG. 61 is a layout diagram of a first semiconductor layer in FIG. 60A;

FIG. 62 is a layout diagram of a first gate metal layer in FIG. 60A;

FIG. 63 is a layout diagram of a second gate metal layer in FIG. 60A;

FIG. 64 is a layout diagram of a second semiconductor layer in FIG. 60A;

FIG. 65 is a layout diagram of a third gate metal layer in FIG. 60A;

FIG. 66 is a layout diagram of a first source-drain metal layer in FIG. 60A;

FIG. 67A is a layout diagram of a second source-drain metal layer in FIG. 60A;

FIG. 67B is a layout diagram of the first semiconductor layer and the first gate metal layer in FIG. 60A;

FIG. 67C is a layout diagram of the first gate metal layer and the second gate metal layer in FIG. 60A;

FIG. 67D is a layout diagram of the second gate metal layer and the second semiconductor layer in FIG. 60A;

FIG. 67E is a layout diagram of the third gate metal layer and the second semiconductor layer in FIG. 60A;

FIG. 67F is a layout diagram of the third gate metal layer and the first source-drain metal layer in FIG. 60A;

FIG. 67G is a layout diagram of the first source-drain metal layer and the second source-drain metal layer in FIG. 60A; and

FIG. 68 is a layout diagram of a second semiconductor layer in FIG. 60A.

### DETAILED DESCRIPTION

The technical solutions in the embodiments of the present disclosure will be clearly and completely described hereinafter in conjunction with the accompanying drawings in the embodiments of the present disclosure. Obviously, the described embodiments are only a part of the embodiments of the present disclosure, rather than all the embodiments. Based on the embodiments in the present disclosure, all other embodiments obtained by those of ordinary skill in the art without creative work shall fall within the protection scope of the present disclosure.

The transistors used in all the embodiments of the present disclosure may be thin film transistors, field effect transistors or other devices with the same characteristics. In the embodiments of the present disclosure, in order to distinguish two electrodes of the transistor other than the gate, one of the electrodes is referred to as a first electrode, and the other electrode is referred to as a second electrode.

In actual operation, when the transistor is a thin film transistor or a field effect transistor, the first electrode may be a drain electrode, and the second electrode may be a source electrode, or the first electrode may be a source electrode, and the second electrode may be a drain electrode.

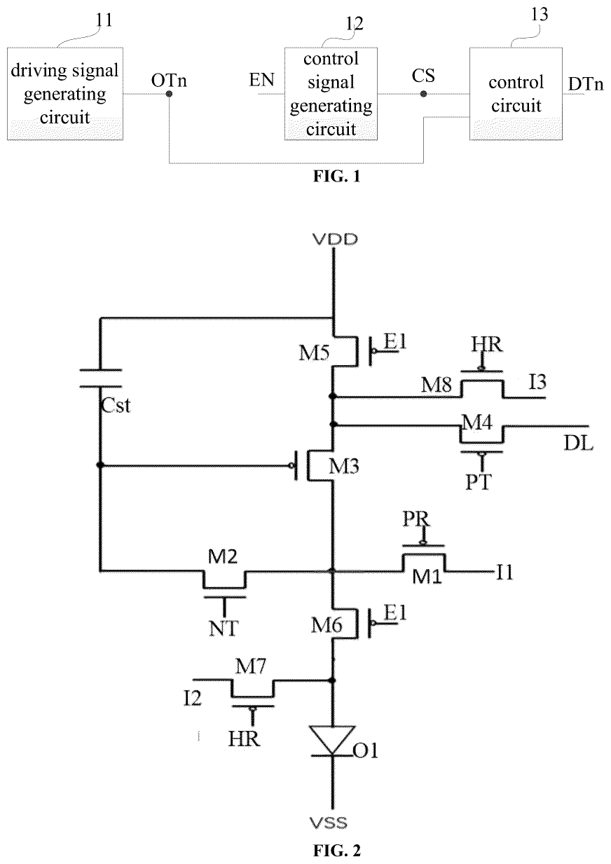

As shown in FIG. 1, a driving circuit in one embodiment of the present disclosure includes a driving signal generating circuit 11, a control signal generating circuit 12 and a control circuit 13.

The driving signal generating circuit 11 is electrically connected to an n-th stage driving signal output terminal OTn, and is used to generate and output an n-th stage driving signal through the n-th stage driving signal output terminal OTn; n is a positive integer.

The control signal generating circuit 12 is electrically connected to an enable signal line EN and a control signal terminal CS, and is used to generate a control signal according to the enable signal provided by the enable signal line EN and output the control signal through the control signal terminal CS.

The control circuit 13 is electrically connected to the control signal terminal CS, the n-th stage driving signal output terminal OTn and an n-th stage driving output terminal DTn respectively, and is used to output the n-th stage driving signal or invalid voltage signal to the n-th stage driving output terminal DTn under control of the control signal.

When the driving circuit in the embodiment of the present disclosure is in operation, the driving signal generating circuit 11 outputs the n-th stage driving signal; the control signal generating circuit 12 generates a control signal according to the enable signal; and the control circuit 13 controls the output of the n-th stage driving signal or an invalid voltage signal under control of the control signal.

In the related art, the driving circuit usually includes a driving signal generating circuit and a control circuit directly controlled by an enable signal. When a pulse width of the n-th stage driving signal provided by the driving signal generating circuit is 1H (1H is a row scanning time), the control circuit directly controlled by the enable signal can be used to control the output of the n-th stage driving signal or an invalid voltage signal. However, with the development of pixels, signals for controlling pixels are diversified, and the pulse width of the n-th stage driving signal will exceed 1H, causing waveform of the n-th stage driving signal to cross a changing edge (rising edge or falling edge) of the enable signal, resulting in only part of the n-th stage driving signal being able to be output, which will cause abnormal pixel operation.

In view of this, the driving circuit in the embodiment of the present disclosure is additionally provided with a control signal generating circuit 12, which generates a control signal according to an enable signal, and controls, through the control signal, the output of the n-th stage driving signal or the invalid voltage signal to the n-th stage driving output terminal DTn. In at least one embodiment of the present disclosure, the control signal generating circuit can generate the control signal according to the enable signal under control of a (n−1)-th stage driving signal, a (n−1)-stage inverting driving signal (the (n−1)-stage inverting driving signal can be inverting with the (n−1)-th driving signal), an n-th stage driving signal and an n-th stage inverting driving signal (the n-th stage inverting driving signal can be inverting with the n-th stage driving signal) provided at a (n−1)-th stage driving signal output terminal. The control circuit 13 outputs the n-th stage driving signal or the invalid voltage signal to the n-th stage driving output terminal DTn under control of the control signal, so that even when a pulse width of the n-th stage driving signal is greater than 1H, the n-th stage driving signal or the invalid voltage signal can be accurately output to the n-th stage driving output terminal DTn, thereby accurately performing local refresh.

In at least one embodiment of the present disclosure, the control signal generating circuit is further electrically connected to the (n−1)-th stage driving signal output terminal, the (n−1)-th stage inverting signal output terminal, the n-th stage driving signal output terminal and the n-th stage inverting signal output terminal, respectively, and is used to control connection or disconnection between the enable signal line and the control signal terminal under control of a (n−1)-th stage driving signal, a (n−1)-th stage inverting driving signal, an n-th stage driving signal and an n-th stage inverting driving signal.

As shown in FIG. 2, at least one embodiment of a related pixel circuit includes a first display control transistor M1, a second display control transistor M2, a driving transistor M3, a fourth display control transistor M4, a fifth display control transistor M5, a sixth display control transistor M6, a seventh display control transistor M7, an eighth display control transistor M8, a storage capacitor Cst, and an organic light emitting diode O1.

A gate electrode of M1 is electrically connected to a first reset terminal PR, a source electrode of M1 is electrically connected to a first starting voltage terminal I1, a second electrode of M1 is electrically connected to a drain electrode of M3. The first starting voltage terminal I1 is used to provide a first starting voltage Vinit1.

A gate electrode of M2 is electrically connected to a first scanning terminal NT, a source electrode of M2 is electrically connected to a gate electrode of M3, and a drain electrode of M2 is electrically connected to the drain electrode of M3.

A gate electrode of M4 is electrically connected to a second scanning terminal PT, a source electrode of M4 is electrically connected to a data line DL, and a drain electrode of M4 is electrically connected to the source electrode of M3.

A gate electrode of M5 is electrically connected to a light emitting control terminal E1, a source electrode of M5 is electrically connected to a high-level terminal VDD, and a drain electrode of M5 is electrically connected to the source electrode of M3.

A gate electrode of M6 is electrically connected to the light emitting control terminal E1, a source electrode of M6 is electrically connected to the drain electrode of M3, a drain electrode of M6 is electrically connected to an anode of O1; a cathode of O1 is electrically connected to a low-level terminal VSS;

A gate electrode of M7 is electrically connected to a second reset terminal HR, a source electrode of M7 is electrically connected to a second initial voltage terminal 12, and a drain electrode of M7 is electrically connected to the anode of O1.

A gate electrode of M8 is electrically connected to the second reset terminal HR, a source electrode of M8 is electrically connected to a third initial voltage terminal I3, and a drain electrode of M8 is electrically connected to the source electrode of M3.

A first electrode plate of Cst is electrically connected to the gate electrode of M3, and a second electrode plate of Cst is electrically connected to the high-level terminal VDD.

M1, M3, M4, M5, M6, M7 and M8 are all p-type transistors, and M2 is an n-type transistor.

In at least one embodiment of the present disclosure, the n-th stage driving output terminal DTn may be an n-th stage first scanning terminal, an n-th stage second scanning terminal or an n-th stage first reset terminal, but is not limited thereto.

As shown in FIG. 3, based on the embodiment of the driving circuit shown in FIG. 1, the driving circuit according to at least one embodiment of the present disclosure further includes an output inverting circuit 31.

The output inverting circuit 31 is electrically connected to the n-th stage driving signal output terminal OTn and the n-th stage inverting signal output terminal FOn respectively, and is used to invert the n-th stage driving signal to obtain and output the n-th stage inverting driving signal through the n-th stage inverting signal output terminal FOn.

In at least one embodiment of the present disclosure, the control circuit includes a first control circuit, a second control circuit, a third control circuit, a first energy storage circuit, and a second energy storage circuit.

The first control circuit is electrically connected to the control signal terminal, a first-voltage line, a second-voltage line and a first control output terminal respectively, and is used to invert the control signal to obtain an inverting control signal, and output the inverting control signal through the first control output terminal.

The second control circuit is electrically connected to the n-th stage driving signal output terminal, the first-voltage line, the first control output terminal and the second control output terminal respectively, and is used to control the second control output terminal to be connected to the first-voltage line or the first control output terminal under control of the n-th stage driving signal; or, the second control circuit is electrically connected to the n-th stage driving signal output terminal, the first control output terminal, the second control output terminal and the second-voltage line respectively, and is used to control the second control output terminal to be connected to the second-voltage line or the first control output terminal under control of the n-th stage driving signal.

The third control circuit is electrically connected to the second control output terminal, the first-voltage line, the second-voltage line and the n-th stage driving output terminal respectively, and is used to invert the signal output by the second control output terminal, and output the inverting signal through the n-th stage driving output terminal.

The first energy storage circuit is electrically connected to the control signal terminal and is used to maintain a potential of the control signal terminal.

The second energy storage circuit is electrically connected to the second control output terminal, and is used to maintain a potential of the second control output terminal.

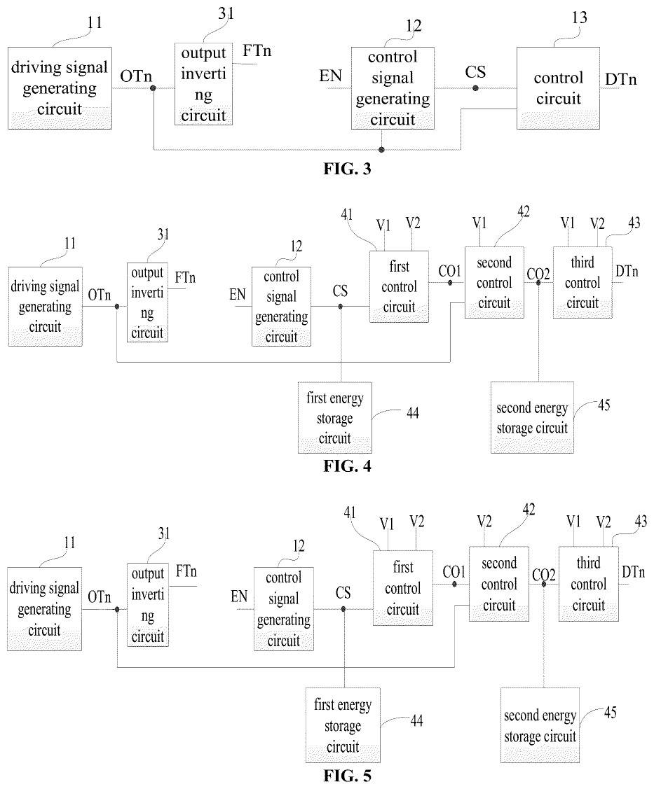

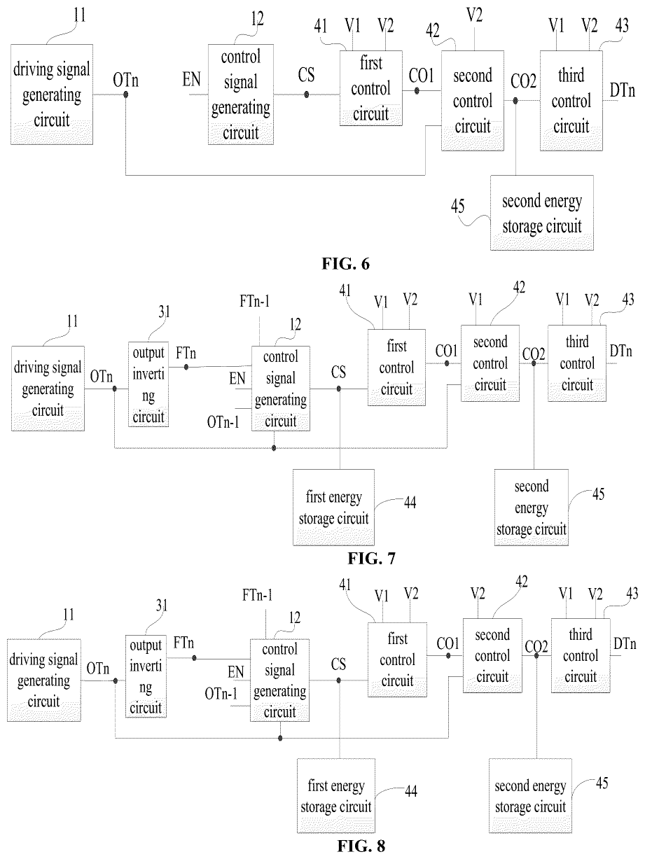

As shown in FIG. 4, on basis of at least one embodiment of the driving circuit shown in FIG. 3, the control circuit includes a first control circuit 41, a second control circuit 42, a third control circuit 43, a first energy storage circuit 44 and a second energy storage circuit 45.

The first control circuit 41 is electrically connected to the control signal terminal CS, the first-voltage line V1, the second-voltage line V2 and the first control output terminal CO1 respectively, and is used to invert the control signal to obtain an inverting control signal, and output the inverting control signal through the first control output terminal CO1.

The second control circuit 42 is electrically connected to an n-th stage driving signal output terminal OTn, a first-voltage line V1, a first control output terminal CO1 and a second control output terminal CO2 respectively, and is used to control the second control output terminal CO2 to be connected to the first-voltage line V1 or the first control output terminal CO1 under control of an n-th stage driving signal.

The third control circuit 43 is electrically connected to a second control output terminal CO2, the first-voltage line V1, the second-voltage line V2 and an n-th stage driving output terminal DTn, respectively, and is used to invert a signal output by the second control output terminal CO2, and output the inverting signal through the n-th stage driving output terminal DTn.

The first energy storage circuit 44 is electrically connected to the control signal terminal CS, and is used to maintain a potential of the control signal terminal CS.

The second energy storage circuit 45 is electrically connected to the second control output terminal CO2 and is used to maintain a potential of the second control output terminal CO2.

As shown in FIG. 5, on basis of at least one embodiment of the driving circuit shown in FIG. 3, the control circuit includes a first control circuit 41, a second control circuit 42, a third control circuit 43, a first energy storage circuit 44 and a second energy storage circuit 45.

The first control circuit 41 is electrically connected to the control signal terminal CS, the first-voltage line V1, the second-voltage line V2 and the first control output terminal CO1 respectively, and is used to invert the control signal to obtain an inverting control signal, and output the inverting control signal through the first control output terminal CO1.

The second control circuit 42 is electrically connected to the n-th stage driving signal output terminal OTn, the first control output terminal CO1, the second control output terminal CO2 and the second-voltage line V2, respectively, and is used to control the second control output terminal CO2 to be connected to the second-voltage line V2 or the first control output terminal CO1 under control of the n-th stage driving signal.

The third control circuit 43 is electrically connected to the second control output terminal CO2, the first-voltage line V1, the second-voltage line V2 and the n-th stage driving output terminal DTn, respectively, and is used to invert a signal output by the second control output terminal CO2, and output the inverting signal through the n-th stage driving output terminal DTn.

The first energy storage circuit 44 is electrically connected to the control signal terminal CS, and is used to maintain a potential of the control signal terminal CS.

The second energy storage circuit 45 is electrically connected to the second control output terminal CO2, and is used to maintain a potential of the second control output terminal CO2.

In at least one embodiment of the present disclosure, the control circuit includes a first control circuit, a second control circuit, a third control circuit, a fourth control circuit, and a second energy storage circuit.

The first control circuit is electrically connected to the control signal terminal, the first-voltage line, the second-voltage line and the first control output terminal respectively, and is used to invert the control signal to obtain an inverting control signal, and output the inverting control signal through the first control output terminal.

The second control circuit is electrically connected to the n-th stage driving signal output terminal, the first control output terminal, the second control output terminal and the second-voltage line respectively, and is used to control the second control output terminal to be connected to the second-voltage line or the first control output terminal under control of the n-th stage driving signal.

The third control circuit is electrically connected to the second control output terminal, the first-voltage line, the second-voltage line and the n-th stage driving output terminal respectively, and is used to invert the signal output by the second control output terminal, and output the inverting signal through the n-th stage driving output terminal.

The second energy storage circuit is electrically connected to the second control output terminal, and is used to maintain a potential of the second control output terminal.

As shown in FIG. 6, on basis of at least one embodiment of the driving circuit shown in FIG. 1, the control circuit includes a first control circuit 41, a second control circuit 42, a third control circuit 43, a fourth control circuit 40 and a second energy storage circuit 45.

The first control circuit 41 is electrically connected to a control signal terminal CS, a first-voltage line V1, a second-voltage line V2 and a first control output terminal CO1 respectively, and is used to invert a control signal to obtain an inverting control signal, and output the inverting control signal through the first control output terminal CO1.

The second control circuit 42 is electrically connected to an n-th stage driving signal output terminal OTn, the first control output terminal CO1, a second control output terminal CO2 and the second-voltage line V2, respectively, and is used to control the second control output terminal CO2 to be connected to the second-voltage line V2 or the first control output terminal CO1 under control of an n-th stage driving signal.

The third control circuit 43 is electrically connected to the second control output terminal CO2, the first-voltage line V1, the second-voltage line V2 and the n-th stage driving output terminal DTn, respectively, and is used to invert a signal output by the second control output terminal CO2, and output the inverting signal through the n-th stage driving output terminal DTn.

The second energy storage circuit 45 is electrically connected to the second control output terminal CO2 and is used to maintain a potential of the second control output terminal CO2.

In at least one embodiment of the present disclosure, the control signal generating circuit is further electrically connected to a (n−1)-th stage driving signal output terminal, a (n−1)-th stage inverting signal output terminal, an n-th stage driving signal output terminal and an n-th stage inverting signal output terminal, respectively, and is used to control connection or disconnection between the enable signal line and the control signal terminal under control of a (n−1)-th stage driving signal, a (n−1)-th stage inverting driving signal, an n-th stage driving signal and an n-th stage inverting driving signal.

In a specific implementation, the (n−1)-th stage driving signal output terminal is used to provide a (n−1)-th stage driving signal, and the (n−1)-th stage inverting signal output terminal is used to provide a (n−1)-th stage inverting driving signal.

As shown in FIG. 7, on the basis of at least one embodiment of the driving circuit shown in FIG. 4, the control signal generating circuit 12 is further electrically connected to a (n−1)-th stage driving signal output terminal OTn−1, a (n−1)-th stage inverting signal output terminal FTn−1, the n-th stage driving signal output terminal OTn and the n-th stage inverting signal output terminal FTn, respectively, and is used to control connection or disconnection between the enable signal line EN and the control signal terminal CS under control of the (n−1)-th stage driving signal, the (n−1)-th stage inverting driving signal, the (n−1)-th stage driving signal and the n-th stage inverting driving signal.

As shown in FIG. 8, on the basis of at least one embodiment of the driving circuit shown in FIG. 5, the control signal generating circuit 12 is further electrically connected to the (n−1)-th stage driving signal output terminal OTn−1, the (n−1)-th stage inverting signal output terminal FTn−1, the n-th stage driving signal output terminal OTn and the n-th stage inverting signal output terminal FTn, respectively, and is used to control connection or disconnection between the enable signal line EN and the control signal terminal CS under control of a (n−1)-th stage driving signal, a (n−1)-th stage inverting driving signal, an n-th stage driving signal and an n-th stage inverting driving signal.

Optionally, the first control circuit includes a first control transistor, a second control transistor, a third control transistor and a fourth control transistor, the second control circuit includes a fifth control transistor and a sixth control transistor; the third control circuit includes a seventh control transistor and an eighth control transistor. The first energy storage circuit includes a first capacitor, and the second energy storage circuit includes a second capacitor.

A gate electrode of the first control transistor is electrically connected to the control signal terminal, a first electrode of the first control transistor is electrically connected to the first-voltage line, and a second electrode of the first control transistor is electrically connected to the first control output terminal.

A gate electrode of the second control transistor is electrically connected to the control signal terminal, a first electrode of the second control transistor is electrically connected to the first control output terminal, and a second electrode of the second control transistor is electrically connected to the second-voltage line.

A gate electrode of the third control transistor is electrically connected to the first control output terminal, a first electrode of the third control transistor is electrically connected to the first-voltage line, and a second electrode of the third control transistor is electrically connected to the control signal terminal.

A gate electrode of the fourth control transistor is electrically connected to the first control output terminal, a first electrode of the fourth control transistor is electrically connected to the control signal terminal, and a second electrode of the fourth control transistor is electrically connected to the second-voltage line.

A gate electrode of the fifth control transistor and a gate electrode of the sixth control transistor are both electrically connected to the n-th stage driving signal output terminal, a first electrode of the fifth control transistor is electrically connected to the first-voltage line, and a second electrode of the fifth control transistor is electrically connected to the second control output terminal.

A first electrode of the sixth control transistor is electrically connected to the second control output terminal, and a second electrode of the sixth control transistor is electrically connected to the first control output terminal.

A gate electrode of the seventh control transistor is electrically connected to the second control output terminal, a first electrode of the seventh control transistor is electrically connected to the first-voltage line, and a second electrode of the seventh control transistor is electrically connected to the n-th stage driving output terminal.

A gate electrode of the eighth control transistor is electrically connected to the second control output terminal, a first electrode of the eighth control transistor is electrically connected to the n-th stage driving output terminal, and a second electrode of the eighth control transistor is electrically connected to the second-voltage line.

A first electrode plate of the first capacitor is electrically connected to the second-voltage line, and a second electrode plate of the first capacitor is electrically connected to the control signal terminal.

A first electrode plate of the second capacitor is electrically connected to the second control output terminal, and a second electrode plate of the second capacitor is electrically connected to the second-voltage line.

The first control transistor, the third control transistor, the fifth control transistor and the seventh control transistor are all p-type transistors, and the second control transistor, the fourth control transistor, the sixth control transistor and the eighth control transistor are all n-type transistors.

Optionally, the control signal generating circuit includes a ninth control transistor, a tenth control transistor, an eleventh control transistor and a twelfth control transistor.

A gate electrode of the ninth control transistor is electrically connected to the (n−1)-th stage inverting signal output terminal, a first electrode of the ninth control transistor is electrically connected to the enable signal line, and a second electrode of the ninth control transistor is electrically connected to the first electrode of the eleventh control transistor.

A gate electrode of the tenth control transistor is electrically connected to the (n−1)-th stage driving signal output terminal, a first electrode of the tenth control transistor is electrically connected to the enable signal line, and a second electrode of the tenth control transistor is electrically connected to a first electrode of the eleventh control transistor.

A gate electrode of the eleventh control transistor is electrically connected to the n-th stage driving signal output terminal, and a second electrode of the eleventh control transistor is electrically connected to the control signal terminal.

A gate electrode of the twelfth control transistor is electrically connected to the n-th stage inverting signal output terminal, a first electrode of the twelfth control transistor is electrically connected to the first electrode of the eleventh control transistor, and a second electrode of the twelfth control transistor is electrically connected to the control signal terminal.

The ninth control transistor and the eleventh control transistor are p-type transistors, and the tenth control transistor and the twelfth control transistor are n-type transistors.

Optionally, the first control circuit includes a first control transistor, a second control transistor, a third control transistor and a fourth control transistor; the second control circuit includes a fifth control transistor and a sixth control transistor; the third control circuit includes a seventh control transistor and an eighth control transistor; the first energy storage circuit includes a first capacitor; and the second energy storage circuit includes a second capacitor.

A gate electrode of the first control transistor is electrically connected to the control signal terminal, a first electrode of the first control transistor is electrically connected to the first-voltage line, and a second electrode of the first control transistor is electrically connected to the first control output terminal.

A gate electrode of the second control transistor is electrically connected to the control signal terminal, a first electrode of the second control transistor is electrically connected to the first control output terminal, and a second electrode of the second control transistor is electrically connected to the second-voltage line.

A gate electrode of the third control transistor is electrically connected to the first control output terminal, a first electrode of the third control transistor is electrically connected to the first-voltage line, and a second electrode of the third control transistor is electrically connected to the control signal terminal.

A gate electrode of the fourth control transistor is electrically connected to the first control output terminal, a first electrode of the fourth control transistor is electrically connected to the control signal terminal, and a second electrode of the fourth control transistor is electrically connected to the second-voltage line.

A gate electrode of the fifth control transistor and a gate electrode of the sixth control transistor are both electrically connected to the n-th stage driving signal output terminal, a first electrode of the fifth control transistor is electrically connected to the first control output terminal, and a second electrode of the fifth control transistor is electrically connected to the second control output terminal.

A first electrode of the sixth control transistor is electrically connected to the second control output terminal, and a second electrode of the sixth control transistor is electrically connected to the second-voltage line.

A gate electrode of the seventh control transistor is electrically connected to the second control output terminal, a first electrode of the seventh control transistor is electrically connected to the first-voltage line, and a second electrode of the seventh control transistor is electrically connected to the n-th stage driving output terminal.

A gate electrode of the eighth control transistor is electrically connected to the second control output terminal, a first electrode of the eighth control transistor is electrically connected to the n-th stage driving output terminal, and a second electrode of the eighth control transistor is electrically connected to the second-voltage line.

A first electrode plate of the first capacitor is electrically connected to the second-voltage line, and a second electrode plate of the first capacitor is electrically connected to the control signal terminal.

A first electrode plate of the second capacitor is electrically connected to the second control output terminal, and a second electrode plate of the second capacitor is electrically connected to the second-voltage line.

The first control transistor, the third control transistor, the fifth control transistor and the seventh control transistor are all p-type transistors, and the second control transistor, the fourth control transistor, the sixth control transistor and the eighth control transistor are all n-type transistors.

Optionally, the control signal generating circuit includes a ninth control transistor, a tenth control transistor, an eleventh control transistor and a twelfth control transistor.

A gate electrode of the ninth control transistor is electrically connected to the n-th stage inverting signal output terminal, a first electrode of the ninth control transistor is electrically connected to the enable signal line, and the second electrode of the ninth control transistor is electrically connected to a first electrode of the eleventh control transistor.

A gate electrode of the tenth control transistor is electrically connected to the n-th stage driving signal output terminal, a first electrode of the tenth control transistor is electrically connected to the enable signal line, and a second electrode of the tenth control transistor is electrically connected to the first electrode of the eleventh control transistor.

A gate electrode of the eleventh control transistor is electrically connected to the (n−1)-th stage driving signal output terminal, and a second electrode of the eleventh control transistor is electrically connected to the control signal terminal.

A gate electrode of the twelfth control transistor is electrically connected to the (n−1)-th stage inverting signal output terminal, a first electrode of the twelfth control transistor is electrically connected to the first electrode of the eleventh control transistor, and a second electrode of the twelfth control transistor is electrically connected to the control signal terminal.

The ninth control transistor and the eleventh control transistor are p-type transistors, and the tenth control transistor and the twelfth control transistor are n-type transistors.

In at least one embodiment of the present disclosure, the control signal generating circuit is used to invert the enable signal to generate an inverting enable signal, and output the inverting enable signal through the control signal terminal.

Optionally, the first control circuit includes a first control transistor, a second control transistor, a third control transistor and a fourth control transistor; the second control circuit includes a fifth control transistor and a sixth control transistor; the third control circuit includes a seventh control transistor and an eighth control transistor; and the second energy storage circuit includes a second capacitor.

A gate electrode of the first control transistor is electrically connected to the control signal terminal, a first electrode of the first control transistor is electrically connected to the first-voltage line, and the second electrode of the first control transistor is electrically connected to the first control output terminal.

A gate electrode of the second control transistor is electrically connected to the control signal terminal, a first electrode of the second control transistor is electrically connected to the first control output terminal, and a second electrode of the second control transistor is electrically connected to the second-voltage line.

A gate electrode of the third control transistor is electrically connected to the first control output terminal, a first electrode of the third control transistor is electrically connected to the first-voltage line, and a second electrode of the third control transistor is electrically connected to the control signal terminal.

A gate electrode of the fourth control transistor is electrically connected to the first control output terminal, a first electrode of the fourth control transistor is electrically connected to the control signal terminal, and a second electrode of the fourth control transistor is electrically connected to the second-voltage line.

A gate electrode of the fifth control transistor and a gate electrode of the sixth control transistor are both electrically connected to the n-th stage driving signal output terminal, a first electrode of the fifth control transistor is electrically connected to the first control output terminal, and a second electrode of the fifth control transistor is electrically connected to the second control output terminal.

A first electrode of the sixth control transistor is electrically connected to the second control output terminal, and a second electrode of the sixth control transistor is electrically connected to the second-voltage line.

A gate electrode of the seventh control transistor is electrically connected to the second control output terminal; a first electrode of the seventh control transistor is electrically connected to the first-voltage line, and a second electrode of the seventh control transistor is electrically connected to the n-th stage driving output terminal.

A gate electrode of the eighth control transistor is electrically connected to the second control output terminal, a first electrode of the eighth control transistor is electrically connected to the n-th stage driving output terminal, and a second electrode of the eighth control transistor is electrically connected to the second-voltage line.

A first electrode plate of the second capacitor is electrically connected to the second control output terminal, and a second electrode plate of the second capacitor is electrically connected to the second-voltage line.

The first control transistor, the third control transistor, the fifth control transistor and the seventh control transistor are all p-type transistors, and the second control transistor, the fourth control transistor, the sixth control transistor and the eighth control transistor are all n-type transistors.

Optionally, the control signal generating circuit includes a ninth control transistor and a tenth control transistor.

A gate electrode of the ninth control transistor is electrically connected to the enable signal line, a first electrode of the ninth control transistor is electrically connected to the first-voltage line, and a second electrode of the ninth control transistor is electrically connected to the control signal terminal.

A gate electrode of the tenth control transistor is electrically connected to the enable signal line, a first electrode of the tenth control transistor is electrically connected to the control signal terminal, and a second electrode of the tenth control transistor is electrically connected to the second-voltage line.

The ninth control transistor is a p-type transistor, and the tenth control transistor is an n-type transistor.

Optionally, the output inverting circuit includes a thirteenth control transistor and a fourteenth control transistor.

A gate electrode of the thirteenth control transistor is electrically connected to the n-th stage driving signal output terminal, a first electrode of the thirteenth control transistor is electrically connected to the first-voltage line, and a second electrode of the thirteenth control transistor is electrically connected to the n-th stage inverting signal output terminal.

A gate electrode of the fourteenth control transistor is electrically connected to the n-th stage driving signal output terminal, a first electrode of the fourteenth control transistor is electrically connected to the n-th stage inverting signal output terminal, and a second electrode of the fourteenth control transistor is electrically connected to the second-voltage line.

The thirteenth control transistor is a p-type transistor, and the fourteenth control transistor is an n-type transistor.

In at least one embodiment of the present disclosure, the driving signal generating circuit includes a first node control circuit, a second node control circuit, a first output node control circuit, a second output node control circuit, a potential maintaining circuit and an output circuit.

The first node control circuit is electrically connected to a first node, a first clock signal line, the second-voltage line and a second output node, respectively, and is used to control connection between the first node and the second-voltage line under control of a first clock signal provided by the first clock signal line, and to control connection or disconnection between the first node and the first clock signal line under control of a potential of the second output node.

The second node control circuit is electrically connected to the first node, a first intermediate node, the first-voltage line, the second clock signal line, the second node, the input terminal and the second-voltage line respectively, and is used to control connection between the first intermediate node and the first-voltage line under control of the potential of the first node, control the connection between the first intermediate node and the second clock signal line under control of the potential of the second node, and control the potential of the second node according to the potential of the first intermediate node, and control connection between the input terminal and the second node under control of the second clock signal provided by the second clock signal line and the second-voltage signal provided by the second-voltage line.

The first output node control circuit is electrically connected to the first output node, the first node, the second clock signal line, the second intermediate node, the second output node and the first-voltage line respectively, and is used to control connection between the second intermediate node and the second clock signal line under control of the potential of the first node, control the potential of the second intermediate node according to the potential of the first node, control the connection between the second intermediate node and the first output node under control of the second clock signal provided by the second clock signal line, and control the connection between the first output node and the first-voltage line under control of the potential of the second output node.

The second output node control circuit is electrically connected to the second clock signal line, the input terminal, the control voltage line, the first-voltage line, the second node, and the second output node, respectively, and is used to control connection between the second output node and the input terminal under control of the second clock signal provided by the second clock signal line, and control the potential of the second output node according to the potential of the second node, and control the connection between the second output node and the first-voltage line under control of the control voltage provided by the control voltage line.

The potential maintaining circuit is electrically connected to the first output node, and is used to maintain the potential of the first output node.

The output circuit is electrically connected to the first output node, the second output node, the first-voltage line, the second-voltage line and the n-th stage driving signal output terminal, respectively, and is used to control the connection between the n-th stage driving signal output terminal and the first-voltage line under control of the potential of the first output node, and to control the connection between the n-th stage driving signal output terminal and the second-voltage line under control of the potential of the second output node.

Optionally, the first-voltage line may be a high-voltage line, and the second-voltage line may be a low-voltage line.

In a specific implementation, the driving signal generating circuit may include a first node control circuit, a second node control circuit, a first output node control circuit, a second output node control circuit, a potential maintaining circuit and an output circuit. The first node control circuit controls the potential of the first node. The second node control circuit controls the potential of the second node. The first output node control circuit controls the potential of the output node. The second output node control circuit controls the potential of the second output node. The potential maintaining circuit maintains the potential of the first output node. The output circuit controls the connection between the n-th stage driving signal output terminal and the first-voltage line under control of the potential of the first output node, and controls the connection between the n-th stage driving signal output terminal and the second-voltage line under control of the potential of the second output node.

In at least one embodiment of the present disclosure, the structure of the driving signal generating circuit is not limited to the above structure.

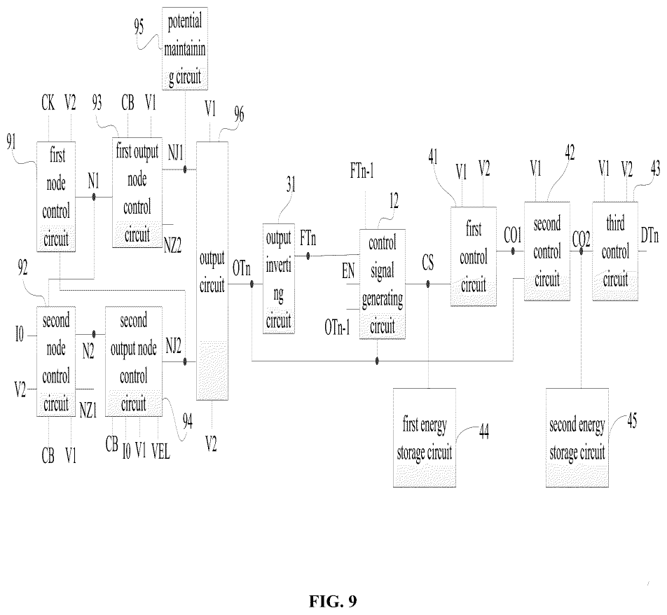

As shown in FIG. 9, on basis of at least one embodiment of the driving circuit shown in FIG. 7, the driving signal generating circuit includes a first node control circuit 91, a second node control circuit 92, a first output node control circuit 93, a second output node control circuit 94, a potential maintaining circuit 95 and an output circuit 96.

The first node control circuit 91 is electrically connected to a first node N1, a first clock signal line CK, a second-voltage line V2 and a second output node NJ2, respectively, and is used to control connection between the first node N1 and the second-voltage line V2 under control of a first clock signal provided by the first clock signal line CK, and to control connection or disconnection between the first node N1 and the first clock signal line CK under control of a potential of the second output node NJ2.

The second node control circuit 92 is electrically connected to the first node N1, a first intermediate node NZ1, the first-voltage line V1, the second clock signal line CB, the second node N2, an input terminal I0 and the second-voltage line V2, respectively, and is used to control connection between the first intermediate node NZ1 and the first-voltage line V1 under control of the potential of the first node N1, and to control connection between the first intermediate node NZ1 and the second clock signal line CB under control of the potential of the second node N2, and to control the potential of the second node N2 according to the potential of the first intermediate node NZ1, and to control connection between the input terminal and the second node under control of a second clock signal provided by the second clock signal line CB and a second-voltage signal provided by the second-voltage line V2.

The first output node control circuit 93 is electrically connected to the first output node NJ1, the first node N1, the second clock signal line CB, the second intermediate node NZ2, the second output node NJ2 and the first-voltage line V1, respectively, and is used to control connection between the second intermediate node NZ2 and the second clock signal line CB under control of the potential of the first node N1, control the potential of the second intermediate node NZ2 according to the potential of the first node N1, control the connection between the second intermediate node NZ2 and the first output node NJ1 under control of the second clock signal provided by the second clock signal line CB, and control the connection between the first output node NJ1 and the first-voltage line V1 under control of the potential of the second output node NJ2.

The second output node control circuit 94 is electrically connected to the second clock signal line CB, the input terminal I0, the control voltage line VEL, the first-voltage line V1, the second node N2 and the second output node NJ2, respectively, and is used to control connection between the second output node NJ2 and the input terminal I0 under control of the second clock signal provided by the second clock signal line CB, control the potential of the second output node NJ2 according to the potential of the second node N2, and control the connection between the second output node NJ2 and the first-voltage line V1 under control of the control voltage provided by the control voltage line VEL.

The potential maintaining circuit 95 is electrically connected to the first output node NJ1 and is used to maintain the potential of the first output node NJ1.

The output circuit 96 is electrically connected to the first output node NJ1, the second output node NJ2, the first-voltage line V1, the second-voltage line V2 and the n-th stage driving signal output terminal OTn, respectively, and is used to control the connection between the n-th stage driving signal output terminal OTn and the first-voltage line V1 under control of the potential of the first output node NJ1, and to control the connection between the n-th stage driving signal output terminal OTn and the second-voltage line V2 under control of the potential of the second output node NJ2.

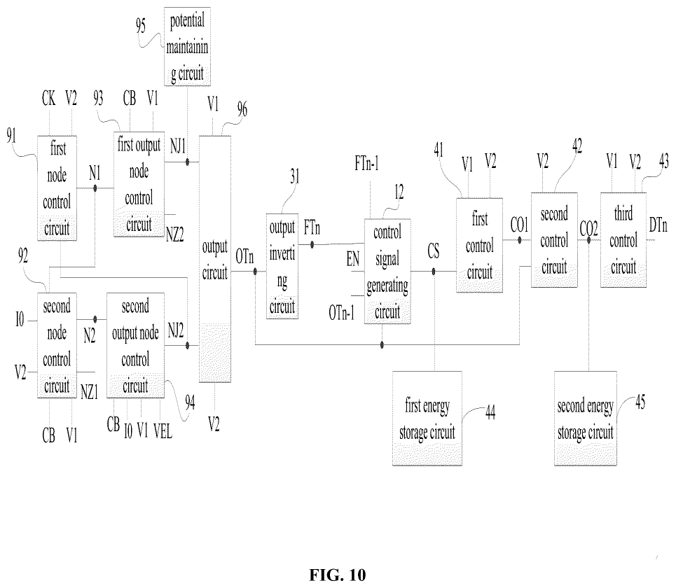

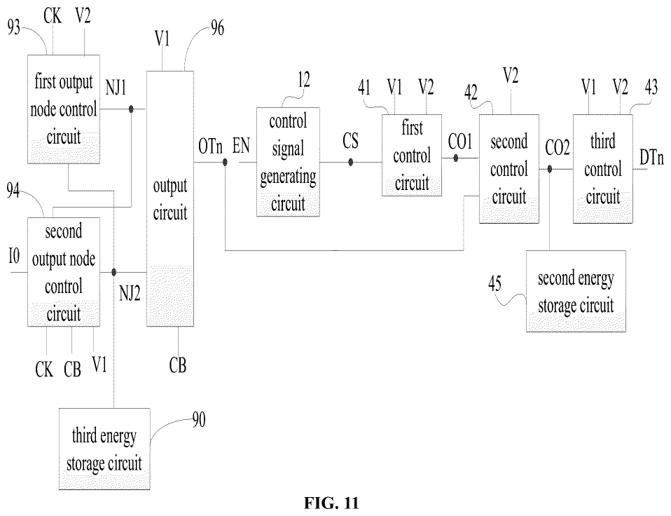

As shown in FIG. 10, on basis of at least one embodiment of the driving circuit shown in FIG. 8, the driving signal generating circuit includes a first node control circuit 91, a second node control circuit 92, a first output node control circuit 93, a second output node control circuit 94, a potential maintaining circuit 95 and an output circuit 96.

The first node control circuit 91 is electrically connected to the first node N1, the first clock signal line CK, the second-voltage line V2 and the second output node NJ2, respectively, and is used to control the connection between the first node N1 and the second-voltage line V2 under control of the first clock signal provided by the first clock signal line CK, and to control connection or disconnection between the first node N1 and the first clock signal line CK under control of the potential of the second output node NJ2.

The second node control circuit 92 is electrically connected to the first node N1, the first intermediate node NZ1, the first-voltage line V1, the second clock signal line CB, the second node N2, the input terminal I0 and the second-voltage line V2, respectively, and is used to control the connection between the first intermediate node NZ1 and the first-voltage line V1 under control of the potential of the first node N1, control the connection between the first intermediate node NZ1 and the second clock signal line CB under control of the potential of the second node N2, and control the potential of the second node N2 according to the potential of the second intermediate node NZ2, and control the connection between the input terminal and the second node N2 under control of the second clock signal provided by the second clock signal line CB and the second-voltage signal provided by the second-voltage line V2.

The first output node control circuit 93 is electrically connected to the first output node NJ1, the first node N1, the second clock signal line CB, the second intermediate node NZ2, the second output node NJ2 and the first-voltage line V1, respectively, and is used to control connection between the second intermediate node NZ2 and the second clock signal line CB under control of the potential of the first node N1, control the potential of the second intermediate node NZ2 according to the potential of the first node N1, control the connection between the second intermediate node NZ2 and the first output node NJ1 under control of the second clock signal provided by the second clock signal line CB, and control the connection between the first output node NJ1 and the first-voltage line V1 under control of the potential of the second output node NJ2.

The second output node control circuit 94 is electrically connected to the second clock signal line CB, the input terminal I0, the control voltage line VEL, the first-voltage line V1, the second node N2 and the second output node NJ2, respectively, and is used to control connection between the second output node NJ2 and the input terminal I0 under control of the second clock signal provided by the second clock signal line CB, control the potential of the second output node NJ2 according to the potential of the second node N2, and control the connection between the second output node NJ2 and the first-voltage line V1 under control of the control voltage provided by the control voltage line VEL.

The potential maintaining circuit 95 is electrically connected to the first output node NJ1 and is used to maintain the potential of the first output node NJ1.

The output circuit 96 is electrically connected to the first output node NJ1, the second output node NJ2, the first-voltage line V1, the second-voltage line V2 and the n-th stage driving signal output terminal OTn, respectively, and is used to control connection between the n-th stage driving signal output terminal OTn and the first-voltage line V1 under control of the potential of the first output node NJ1, and to control connection between the n-th stage driving signal output terminal OTn and the second-voltage line V2 under control of the potential of the second output node NJ2.

Optionally, the first node control circuit includes a first transistor, a second transistor and a third transistor; the second output node control circuit includes a fourth transistor, a fifth transistor, a sixth transistor and a seventh transistor.

A gate electrode of the first transistor is electrically connected to the first clock signal line, a first electrode of the first transistor is electrically connected to the second-voltage line, and a second electrode of the first transistor is electrically connected to the first electrode of the third transistor.

A gate electrode of the second transistor is electrically connected to a second electrode of the fourth transistor, a first electrode of the second transistor is electrically connected to the first clock signal line, and a second electrode of the second transistor is electrically connected to a first electrode of the third transistor.

A gate electrode of the third transistor is electrically connected to the second-voltage line, and a second electrode of the third transistor is electrically connected to the first node.

A gate electrode of the fourth transistor is electrically connected to the first clock signal line, and a first electrode of the fourth transistor is electrically connected to the input terminal.

A gate electrode of the fifth transistor is electrically connected to the second-voltage line, a first electrode of the fifth transistor is electrically connected to a second electrode of the fourth transistor, and a second electrode of the fifth transistor is electrically connected to the second output node.

A gate electrode of the sixth transistor and a first electrode of the sixth transistor are both electrically connected to the second node, and a second electrode of the sixth transistor is electrically connected to the second output node.

A gate electrode of the seventh transistor is electrically connected to the control voltage line, a first electrode of the seventh transistor is electrically connected to the first-voltage line, and a second electrode of the seventh transistor is electrically connected to the first electrode of the fifth transistor.

The second node control circuit includes an eighth transistor, a ninth transistor, a tenth transistor, an eleventh transistor and a third capacitor.

A gate electrode of the eighth transistor is electrically connected to the second node, a first electrode of the eighth transistor is electrically connected to the second clock signal line, and a second electrode of the eighth transistor is electrically connected to the first intermediate node.

A gate electrode of the ninth transistor is electrically connected to the second electrode of the first transistor, a first electrode of the ninth transistor is electrically connected to the first-voltage line, and a second electrode of the ninth transistor is electrically connected to the first intermediate node.

A gate electrode of the tenth transistor is electrically connected to the first clock signal line, a first electrode of the tenth transistor is electrically connected to the input terminal, and a second electrode of the tenth transistor is electrically connected to a first electrode of the eleventh transistor.

A gate electrode of the eleventh transistor is electrically connected to the second-voltage line, and a second electrode of the eleventh transistor is electrically connected to the second node.

A first electrode plate of the third capacitor is electrically connected to the second node, and a second electrode plate of the third capacitor is electrically connected to the first intermediate node.

The first output node control circuit includes a twelfth transistor, a thirteenth transistor, a fourteenth transistor and a fourth capacitor.

A gate electrode of the twelfth transistor is electrically connected to the first node, a first electrode of the twelfth transistor is electrically connected to the second clock signal line, and a second electrode of the twelfth transistor is electrically connected to the second intermediate node.

A gate electrode of the thirteenth transistor is electrically connected to the second clock signal line, a first electrode of the thirteenth transistor is electrically connected to the second intermediate node, and a second electrode of the thirteenth transistor is electrically connected to the first output node.

A gate electrode of the fourteenth transistor is electrically connected to the first electrode of the fifth transistor, a first electrode of the fourteenth transistor is electrically connected to the first-voltage line, and a second electrode of the fourteenth transistor is electrically connected to the first output node.

A first electrode plate of the fourth capacitor is electrically connected to the first node, and a second electrode plate of the fourth capacitor is electrically connected to the second intermediate node.

The potential maintaining circuit includes a fifth capacitor.

A first electrode plate of the fifth capacitor is electrically connected to the first output node, and a second electrode plate of the fifth capacitor is electrically connected to the first-voltage line.

The output circuit includes a fifteenth transistor and a sixteenth transistor.

A gate electrode of the fifteenth transistor is electrically connected to the first output node, a first electrode of the fifteenth transistor is electrically connected to the first-voltage line, and a second electrode of the fifteenth transistor is electrically connected to the n-th stage driving signal output terminal.

A gate electrode of the sixteenth transistor is electrically connected to the second output node, a first electrode of the sixteenth transistor is electrically connected to the n-th stage driving signal output terminal, and a second electrode of the sixteenth transistor is electrically connected to the second-voltage line.

In at least one embodiment of the present disclosure, the driving signal generating circuit includes a first output node control circuit, a second output node control circuit, a third energy storage circuit and an output circuit.

The first output node control circuit is electrically connected to the first clock signal line, the second-voltage line, and the second output node, respectively, and is used to control connection between the first output node and the second-voltage line under control of the first clock signal provided by the first clock signal line, and control connection between the first output node and the first clock signal line under control of the potential of the second output node, and is used to maintain the potential of the first output node.

The second output node control circuit is electrically connected to the second output node, the first clock signal line, the input terminal, the second clock signal line, the first output node and the first-voltage line respectively, and is used to control connection between the second output node and the input terminal under control of the first clock signal, and control connection between the second output node and the first-voltage line under control of the potential of the first output node and a second clock signal provided by the second clock signal line.

A first end of the third energy storage circuit is electrically connected to the second output node, a second end of the third energy storage circuit is electrically connected to the n-th stage driving signal output terminal, and the third energy storage circuit is used to store electric energy.

The output circuit is electrically connected to the first output node, the second output node, the first-voltage line, the second clock signal and the n-th stage driving signal output terminal, respectively, and is used to control connection between the n-th stage driving signal output terminal and the first-voltage line under control of the potential of the first output node, and to control the connection between the n-th stage driving signal output terminal and the second clock signal line under control of the potential of the second output node.

In a specific implementation, the driving signal generating circuit may include a first output node control circuit, a second output node control circuit, a third energy storage circuit and an output circuit. The first output node control circuit controls the potential of the first output node. The second output node control circuit controls the potential of the second output node. The output circuit controls the connection between the n-th stage driving signal output terminal and the first-voltage line under control of the potential of the first output node, and controls the connection between the n-th stage driving signal output terminal and the second clock signal line under control of the potential of the second output node.

As shown in FIG. 11, on basis of at least one embodiment of the driving circuit shown in FIG. 6, the driving signal generating circuit includes a first output node control circuit 93, a second output node control circuit 94, a third energy storage circuit 90 and an output circuit 96.

The first output node control circuit 93 is electrically connected to a first clock signal line CK, a second-voltage line V2, a first output node NJ1 and a second output node NJ2 respectively, and is used to control connection between the first output node NJ1 and the second-voltage line V2 under control of the first clock signal provided by the first clock signal line CK, and to control the connection between the first output node NJ1 and the first clock signal line CK under control of the potential of the second output node NJ2, and to maintain the potential of the first output node NJ1.

The second output node control circuit 94 is electrically connected to the second output node NJ2, the first clock signal line CK, the input terminal I0, the second clock signal line CB, the first output node NJ1 and the first-voltage line V1, respectively, and is used to control connection between the second output node NJ2 and the input terminal I0 under control of the first clock signal, and control the connection between the second output node NJ2 and the first-voltage line V1 under control of the potential of the first output node NJ1 and the second clock signal provided by the second clock signal line CB.

A first end of the third energy storage circuit 90 is electrically connected to the second output node NJ2, a second end of the third energy storage circuit 90 is electrically connected to the n-th stage driving signal output terminal OTn, and the third energy storage circuit 90 is used to store electric energy.

The output circuit 96 is electrically connected to the first output node NJ1, the second output node NJ2, the first-voltage line V1, the second clock signal CB and the n-th stage driving signal output terminal OTn, respectively, and is used to control the connection between the n-th stage driving signal output terminal OTn and the first-voltage line V1 under control of the potential of the first output node NJ1, and to control the connection between the n-th stage driving signal output terminal OTn and the second clock signal line CB under control of the potential of the second output node NJ2.

Optionally, the first output node control circuit includes a seventeenth transistor, an eighteenth transistor and a sixth capacitor.

A gate electrode of the seventeenth transistor is electrically connected to the first clock signal line, a first electrode of the seventeenth transistor is electrically connected to the second-voltage line, and a second electrode of the seventeenth transistor is electrically connected to the first output node.

A gate electrode of the eighteenth transistor is electrically connected to the second output node, a first electrode of the eighteenth transistor is electrically connected to the first clock signal line, and a second electrode of the eighteenth transistor is electrically connected to the first output node.

A first electrode plate of the sixth capacitor is electrically connected to the first output node, and a second electrode plate of the sixth capacitor is electrically connected to the first-voltage line.

The second output node control circuit includes a nineteenth transistor, a twentieth transistor, and a twenty-first transistor; the third energy storage circuit includes a seventh capacitor.

A gate electrode of the nineteenth transistor is electrically connected to the first clock signal line, a first electrode of the nineteenth transistor is electrically connected to the input terminal, and a second electrode of the nineteenth transistor is electrically connected to the second output node.

A gate electrode of the twentieth transistor is electrically connected to the first output node, a first electrode of the twentieth transistor is electrically connected to the first-voltage line, and a second electrode of the twentieth transistor is electrically connected to a first electrode of the twenty-first transistor.

A gate electrode of the twenty-first transistor is electrically connected to the second clock signal line, and a second electrode of the twenty-first transistor is electrically connected to the second output node.

A first electrode plate of the seventh capacitor is electrically connected to the second output node, and a second electrode plate of the seventh capacitor is electrically connected to the n-th stage driving signal output terminal.

The output circuit includes a twenty-second transistor and a twenty-third transistor.

A gate electrode of the twenty-second transistor is electrically connected to the first output node, a first electrode of the twenty-second transistor is electrically connected to the first-voltage line, and a second electrode of the twenty-second transistor is electrically connected to the n-th stage driving signal output terminal.

A gate electrode of the twenty-third transistor is electrically connected to the second output node, a first electrode of the twenty-third transistor is electrically connected to the n-th stage driving signal output terminal, and a second electrode of the twenty-third transistor is electrically connected to the second clock signal line.

The driving circuit further includes a twenty-fourth transistor.

A second electrode of the twenty-first transistor is electrically connected to the second output node through the twenty-fourth transistor; a gate electrode of the twenty-fourth transistor is electrically connected to the second-voltage line, a first electrode of the twenty-fourth transistor is electrically connected to the second electrode of the twenty-first transistor, and the second electrode of the twenty-fourth transistor is electrically connected to the second output node.

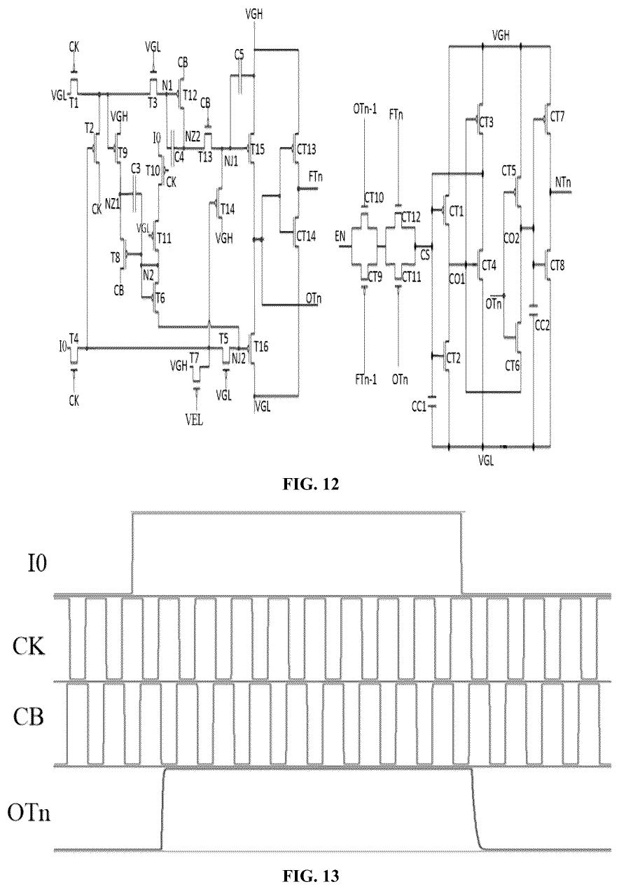

As shown in FIG. 12, on basis of at least one embodiment of the driving circuit shown in FIG. 9, the n-th stage driving output terminal is an n-th stage first scanning terminal NTn.

The first control circuit includes a first control transistor CT1, a second control transistor CT2, a third control transistor CT3 and a fourth control transistor CT4; the second control circuit includes a fifth control transistor CT5 and a sixth control transistor CT6; the third control circuit includes a seventh control transistor CT7 and an eighth control transistor CT8; the first energy storage circuit includes a first capacitor CC1, and the second energy storage circuit includes a second capacitor CC2.

A gate electrode of CT1 is electrically connected to the control signal terminal CS, a source electrode of CT1 is electrically connected to a high-voltage line VGH, and a drain electrode of CT1 is electrically connected to the first control output terminal CO1.

A gate electrode of CT2 is electrically connected to the control signal terminal CS, a source electrode of CT2 is electrically connected to the first control output terminal CO1, and a drain electrode of CT2 is electrically connected to the low-voltage line VGL.

A gate electrode of CT3 is electrically connected to the first control output terminal CO1, a source electrode of CT3 is electrically connected to the high-voltage line VGH, and a drain electrode of CT3 is electrically connected to the control signal terminal CS.

A gate electrode of CT4 is electrically connected to the first control output terminal CO1, a source electrode of CT4 is electrically connected to the control signal terminal CS, and a drain electrode of CT4 is electrically connected to the low-voltage line VGL.

A gate electrode of CT5 and a gate electrode of CT6 are both electrically connected to the n-th stage driving signal output terminal OTn, a source electrode of CT5 is electrically connected to the high-voltage line VGH, and a drain electrode of CT5 is electrically connected to the second control output terminal CO2.

A source electrode of CT6 is electrically connected to the second control output terminal CO2, and a drain electrode of CT6 is electrically connected to the first control output terminal CO1.

A gate electrode of CT7 is electrically connected to the second control output terminal CO2, a source electrode of CT7 is electrically connected to the high-voltage line VGH, and a drain electrode of CT7 is electrically connected to the n-th stage first scanning terminal NTn.

A gate electrode of CT8 is electrically connected to the second control output terminal CO2, a source electrode of CT8 is electrically connected to the n-th stage first scanning terminal NTn, and a drain electrode of CT8 is electrically connected to the low-voltage line VGL.

A second electrode plate of CC1 is electrically connected to the control signal terminal CS, and a first electrode plate of CC1 is electrically connected to the low-voltage line VGL.

A first electrode plate of CC2 is electrically connected to the second control output terminal CO2, and a second electrode plate of CC2 is electrically connected to the low-voltage line VGL.

CT1, CT3, CT5 and CT7 are all p-type transistors, and CT2, CT4, CT6 and CT8 are all n-type transistors.

The control signal generating circuit includes a ninth control transistor CT9, a tenth control transistor CT10, an eleventh control transistor CT11 and a twelfth control transistor CT12.

A gate electrode of CT9 is electrically connected to the (n−1)-th stage inverting signal output terminal FTn−1, a source electrode of CT9 is electrically connected to the enable signal line EN, and a drain electrode of CT9 is electrically connected to the source electrode of the eleventh control transistor CT11.

A gate electrode of CT10 is electrically connected to the (n−1)-th stage driving signal output terminal OTn−1, a source electrode of CT10 is electrically connected to the enable signal line EN, and a drain electrode of CT10 is electrically connected to the source electrode of CT11.

A gate electrode of CT11 is electrically connected to the n-th stage driving signal output terminal OTn, and a drain electrode of CT11 is electrically connected to the control signal terminal CS.

A gate electrode of CT12 is electrically connected to the n-th stage inverting signal output terminal FTn, a source electrode of CT12 is electrically connected to the drain electrode of CT11, and a drain electrode of CT12 is electrically connected to the control signal terminal CS.

CT9 and CT11 are p-type transistors, and CT10 and CT12 are n-type transistors.

The output inverting circuit includes a thirteenth control transistor CT13 and a fourteenth control transistor CT14.

A gate electrode of CT13 is electrically connected to the n-th stage driving signal output terminal OTn, a source electrode of CT13 is electrically connected to the high-voltage line VGH, and a drain electrode of CT13 is electrically connected to the n-th stage inverting signal output terminal FTn.

A gate electrode of CT14 is electrically connected to the n-th stage driving signal output terminal OTn, a source electrode of CT14 is electrically connected to the n-th stage inverting signal output terminal FTn, and a drain electrode of CT14 is electrically connected to the low-voltage line VGL.

CT13 is a p-type transistor, and CT14 is an n-type transistor.

The first node control circuit includes a first transistor T1, a second transistor T2 and a third transistor T3; the second output node control circuit includes a fourth transistor T4, a fifth transistor T5, a sixth transistor T6 and a seventh transistor T7.

A gate electrode of T1 is electrically connected to the first clock signal line CK, a source electrode of T1 is electrically connected to the low-voltage line VGL, and a drain electrode of T1 is electrically connected to a source electrode of T3.

A gate electrode of T2 is electrically connected to a drain electrode of T4, a source electrode of T2 is electrically connected to the first clock signal line CK, and a drain electrode of T2 is electrically connected to a source electrode of T3.

A gate electrode of T3 is electrically connected to the low-voltage line VGL, and a drain electrode of T3 is electrically connected to the first node N1.

A gate electrode of T4 is electrically connected to the first clock signal line CK, and a source electrode of T4 is electrically connected to the input terminal I0.

A gate electrode of T5 is electrically connected to the low-voltage line VGL, a source electrode of T5 is electrically connected to a drain electrode of T4, and a drain electrode of T5 is electrically connected to the second output node NJ2.

A gate electrode of T6 and a source electrode of T6 are both electrically connected to the second node N2, and a drain electrode of T6 is electrically connected to the second output node NJ2.

A gate electrode of T7 is electrically connected to the control voltage line VEL, a source electrode of T7 is electrically connected to the high-voltage line VGH, and a drain electrode of T7 is electrically connected to the source electrode of T5.

The second node control circuit includes an eighth transistor T8, a ninth transistor T9, a tenth transistor T10, an eleventh transistor T11 and a third capacitor C3.

A gate electrode of T8 is electrically connected to the second node N2, a source electrode of T8 is electrically connected to the second clock signal line CB, and a drain electrode of T8 is electrically connected to the first intermediate node NZ1.

A gate electrode of T9 is electrically connected to the drain electrode of T1, a source electrode of T9 is electrically connected to the high-voltage line VGH, and a drain electrode of T9 is electrically connected to the first intermediate node NZ1.

A gate electrode of T10 is electrically connected to the first clock signal line CK, a source electrode of T10 is electrically connected to the input terminal I0, and a drain electrode of T10 is electrically connected to the drain electrode of T11.

A gate electrode of T11 is electrically connected to the low-voltage line VGL, and a drain electrode of T11 is electrically connected to the second node N2.

A second electrode plate of C3 is electrically connected to the first intermediate node NZ1, and a first electrode plate of C3 is electrically connected to the second node N2.

The first output node control circuit includes a twelfth transistor T12, a thirteenth transistor T13, a fourteenth transistor T14 and a fourth capacitor C4.

A gate electrode of T12 is electrically connected to the first node N1, a source electrode of T12 is electrically connected to the second clock signal line CB, and a drain electrode of T12 is electrically connected to the second intermediate node NX2.

A gate electrode of T13 is electrically connected to the second clock signal line CB, a source electrode of T13 is electrically connected to the second intermediate node NZ2, and a drain electrode of T13 is electrically connected to the first output node NJ1.

A gate electrode of T14 is electrically connected to a source electrode of T5, a source electrode of T14 is electrically connected to the high-voltage line VGH, and a drain electrode of T14 is electrically connected to the first output node NJ1.

A first electrode plate of C4 is electrically connected to the first node N1, and a second electrode plate of C4 is electrically connected to the second intermediate node NZ2.

The potential maintaining circuit includes a fifth capacitor C5.

A first electrode plate of C5 is electrically connected to the first output node NJ1, and a second electrode plate of C5 is electrically connected to the high-voltage line VGH.

The output circuit includes a fifteenth transistor T15 and a sixteenth transistor T16.

A gate electrode of T15 is electrically connected to the first output node NJ1, a source electrode of T15 is electrically connected to the high-voltage line VGH, and a drain electrode of T15 is electrically connected to the n-th stage driving signal output terminal OTn.

A gate electrode of T16 is electrically connected to the second output node NJ2, a source electrode of T16 is electrically connected to the n-th stage driving signal output terminal OTn, and a drain electrode of T16 is electrically connected to the low-voltage line VGL.

In at least one embodiment of the driving circuit shown in FIG. 12, T1-T16 may be p-type transistors.

In at least one embodiment of the driving circuit shown in FIG. 12, the driving signal generating circuit is a 16T3C circuit. In actual operation, the driving signal generating circuit may also be a circuit having other structures for generating an n-th stage driving signal.

In at least one embodiment of the driving circuit shown in FIGS. 12, T3 and T5 may not be provided.

FIG. 13 is an operation timing diagram of a driving signal generating circuit in at least one embodiment of the driving circuit shown in FIG. 12.

When at least one embodiment of the driving circuit shown in FIG. 12 is in operation, when a display device including the driving circuit just starts to operate, VEL provides a low voltage signal and T7 is turned on to control connection between the gate electrode of T14 and VGH, so that T14 is turned off; thereafter, when the driving circuit is in operation, VEL always provides a high voltage signal, so that T7 is turned off.

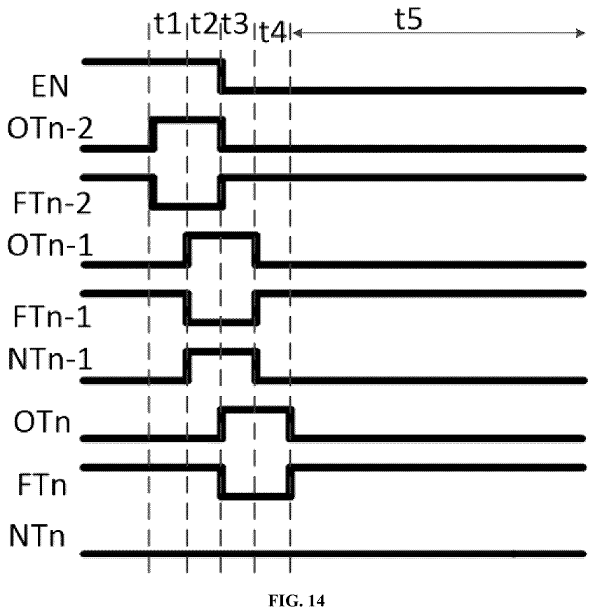

FIG. 14 is an operation timing diagram of at least one embodiment of the (n−1)-th stage driving circuit and at least one embodiment of the n-th stage driving circuit; the structure of the n-th stage driving circuit is shown in FIG. 12.

The structure of the (n−1)-th stage driving circuit is the same as the structure of the n-th stage driving circuit shown in FIG. 12. The differences between the structure of the (n−1)-th stage driving circuit and the n-th stage driving circuit shown in FIG. 12 include:
a drain electrode of T15 is electrically connected to the (n−1)-th stage driving signal output terminal OTn−1, and a drain electrode of CT13 is electrically connected to the (n−1)-th stage inverting signal output terminal FTn−1;
a gate electrode of CT10 is electrically connected to a (n−2)-th stage driving signal output terminal OTn−2, a gate electrode of CT9 is electrically connected to a (n−2)-th stage inverting signal output terminal FTn−2, a gate electrode of CT12 is electrically connected to the (n−1)-th stage inverting signal output terminal FTn−1, a gate electrode of CT11 and a gate electrode of CT5 are electrically connected to the (n−1)-th stage driving signal output terminal OTn−1, and a drain electrode of CT7 is electrically connected to the (n−1)-th stage first scanning terminal NTn−1.

As shown in FIG. 14, when at least one embodiment of the (n−1)-th stage driving circuit and at least one embodiment of the n-th stage driving circuit are in operation,
in a first stage t1, EN outputs a high voltage signal, OTn−2 provides a high voltage signal, FTn−2 provides a low voltage signal, OTn−1 provides a low voltage signal, FTn−1 provides a high voltage signal, OTn provides a low voltage signal, and FTn provides a high voltage signal.

In the (n−1)-th stage driving circuit, CT10 and CT9 are turned on, CT11 and CT12 are turned on, EN is coupled to CS, and the potential of CS is low voltage; CT1 is turned on, CO1 outputs a high voltage signal, CT4 is turned on, and CS is coupled to VGL; OTn−1 provides a low voltage signal, CT5 is turned on, CO2 outputs a high voltage signal, CT8 is turned on, and NTn−1 provides a low voltage signal.

In the n-th stage driving circuit, CT9 and C10 are turned off, EN is decoupled from CS; OTn provides a low voltage signal, CT5 is turned on, CO2 outputs a high voltage signal, CT8 is turned on, and NTn provides a low voltage signal.

In the second stage t2, EN provides a high voltage signal, OTn−2 provides a high voltage signal, FTn−2 provides a low voltage signal, OTn−1 provides a high voltage signal, FTn−1 provides a low voltage signal, OTn provides a low voltage signal, and FTn provides a high voltage signal.

In the (n−1)-th stage driving circuit, CT10 and CT9 are turned on, CT11 and CT12 are turned off, EN is decoupled from CS, and the potential of CS is maintained at a low voltage; CT1 is turned on, CO1 outputs a high voltage signal, CT4 is turned on, and CS is coupled to VGL; OTn−1 provides a high voltage signal, CT6 is turned on, CO2 outputs a low voltage signal, CT7 is turned on, and NTn−1 provides a high voltage signal.

In the n-th stage driving circuit, CT9 and CT10 are turned on, CT11 and CT12 are turned on, EN is coupled to CS, the potential of CS is a high voltage signal, CT2 is turned on, CO1 provides a low voltage signal, CT3 is turned on, CS is coupled to VGH; OTn provides a low voltage signal, CT5 is turned on, CO2 provides a high voltage signal, CT8 is turned on, and NTn provides a low voltage signal.

In the third stage t3, EN provides a low voltage signal, OTn−2 provides a low voltage signal, FTn−2 provides a high voltage signal, OTn−1 provides a high voltage signal, FTn−1 provides a low voltage signal, OTn provides a high voltage signal, and FTn provides a low voltage signal.

In the (n−1)-th stage driving circuit, CT9 and CT10 are turned off, EN is decoupled from CS, C11 maintains the potential of CS at a low voltage; CT1 is turned on, CO1 outputs a high voltage signal, CT4 is turned on, CS is coupled to VGL; OTn−1 provides a high voltage signal, CT6 is turned on, CO2 outputs a low voltage signal, CT7 is turned on, and NTn−1 provides a high voltage signal.

In the n-th stage driving circuit, CT11 and CT12 are turned off, EN is decoupled from CS, the potential of CS is a high voltage signal, CT2 is turned on, CO1 provides a low voltage signal, CT3 is turned on, CS is coupled to VGH; OTn provides a high voltage signal, CT6 is turned on, CO2 provides a high voltage signal, CT8 is turned on, and NTn provides a low voltage signal.

In the fourth stage t4, EN provides a low voltage signal, OTn−2 provides a low voltage signal, FTn−2 provides a high voltage signal, OTn−1 provides a low voltage signal, FTn−1 provides a high voltage signal, OTn provides a high voltage signal, and FTn provides a low voltage signal.

In the (n−1)-th stage driving circuit, CT9 and CT10 are turned off, EN is decoupled from CS, C11 maintains the potential of CS at a low voltage; CT1 is turned on, CO1 outputs a high voltage signal, CT4 is turned on, CS is coupled to VGL; OTn−1 provides a low voltage signal, CT5 is turned on, CO2 outputs a high voltage signal, CT8 is turned on, and NTn−1 provides a low voltage signal.

In the n-th stage driving circuit, CT9 and CT10 are turned off, EN is decoupled from CS, the potential of CS is a high voltage signal, CT2 is turned on, CO1 provides a low voltage signal, CT3 is turned on, CS is coupled to VGH; OTn provides a high voltage signal, CT6 is turned on, CO2 provides a high voltage signal, CT8 is turned on, and NTn provides a low voltage signal.

In the fifth stage t5, EN provides a low voltage signal, OTn−2 provides a low voltage signal, FTn−2 provides a high voltage signal, OTn−1 provides a low voltage signal, FTn−1 provides a high voltage signal, OTn provides a low voltage signal, and FTn provides a high voltage signal.

In the (n−1)-th stage driving circuit, CT9 and CT10 are turned off, EN is decoupled from CS, C11 maintains the potential of CS at a low voltage; CT1 is turned on, CO1 outputs a high voltage signal, CT4 is turned on, CS is coupled to VGL; OTn−1 provides a low voltage signal, CT5 is turned on, CO2 outputs a high voltage signal, CT8 is turned on, and NTn−1 provides a low voltage signal.

In the n-th stage driving circuit, CT9 and CT10 are turned off, EN is decoupled from CS, the potential of CS is a high voltage signal, CT2 is turned on, CO1 provides a low voltage signal, CT3 is turned on, CS is coupled to VGH; OTn provides a low voltage signal, CT5 is turned on, CO2 provides a high voltage signal, CT8 is turned on, and NTn provides a low voltage signal.

As shown in FIG. 14, NTn provides an invalid voltage signal, and NTn−1 provides a valid (n−1)-th stage first scanning signal, which can control the transistor whose gate is electrically connected to NTn in the pixel circuit of the n-th row to be turned off so as not to perform scanning; when the potential of the (n−1)-th stage first scanning signal is a valid voltage, the transistor whose gate is electrically connected to NTn−1 in the pixel circuit of the (n−1)-th row is controlled to be turned on so as to perform normal scanning; thereby achieving the purpose of local refresh.

Since the transistor in the pixel circuit electrically connected to NTn is an n-type transistor, the invalid voltage signal provided by NTn is a low voltage signal.

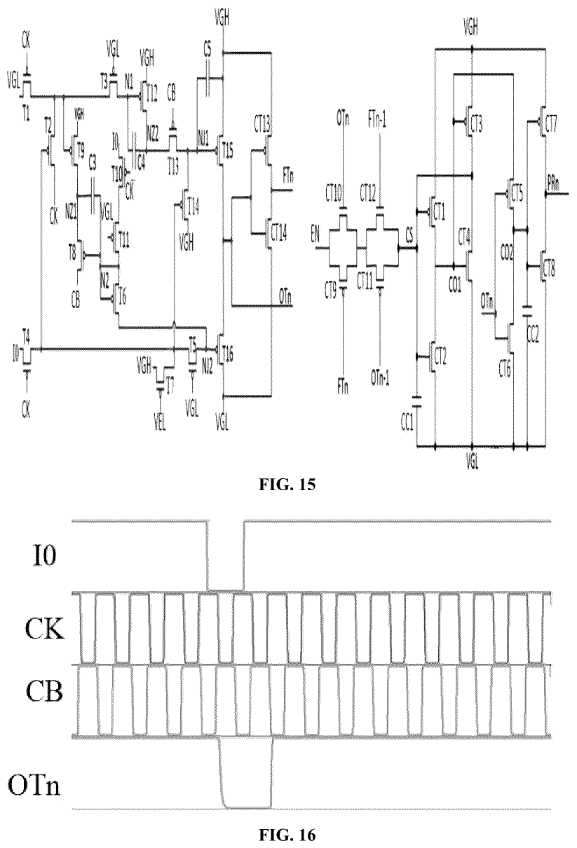

As shown in FIG. 15, on basis of at least one embodiment of the driving circuit shown in FIG. 10, the n-th stage driving output terminal is an n-th stage first reset terminal PRn.

The first control circuit includes a first control transistor CT1, a second control transistor CT2, a third control transistor CT3 and a fourth control transistor CT4; the second control circuit includes a fifth control transistor CT5 and a sixth control transistor CT6; the third control circuit includes a seventh control transistor CT7 and an eighth control transistor CT8; the first energy storage circuit includes a first capacitor CC1, and the second energy storage circuit includes a second capacitor CC2.

A gate electrode of CT1 is electrically connected to the control signal terminal CS, a source electrode of CT1 is electrically connected to the high-voltage line VGH, and a drain electrode of CT1 is electrically connected to the first control output terminal CO1.

A gate electrode of CT2 is electrically connected to the control signal terminal CS, a source electrode of CT2 is electrically connected to the first control output terminal CO1, and a drain electrode of CT2 is electrically connected to the low-voltage line VGL.

A gate electrode of CT3 is electrically connected to the first control output terminal CO1, a source electrode of CT3 is electrically connected to the high-voltage line VGH, and a drain electrode of CT3 is electrically connected to the control signal terminal CS.

A gate electrode of CT4 is electrically connected to the first control output terminal CO1, a source electrode of CT4 is electrically connected to the control signal terminal CS, and a drain electrode of CT4 is electrically connected to the low-voltage line VGL.

A gate electrode of CT5 and a gate electrode of CT6 are both electrically connected to the n-th stage driving signal output terminal OTn, a source electrode of CT5 is electrically connected to the first control output terminal CO1, and a drain electrode of CT5 is electrically connected to the second control output terminal CO2.

A source electrode of CT6 is electrically connected to the second control output terminal CO2, and a drain electrode of CT6 is electrically connected to the low-voltage line VGL.

A gate electrode of CT7 is electrically connected to the second control output terminal CO2, a source electrode of CT7 is electrically connected to the high-voltage line VGH, and a drain electrode of CT7 is electrically connected to the n-th stage first reset terminal PRn.

A gate electrode of CT8 is electrically connected to the second control output terminal CO2, a source electrode of CT8 is electrically connected to the n-th stage first reset terminal PRn, and a drain electrode of CT8 is electrically connected to the low-voltage line VGL.

A first electrode plate of CC1 is electrically connected to the low-voltage line VGL, and a second electrode plate of CC1 is electrically connected to the control signal terminal CS.

A first electrode plate of CC2 is electrically connected to the second control output terminal CO2, and a second electrode plate of CC2 is electrically connected to the low-voltage line VGL.

CT1, CT2, CT5 and CT7 are all p-type transistors, and CT2, CT4, CT6 and CT8 are all n-type transistors.

The control signal generating circuit includes a ninth control transistor CT9, a tenth control transistor CT10, an eleventh control transistor CT11 and a twelfth control transistor CT12.

A gate electrode of CT9 is electrically connected to the n-th stage inverting signal output terminal FTn, a source electrode of CT9 is electrically connected to the enable signal line EN, and a drain electrode of CT9 is electrically connected to the source electrode of CT11.

A gate electrode of CT10 is electrically connected to the n-th stage driving signal output terminal OTn, a source electrode of CT10 is electrically connected to the enable signal line EN, and a drain electrode of CT10 is electrically connected to the source electrode of CT11.

A gate electrode of CT11 is electrically connected to the (n−1)-th stage driving signal output terminal OTn−1, and a drain electrode of CT11 is electrically connected to the control signal terminal CS.

A gate electrode of CT12 is electrically connected to the (n−1)-th stage inverting signal output terminal FTn−1, a source electrode of CT12 is electrically connected to the source electrode of CT11, and a drain electrode of CT12 is electrically connected to the control signal terminal CS.

CT9 and CT11 are p-type transistors, and CT10 and CT12 are n-type transistors.

The output inverting circuit includes a thirteenth control transistor CT13 and a fourteenth control transistor CT14.

A gate electrode of CT13 is electrically connected to the n-th stage driving signal output terminal OTn, a source electrode of CT13 is electrically connected to the high-voltage line VGH, and a drain electrode of CT13 is electrically connected to the n-th stage inverting signal output terminal FTn.

A gate electrode of CT14 is electrically connected to the n-th stage driving signal output terminal OTn, a source electrode of CT14 is electrically connected to the n-th stage inverting signal output terminal FTn, and a drain electrode of CT14 is electrically connected to the low-voltage line VGL.

CT13 is a p-type transistor, and CT14 is an n-type transistor.

The first node control circuit includes a first transistor T1, a second transistor T2 and a third transistor T3; the second output node control circuit includes a fourth transistor T4, a fifth transistor T5, a sixth transistor T6 and a seventh transistor T7.

A gate electrode of T1 is electrically connected to the first clock signal line CK, a source electrode of T1 is electrically connected to the low-voltage line VGL, and a drain electrode of T1 is electrically connected to the source electrode of T3.

A gate electrode of T2 is electrically connected to a drain electrode of T4, a source electrode of T2 is electrically connected to the first clock signal line CK, and a drain electrode of T2 is electrically connected to the source electrode of T3.

A gate electrode of T3 is electrically connected to the low-voltage line VGL, and a drain electrode of T3 is electrically connected to the first node N1.

A gate electrode of T4 is electrically connected to the first clock signal line CK, and a source electrode of T4 is electrically connected to the input terminal I0.

A gate electrode of T5 is electrically connected to the low-voltage line VGL, a source electrode of T5 is electrically connected to the drain electrode of T4, and a drain electrode of T5 is electrically connected to the second output node NJ2.

A gate electrode of T6 and a source electrode of T6 are both electrically connected to the second node N2, and a drain electrode of T6 is electrically connected to the second output node NJ2.

A gate electrode of T7 is electrically connected to the control voltage line VEL, a source electrode of T7 is electrically connected to the high-voltage line VGH, and a drain electrode of T7 is electrically connected to the source electrode of T5.

The second node control circuit includes an eighth transistor T8, a ninth transistor T9, a tenth transistor T10, an eleventh transistor T11 and a third capacitor C3.

A gate electrode of T8 is electrically connected to the second node N2, a source electrode of T8 is electrically connected to the second clock signal line CB, and a drain electrode of T8 is electrically connected to the first intermediate node NZ1.

A gate electrode of T9 is electrically connected to the drain electrode of T1, a source electrode of T9 is electrically connected to the high-voltage line VGH, and a drain electrode of T9 is electrically connected to the first intermediate node NZ1.

A gate electrode of T10 is electrically connected to the first clock signal line CK, a source electrode of T10 is electrically connected to the input terminal I0, and a drain electrode of T10 is electrically connected to ae drain electrode of T11.

A gate electrode of T11 is electrically connected to the low-voltage line VGL, and a drain electrode of T11 is electrically connected to the second node N2.

A second electrode plate of C3 is electrically connected to the first intermediate node NZ1, and a second electrode plate of C3 is electrically connected to the first node N1.

The first output node control circuit includes a twelfth transistor T12, a thirteenth transistor T13, a fourteenth transistor T14 and a fourth capacitor C4.

A gate electrode of T12 is electrically connected to the first node N1, a source electrode of T12 is electrically connected to the second clock signal line CB, and a drain electrode of T12 is electrically connected to the second intermediate node NX2.

A gate electrode of T13 is electrically connected to the second clock signal line CB, a source electrode of T13 is electrically connected to the second intermediate node NZ2, and a drain electrode of T13 is electrically connected to the first output node NJ1.

A gate electrode of T14 is electrically connected to the source electrode of T5, a source electrode of T14 is electrically connected to the high-voltage line VGH, and a drain electrode of T14 is electrically connected to the first output node NJ1.

A first electrode plate of C4 is electrically connected to the first node N1, and a second electrode plate of C4 is electrically connected to the second intermediate node NZ2.

The potential maintaining circuit includes a fifth capacitor C5.

A first electrode plate of C5 is electrically connected to the first output node NJ1, and a second electrode plate of C5 is electrically connected to the high-voltage line VGH.

The output circuit includes a fifteenth transistor T15 and a sixteenth transistor T16.

A gate electrode of T15 is electrically connected to the first output node NJ1, a source electrode of T15 is electrically connected to the high-voltage line VGH, and a drain electrode of T15 is electrically connected to the n-th stage driving signal output terminal OTn.

A gate electrode of T16 is electrically connected to the second output node NJ2, a source electrode of T16 is electrically connected to the n-th stage driving signal output terminal OTn, and a drain electrode of T16 is electrically connected to the low-voltage line VGL.

In at least one embodiment of the driving circuit shown in FIG. 15, T1-T16 may be p-type transistors.

In at least one embodiment of the driving circuit shown in FIG. 15, the driving signal generating circuit is a 16T2C circuit. In actual operation, the driving signal generating circuit may also be a circuit having other structures for generating an n-th stage driving signal.

FIG. 16 is an operation timing diagram of a driving signal generating circuit in at least one embodiment of the driving circuit shown in FIG. 15.

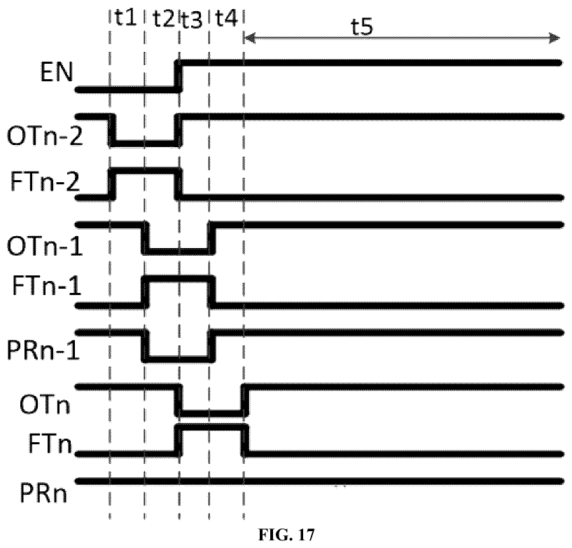

FIG. 17 is an operation timing diagram of at least one embodiment of the (n−1)-th stage driving circuit and at least one embodiment of the n-th stage driving circuit; the structure of the n-th stage driving circuit is shown in FIG. 15.

The structure of the (n−1)-th stage driving circuit is the same as the structure of the n-th stage driving circuit shown in FIG. 15. The differences between the structure of the (n−1)-th stage driving circuit and the n-th stage driving circuit shown in FIG. 15 include:
a drain electrode of T15 is electrically connected to the (n−1)-th stage driving signal output terminal OTn−1, and a drain electrode of CT13 is electrically connected to the (n−1)-th stage inverting signal output terminal FTn−1;
a gate electrode of CT10 is electrically connected to the (n−1)-th stage driving signal output terminal OTn−1, a gate electrode of CT9 is electrically connected to the (n−1)-th stage inverting signal output terminal FTn−1, a gate electrode of CT12 is electrically connected to the (n−2)-th stage inverting signal output terminal FTn−2, a gate electrode of CT11 is electrically connected to the (n−2)-th stage driving signal output terminal OTn−2, a drain electrode of CT7 is electrically connected to the (n−1)-th stage first reset terminal PRn−1, and a gate electrode of CT5 is electrically connected to the (n−1)-th stage driving signal output terminal OTn−1.

As shown in FIG. 17, when at least one embodiment of the (n−1)-th stage driving circuit and at least one embodiment of the n-th stage driving circuit are in operation,
in the first stage t1, EN outputs a low voltage signal, OTn−2 provides a low voltage signal, FTn−2 provides a high voltage signal, OTn−1 provides a high voltage signal, FTn−1 provides a low voltage signal, OTn provides a high voltage signal, and FTn provides a low voltage signal.

In the (n−1)-th stage driving circuit, CT9 and CT10 are turned on, CT11 and CT12 are turned on, EN is coupled to CS, the potential of CS is low voltage, CT1 is turned on, CO1 outputs a high voltage signal, CT4 is turned on, CS is coupled to VGL, OTn−1 provides a high voltage signal, CT6 is turned on, CO2 provides a low voltage signal, CT7 is turned on, and PRn−1 provides a high voltage signal.

In the n-th stage driving circuit, CT9 and CT10 are turned on, CT11 and CT12 are turned off, and EN is decoupled from CS.

In the second stage t2, EN outputs a low voltage signal, OTn−2 provides a low voltage signal, FTn−2 provides a high voltage signal, OTn−1 provides a low voltage signal, FTn−1 provides a high voltage signal, OTn provides a high voltage signal, and FTn provides a low voltage signal.

In the (n−1)-th stage driving circuit, CT9 and CT10 are turned off, EN is decoupled from CS, the potential of CS is maintained at a low voltage, CT1 is turned on, CO1 outputs a high voltage signal, CT4 is turned on, CS is coupled to VGL, OTn−1 provides a low voltage signal, CT5 is turned on, CO2 outputs a high voltage signal, CT8 is turned on, and PRn−1 provides a low voltage signal.

In the n-th stage driving circuit, CT9 and CT10 are turned on, CT11 and CT12 are turned on, EN is connected to CS, and the potential of CS is low voltage; CT1 is turned on, CO1 outputs a high voltage signal, CT4 is turned on, and CS is coupled to VGL; OTn provides a high voltage signal, CT6 is turned on, CO2 outputs a low voltage signal, CT7 is turned on, and PRn provides a high voltage signal.

In the third stage t3, EN provides a high voltage signal, OTn−2 provides a high voltage signal, FTn−2 provides a low voltage signal, OTn−1 provides a low voltage signal, FTn−1 provides a high voltage signal, OTn provides a low voltage signal, and FTn provides a high voltage signal.

In the (n−1)-th stage driving circuit, CT9 and CT10 are turned off, EN is decoupled from CS, the potential of CS is maintained at a low voltage, CT1 is turned on, CO1 outputs a high voltage signal, CT4 is turned on, CS is coupled to VGL, OTn−1 provides a low voltage signal, CT5 is turned on, CO2 outputs a high voltage signal, CT8 is turned on, and PRn−1 provides a low voltage signal.

In the n-th stage driving circuit, CT9 and CT10 are turned off, EN is decoupled from CS, and the potential of CS is maintained at a low voltage; CT1 is turned on, CO1 outputs a high voltage signal, CT4 is turned on, and CS is coupled to VGL; OTn provides a low voltage signal, CT5 is turned on, CO2 outputs a low voltage signal, CT7 is turned on, and PRn provides a high voltage signal.

In the fourth stage t4, EN provides a high voltage signal, OTn−2 provides a high voltage signal, FTn−2 provides a low voltage signal, OTn−1 provides a high voltage signal, FTn−1 provides a low voltage signal, OTn provides a low voltage signal, and FTn provides a high voltage signal.

In the (n−1)-th stage driving circuit, CT9 and CT10 are turned on, CT11 and CT12 are turned off, EN is decoupled from CS, the potential of CS is maintained at a low voltage, CT1 is turned on, CO1 outputs a high voltage signal, CT4 is turned on, CS is coupled to VGL, OTn−1 provides a high voltage signal, CT6 is turned on, CO2 outputs a low voltage signal, CT7 is turned on, and PRn−1 provides a high voltage signal.

In the n-th stage driving circuit, CT9 and CT10 are turned off, EN is decoupled from CS, and the potential of CS is maintained at a low voltage; CT1 is turned on, CO1 outputs a high voltage signal, CT4 is turned on, and CS is coupled to VGL; OTn provides a low voltage signal, CT5 is turned on, CO2 outputs a low voltage signal, CT7 is turned on, and PRn provides a high voltage signal.

In the fifth stage t5, EN provides a high voltage signal, OTn−2 provides a high voltage signal, FTn−2 provides a low voltage signal, OTn−1 provides a high voltage signal, FTn−1 provides a low voltage signal, OTn provides a high voltage signal, and FTn provides a low voltage signal.

In the (n−1)-th stage driving circuit, CT9 and CT10 are turned on, CT11 and CT12 are turned off, EN is decoupled from CS, the potential of CS is maintained at a low voltage, CT1 is turned on, CO1 outputs a high voltage signal, CT4 is turned on, CS is coupled to VGL, OTn−1 provides a high voltage signal, CT6 is turned on, CO2 outputs a low voltage signal, CT7 is turned on, and PRn−1 provides a high voltage signal.

In the n-th stage driving circuit, CT9 and CT10 are turned on, CT11 and CT12 are turned off, EN is decoupled from CS, and the potential of CS is maintained at a low voltage; CT1 is turned on, CO1 outputs a high voltage signal, CT4 is turned on, and CS is coupled to VGL; OTn provides a high voltage signal, CT6 is turned on, CO2 outputs a low voltage signal, CT7 is turned on, and PRn provides a high voltage signal.

As shown in FIG. 17, PRn provides an invalid voltage signal, and PRn−1 provides a valid (n−1)-th stage first reset signal, which can control the transistor whose gate is electrically connected to PRn in the pixel circuit of the n-th row to be turned off so as not to perform a reset; when the potential of the (n−1)-th stage first reset signal is a valid voltage, the transistor whose gate is electrically connected to PRn−1 in the pixel circuit of the (n−1)-th row is controlled to be turned on so as to perform a normal reset.

Since the transistor in the pixel circuit electrically connected to PRn is a p-type transistor, the invalid voltage signal provided by PRn is a high voltage signal.

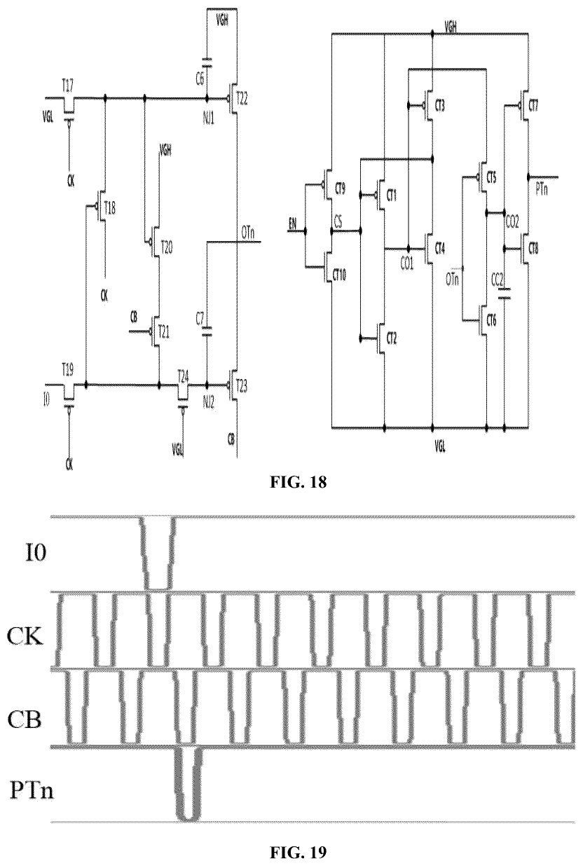

As shown in FIG. 18, on basis of at least one embodiment of the driving circuit shown in FIG. 11, the n-th stage driving output terminal is an n-th stage second scanning terminal PTn.

The first control circuit includes a first control transistor CT1, a second control transistor CT2, a third control transistor CT3 and a fourth control transistor CT4; the second control circuit includes a fifth control transistor CT5 and a sixth control transistor CT6; the third control circuit includes a seventh control transistor CT7 and an eighth control transistor CT8; and the second energy storage circuit includes a second capacitor CC2.

A gate electrode of CT1 is electrically connected to the control signal terminal CS, a source electrode of CT1 is electrically connected to the high-voltage line VGH, and a drain electrode of CT1 is electrically connected to the first control output terminal CO1.

A gate electrode of CT2 is electrically connected to the control signal terminal CS, a source electrode of CT2 is electrically connected to the first control output terminal CO1, and a drain electrode of CT2 is electrically connected to the low-voltage line VGL.

A gate electrode of CT3 is electrically connected to the first control output terminal CO1, a source electrode of CT3 is electrically connected to the high-voltage line VGH, and a drain electrode of CT3 is electrically connected to the control signal terminal CS.

A gate electrode of CT4 is electrically connected to the first control output terminal CO1, a source electrode of CT4 is electrically connected to the control signal terminal CS, and a drain electrode of CT4 is electrically connected to the low-voltage line VGL.

A gate electrode of CT5 and a gate electrode of the sixth control transistor CT6 are both electrically connected to the n-th stage driving signal output terminal OTn, a source electrode of CT5 is electrically connected to the first control output terminal CO1, and a drain electrode of CT5 is electrically connected to the second control output terminal CO2.

A source electrode of CT6 is electrically connected to the second control output terminal CO2, and a drain electrode of CT6 is electrically connected to the low-voltage line VGL.

A gate electrode of CT7 is electrically connected to the second control output terminal CO2, a source electrode of CT7 is electrically connected to the high-voltage line VGH, and a drain electrode of CT7 is electrically connected to the n-th stage second scanning terminal PTn.

A gate electrode of CT8 is electrically connected to the second control output terminal CO2, a source electrode of CT8 is electrically connected to the n-th stage second scanning terminal PTn, and a drain electrode of CT8 is electrically connected to the low-voltage line VGL.

A first electrode plate of CC2 is electrically connected to the second control output terminal CO2, and a second electrode plate of CC2 is electrically connected to the low-voltage line VGL.

CT1, CT3, CT5 and CT7 are all p-type transistors, and CT2, CT4, CT6 and CT8 are all n-type transistors.

The control signal generating circuit includes a ninth control transistor CT9 and a tenth control transistor CT10.

A gate electrode of CT9 is electrically connected to the enable signal line EN, a source electrode of CT9 is electrically connected to the high-voltage line VGH, and a drain electrode of CT9 is electrically connected to the control signal terminal CS.

A gate electrode of CT10 is electrically connected to the enable signal line EN, a source electrode of CT10 is electrically connected to the control signal terminal CS, and a drain electrode of CT10 is electrically connected to the low-voltage line VGL.

T9 is a p-type transistor, and T10 is an n-type transistor.

The first output node control circuit includes a seventeenth transistor T17, an eighteenth transistor T18 and a sixth capacitor C6.

A gate electrode of T17 is electrically connected to the first clock signal line CK, a source electrode of T17 is electrically connected to the low-voltage line VGL, and a drain electrode of the seventeenth transistor T17 is electrically connected to the first output node NJ1.

A gate electrode of T18 is electrically connected to the second output node NJ2 through T24, a source electrode of T18 is electrically connected to the first clock signal line CK, and a drain electrode of T18 is electrically connected to the first output node NJ1.

A first electrode plate of C6 is electrically connected to the first output node NJ1, and a second electrode plate of C6 is electrically connected to the high-voltage line VGH.

The second output node control circuit includes a nineteenth transistor T19, a twentieth transistor T20, and a twenty-first transistor T21; the third energy storage circuit includes a seventh capacitor C7.

A gate electrode of T19 is electrically connected to the first clock signal line CK, a source electrode of T19 is electrically connected to the input terminal I0, and a drain electrode of T19 is electrically connected to the second output node NJ2 through T24.

A gate electrode of T20 is electrically connected to the first output node NJ1, a source electrode of T20 is electrically connected to the high-voltage line VGH, and a drain electrode of T20 is electrically connected to a source electrode of the twenty-first transistor T21.

A gate electrode of T21 is electrically connected to the second clock signal line CB, and a drain electrode of T21 is electrically connected to the second output node NJ2 through T24.

A first electrode plate of C7 is electrically connected to the second output node NJ2, and a second electrode plate of C7 is electrically connected to the n-th stage driving signal output terminal OTn.

The output circuit includes a twenty-second transistor T22 and a twenty-third transistor T23.

A gate electrode of T22 is electrically connected to the first output node NJ1, a source electrode of T22 is electrically connected to the high-voltage line VGH, and a drain electrode of T22 is electrically connected to the n-th stage driving signal output terminal OTn.

A gate electrode of T23 is electrically connected to the second output node NJ2, a source electrode of T23 is electrically connected to the n-th stage driving signal output terminal OTn, and a drain electrode of T23 is electrically connected to the second clock signal line CB.

The driving circuit further includes a twenty-fourth transistor T24.

A gate electrode of T24 is electrically connected to the low-voltage line VGL, a source electrode of T24 is electrically connected to the drain electrode of the twenty-first transistor T21, and a drain electrode of T24 is electrically connected to the second output node NJ2.

In at least one embodiment of the driving circuit shown in FIG. 18, T1-T16 may be p-type transistors.

In at least one embodiment of the driving circuit shown in FIG. 18, T24 may not be provided.

In at least one embodiment of the driving circuit shown in FIG. 18, the driving signal generating circuit is an 8T2C circuit. In actual operation, the driving signal generating circuit may also adopt a circuit of other structures for generating an n-th stage driving signal.

FIG. 19 is an operation timing diagram of a driving signal generating circuit in at least one embodiment of the driving circuit shown in FIG. 18.

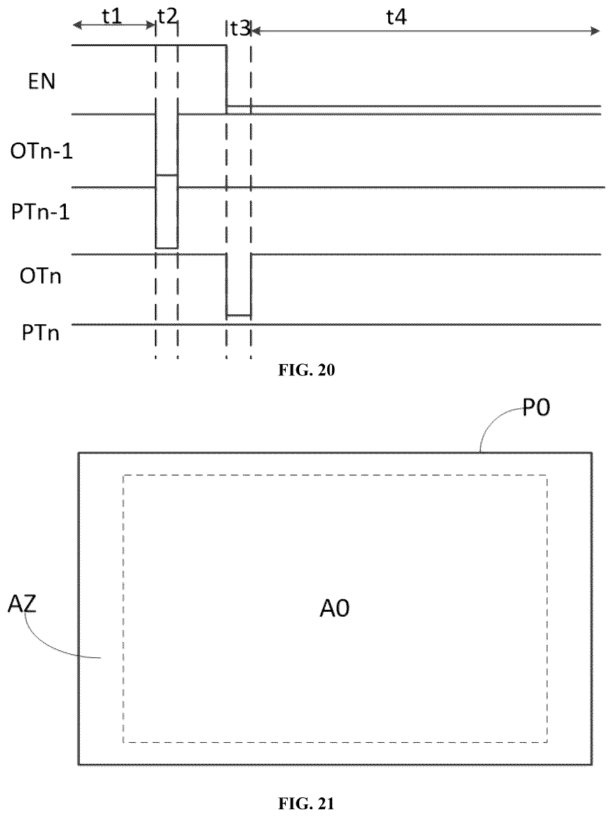

FIG. 20 is an operation timing diagram of at least one embodiment of the (n−1)-th stage driving circuit and at least one embodiment of the n-th stage driving circuit; the structure of the n-th stage driving circuit is shown in FIG. 18.

The structure of the (n−1)-th stage driving circuit is the same as the structure of the n-th stage driving circuit shown in FIG. 18. The differences between the structure of the (n−1)-th stage driving circuit and the n-th stage driving circuit shown in FIG. 18 include:
a drain electrode of T22 is electrically connected to the (n−1)-th stage driving signal output terminal OTn−1;
a gate electrode of CT5 and a gate electrode of CT6 are both electrically connected to the (n−1)-th stage driving signal output terminal OTn−1, and a drain electrode of CT7 is electrically connected to the (n−1)-th stage second scanning terminal PTn−1.

As shown in FIG. 20, when at least one embodiment of the (n−1)-th stage driving circuit and at least one embodiment of the n-th stage driving circuit are in operation,
in the first stage t1, EN provides a high voltage signal, OTn−1 provides a high voltage signal, and OTn provides a high voltage signal.

In the (n−1)-th stage driving circuit, CT10 is turned on, CS is coupled to VGL, the potential of CS is low voltage, CT2 is turned on; OTn−1 provides a high voltage signal, CT6 is turned on, CO2 outputs a low voltage signal, CT7 is turned on, and PTn−1 provides a high voltage signal.

In the n-th stage driving circuit, CT10 is turned on, CS is coupled to VGL, the potential of CS is low voltage, CT1 is turned on; OTn provides a high voltage signal, CT6 is turned on, CO2 outputs a low voltage signal, CT7 is turned on, and PTn provides a high voltage signal.

In the second phase t2, EN provides a high voltage signal, OTn−1 provides a low voltage signal, and OTn provides a high voltage signal.

In the (n−1)-th stage driving circuit, CT10 is turned on, CS is coupled to VGL, the potential of CS is low voltage, CT1 is turned on, CO outputs a high voltage signal, OTn−1 provides a low voltage signal, CT5 is turned on, CO2 outputs a high voltage signal, CT8 is turned on, and PRn−1 outputs a low voltage signal.

In the n-th stage driving circuit, CT10 is turned on, CS is coupled to VGL, the potential of CS is low voltage, CT1 is turned on; OTn provides a high voltage signal, CT6 is turned on, CO2 outputs a low voltage signal, CT7 is turned on, and PTn provides a high voltage signal.

In the third stage t3, EN provides a low voltage signal, OTn−1 provides a high voltage signal, and OTn provides a low voltage signal.

In the (n−1)-th stage driving circuit, CT9 is turned on, CS is coupled to VGH, the potential of CS is high voltage, CT2 is turned on, CO1 outputs a low voltage signal, CT3 is turned on, the source electrode of CT is coupled to VGL, OTn−1 provides a high voltage signal, CT6 is turned on, CO2 outputs a low voltage signal, CT7 is turned on, and PRn−1 outputs a high voltage signal.

In the n-th stage driving circuit, CT9 is turned on, CS is coupled to VGH, the potential of CS is high voltage, CT2 is turned on, CO1 outputs a low voltage signal, CT3 is turned on, the source electrode of CT5 is coupled to VGL, OTn provides a low voltage signal, CT5 is turned on, CO2 outputs a low voltage signal, CT7 is turned on, and PTn provides a high voltage signal.

In the fourth stage t4, EN provides a low voltage signal, OTn−1 provides a high voltage signal, and OTn provides a high voltage signal.

CT9 is turned on, CS is coupled to VGH, the potential of CS is high voltage, CT2 is turned on, CO1 outputs a low voltage signal, CT3 is turned on, the source electrode of CT is coupled to VGL, OTn−1 provides a high voltage signal, CT6 is turned on, CO2 outputs a low voltage signal, CT7 is turned on, and PRn−1 outputs a high voltage signal.

In the n-th stage driving circuit, CT9 is turned on, CS is coupled to VGH, the potential of CS is high voltage, CT2 is turned on, CO1 outputs a low voltage signal, CT3 is turned on, the source electrode of CT5 is coupled to VGL, OTn provides a high voltage signal, CT6 is turned on, CO2 outputs a low voltage signal, CT7 is turned on, and PTn provides a high voltage signal.

As shown in FIG. 20, PTn provides an invalid voltage signal, and PTn−1 provides a valid (n−1)-th stage second scanning signal, which can control the transistor whose gate is electrically connected to PTn in the pixel circuit of the n-th row to be turned off so as not to perform scanning; when the potential of the (n−1)-th stage second scanning signal is a valid voltage, the transistor whose gate is electrically connected to PTn−1 in the pixel circuit of the (n−1)-th row is controlled to be turned on so as to perform normal scanning.

Since the transistor in the pixel circuit electrically connected to PTn is a p-type transistor, the invalid voltage signal provided by PTn is a high voltage signal.

A display substrate provided in one embodiment of the present disclosure includes a base substrate and the above driving circuit arranged on the base substrate.

The display substrate includes a display area and a peripheral area; the driving circuit is arranged in the peripheral area.

As shown in FIG. 21, the display substrate P0 includes a display area A0 and a peripheral area AZ.

The driving circuit is arranged in the peripheral area AZ.

A plurality of rows and columns of pixel circuits are arranged in the display area A0.

In a specific implementation, the driving circuit may be arranged at a left side and/or a right side of the display area A01.

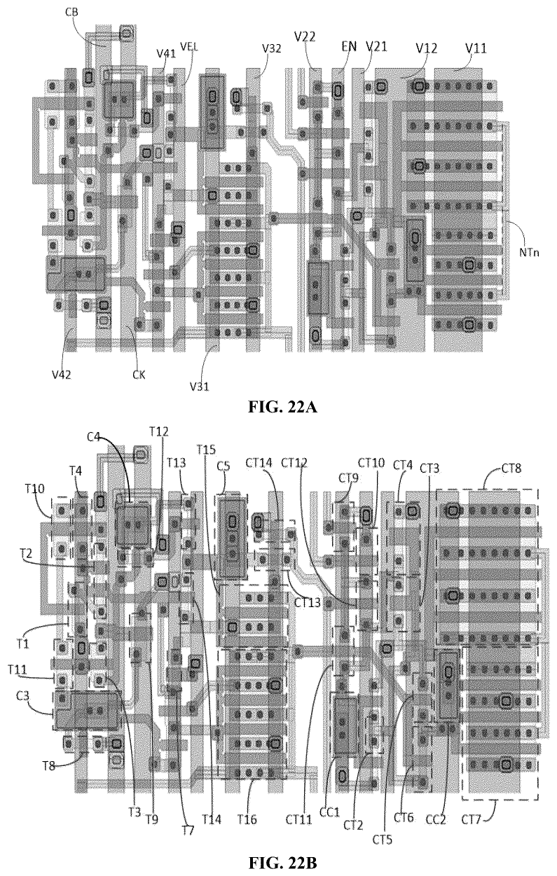

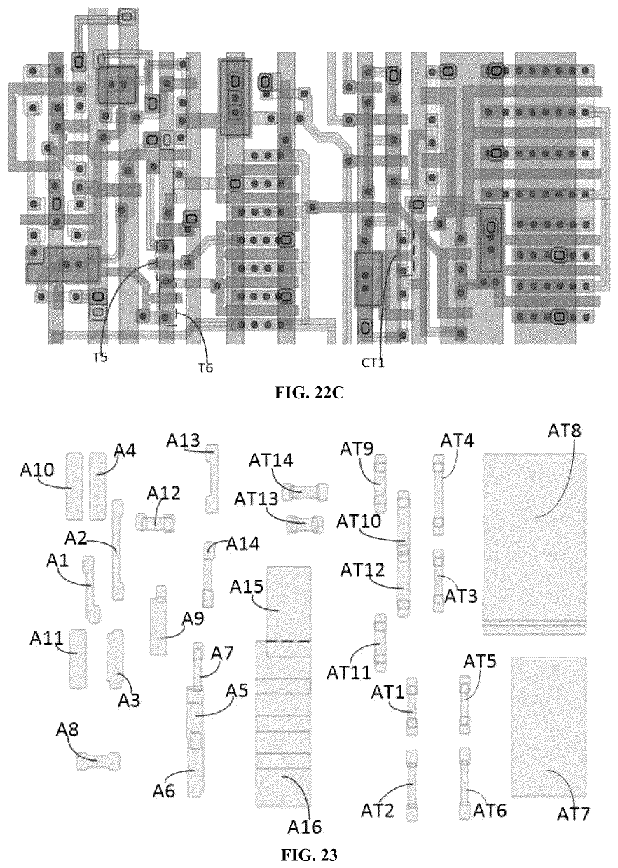

In at least one embodiment of the display substrate shown in FIG. 22A to FIG. 68, the first-voltage line is a high-voltage line, and the second-voltage line is a low-voltage line.

FIG. 22A, FIG. 22B and FIG. 22C are first layout diagrams of a display substrate including at least one embodiment of the driving circuit shown in FIG. 12.

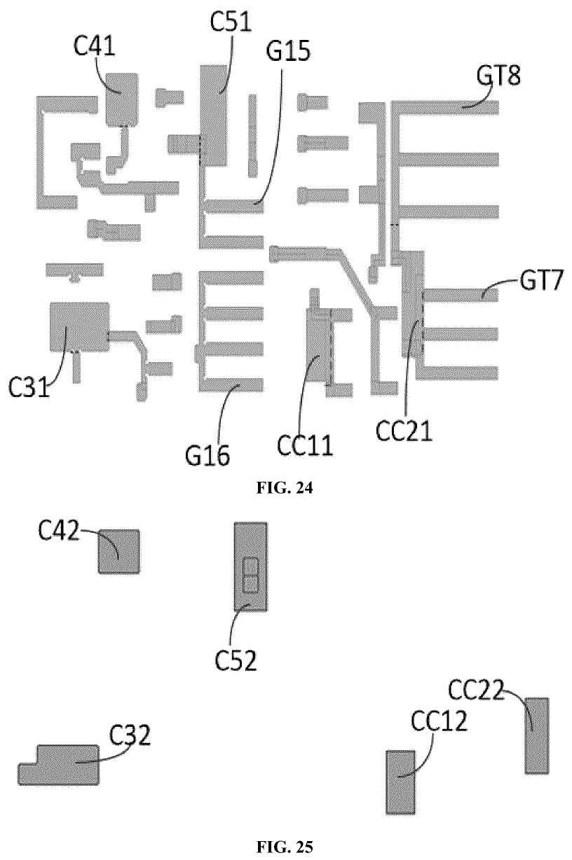

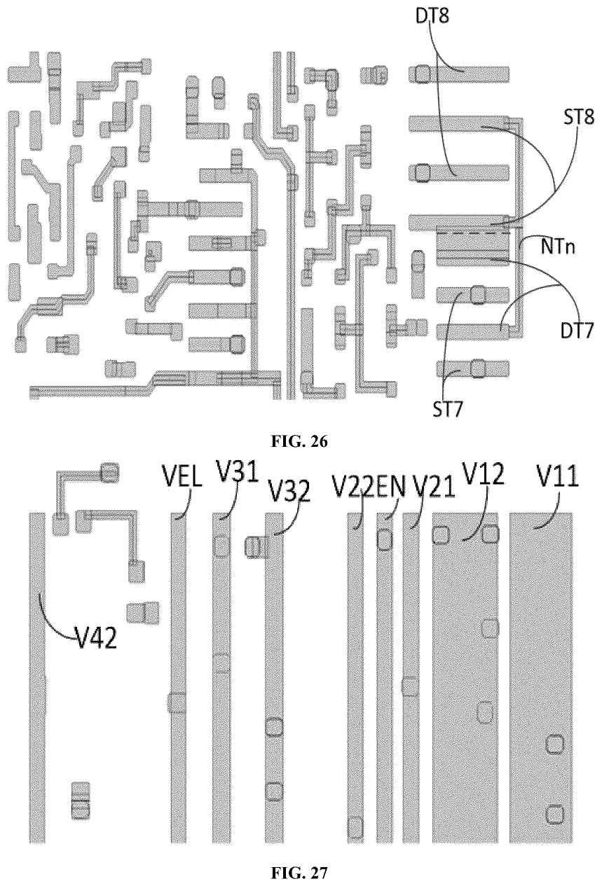

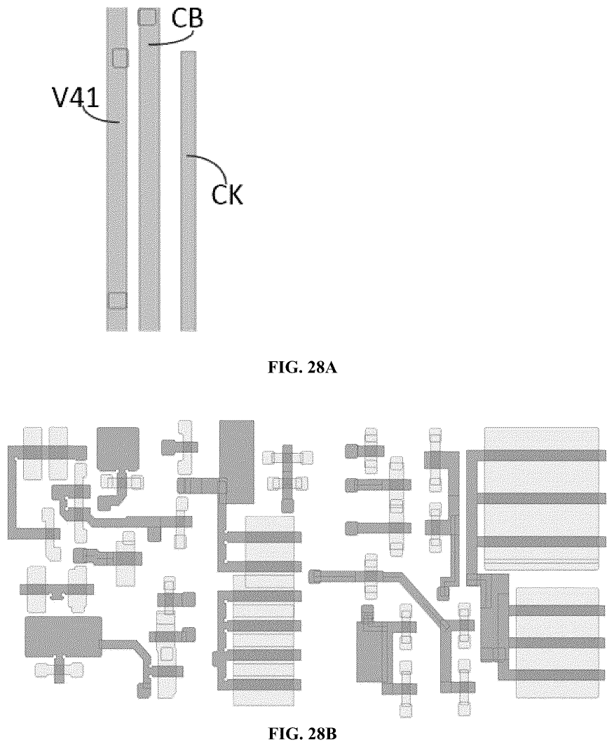

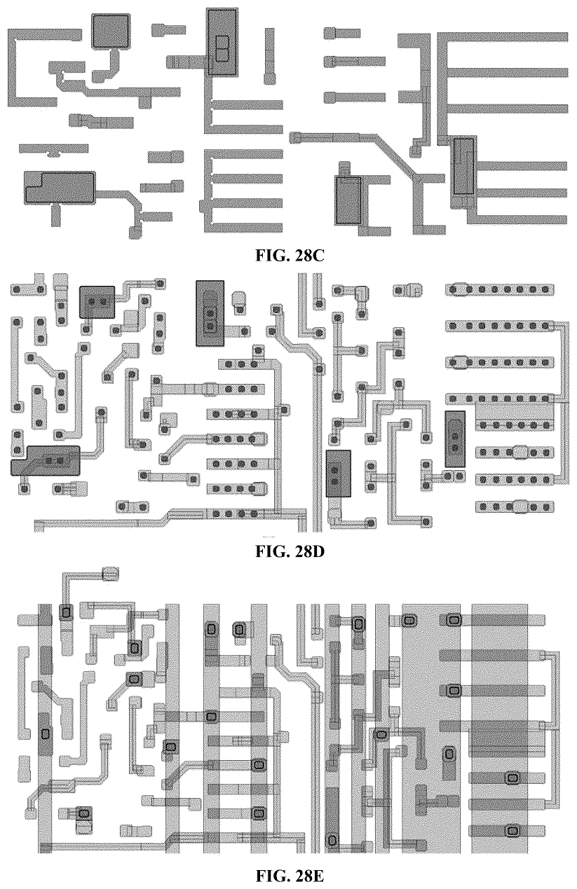

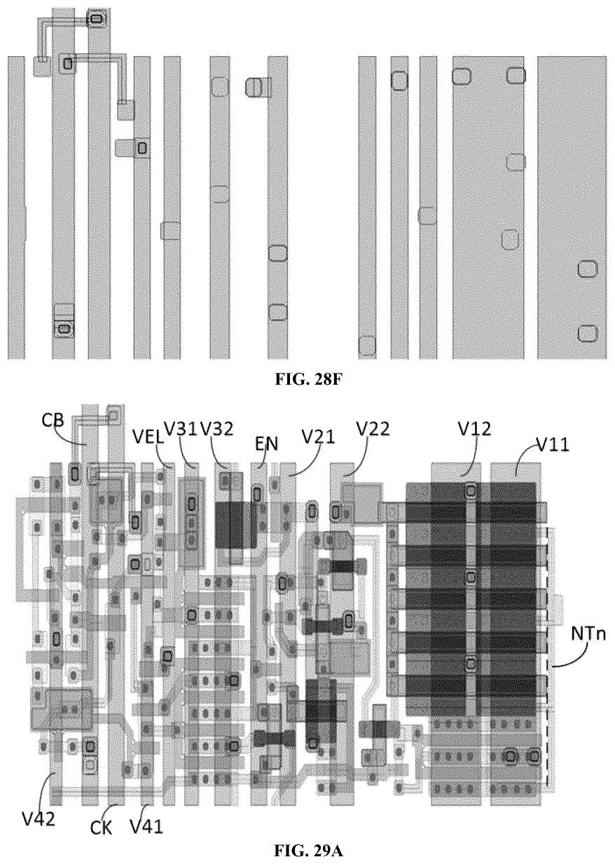

FIG. 23 is a layout diagram of a first semiconductor layer in FIG. 22A. FIG. 24 is a layout diagram of a first gate metal layer in FIG. 22A. FIG. 25 is a layout diagram of a second gate metal layer in FIG. 22A. FIG. 26 is a layout diagram of a first source-drain metal layer in FIG. 22A. FIG. 27 is a layout diagram of a second source-drain metal layer in FIG. 22A. FIG. 28A is a layout diagram of a third source-drain metal layer in FIG. 22A.

FIG. 28B is a superimposed diagram of the first semiconductor layer and the first gate metal layer in FIG. 22A. FIG. 28C is a superimposed diagram of the first gate metal layer and the second gate metal layer in FIG. 22A. FIG. 28D is a superimposed diagram of the second gate metal layer and the first source-drain metal layer in FIG. 22A. FIG. 28E is a superimposed diagram of the first source-drain metal layer and the second source-drain metal layer in FIG. 22A. FIG. 28F is a superimposed diagram of the second source-drain metal layer and the third source-drain metal layer in FIG. 22A.

In at least one embodiment of the display substrate shown in FIG. 22A, the first semiconductor layer, the first gate metal layer, the second gate metal layer, the first source-drain metal layer, the second source-drain metal layer and the third source-drain metal layer are arranged in sequence in a direction away from the base substrate.

At least one embodiment of the display substrate shown in FIG. 22A is a driving circuit manufactured by using a complementary metal oxide semiconductor (CMOS) process.

In at least one embodiment of the present disclosure, the first semiconductor layer may be made of polysilicon, and the second semiconductor layer may be made of indium gallium zinc oxide (IGZO), which is not limited thereto.

In at least one embodiment of the present disclosure, the control signal generating circuit and the control circuit are arranged on a side of the driving signal generating circuit close to the display area, so that the control circuit provides a corresponding driving signal to a pixel circuit arranged in the display area.

Optionally, the first-voltage line includes a first first-voltage line and a second first-voltage line, and the second-voltage line includes a first second-voltage line and a second second-voltage line.

An orthographic projection of at least part of active patterns of transistors included in the third control circuit onto the base substrate at least partially overlaps with an orthographic projection of the first first-voltage line onto the base substrate.

An orthographic projection of at least part of active patterns of transistors included in the third control circuit onto the base substrate at least partially overlaps with an orthographic projection of the first second-voltage line onto the base substrate.

An orthographic projection of the first second-voltage line onto the base substrate at least partially overlaps with an orthographic projection of active patterns of at least part of transistors included in the second control circuit onto the base substrate.

An orthographic projection of the first second-voltage line onto the base substrate at least partially overlaps with an orthographic projection of the electrode plate of the capacitor included in the second energy storage circuit onto the base substrate.

An orthographic projection of the second second-voltage line onto the base substrate at least partially overlaps with an orthographic projection of the electrode plate of the capacitor included in the first energy storage circuit onto the base substrate.

The orthographic projection of the second second-voltage line onto the base substrate at least partially overlaps with an orthographic projection of active patterns of at least part of transistors included in the control signal generating circuit onto the base substrate.

An orthographic projection of the enable signal line onto the base substrate at least partially overlaps with an orthographic projection of active patterns of at least part of transistors included in the control signal generating circuit onto the base substrate.

In at least one embodiment of the present disclosure, an orthographic projection of each signal line onto the base substrate at least partially overlaps with an orthographic projection of an active pattern of the corresponding transistor onto the base substrate, and the signal line and the electrode plate of the corresponding capacitor are arranged so that their orthographic projections onto the base substrate at least partially overlap, thereby reducing lateral space occupied by the driving circuit and facilitating realization of a narrow frame.

Optionally, the first-voltage line may be a high-voltage line, and the second-voltage line may be a low-voltage line.

As shown in FIG. 22A to FIG. 28A, the high-voltage line includes a first high-voltage line V11 and a second high-voltage line V21, and the second-voltage line includes a first low-voltage line V12 and a second low-voltage line V22.

In FIG. 22A to FIG. 28A, the n-th stage first scanning terminal is labeled NTn;
an orthographic projection of an active pattern AT7 of CT7 onto the base substrate at least partially overlaps with an orthographic projection of V11 onto the base substrate;
an orthographic projection of an active pattern AT8 of CT8 onto the base substrate at least partially overlaps with an orthographic projection of V11 onto the base substrate;
an orthographic projection of an active pattern AT7 of CT7 onto the base substrate at least partially overlaps with an orthographic projection of V12 onto the base substrate;
an orthographic projection of an active pattern AT8 of CT8 onto the base substrate at least partially overlaps with an orthographic projection of V12 onto the base substrate;
an orthographic projection of an active pattern AT7 of CT5 onto the base substrate at least partially overlaps with an orthographic projection of V12 onto the base substrate;
an orthographic projection of the active pattern AT7 of CT6 onto the base substrate at least partially overlaps with an orthographic projection of V12 onto the base substrate;
an orthographic projection of a first electrode plate CC21 of CC2 onto the base substrate at least partially overlaps with an orthographic projection of V12 onto the base substrate;
an orthographic projection of a second electrode plate CC22 of CC2 onto the base substrate at least partially overlaps with an orthographic projection of V12 onto the base substrate;
an orthographic projection of V22 onto the base substrate at least partially overlaps with an orthographic projection of a first electrode plate CC11 of CC1 onto the base substrate;
an orthographic projection of V22 onto the base substrate at least partially overlaps with an orthographic projection of a second electrode plate CC12 of CC1 onto the base substrate;
an orthographic projection of V22 onto the base substrate at least partially overlaps with an orthographic projection of an active pattern AT9 of CT9 onto the base substrate;
an orthographic projection of V22 onto the base substrate at least partially overlaps with an orthographic projection of an active pattern AT11 of CT11 onto the base substrate;
an orthographic projection of EN onto the base substrate at least partially overlaps with an orthographic projection of an active pattern AT10 of CT10 onto the base substrate;
the orthographic projection of EN onto the base substrate at least partially overlaps with an orthographic projection of an active pattern AT12 of CT12 onto the base substrate; at least part of an orthographic projection of an active pattern AT3 of CT3 onto the base substrate is between the orthographic projection of V12 onto the base substrate and the orthographic projection of V21 onto the base substrate;
at least part of an orthographic projection of an active pattern AT4 of CT4 onto the base substrate is between the orthographic projection of V12 onto the base substrate and the orthographic projection of V21 onto the base substrate.

In at least one embodiment of the present disclosure, the first first-voltage line, the second first-voltage line, the first second-voltage line, the second second-voltage line and the enable signal line all extend along a first direction.

A width of the first first-voltage line along a second direction is greater than a width of the second first-voltage line along the second direction.

A width of the first second-voltage line along the second direction is greater than a width of the second second-voltage line along the second direction.

The first direction crosses the second direction.

Optionally, the first direction may be a vertical direction, and the second direction may be a horizontal direction, which is not limited thereto.

In at least one embodiment of the present disclosure, the first-voltage line includes a first first-voltage line, a second first-voltage line, a third first-voltage line, and a fourth first-voltage line which may be electrically connected to each other.

The first second-voltage line, the second second-voltage line, the third second-voltage line, and the fourth second-voltage line included in the first-voltage line may be electrically connected to each other, which is not limited thereto.

In at least one embodiment of the present disclosure, the first-voltage line may include at least two voltage lines electrically connected to each other, and a width of at least one voltage line of the at least two voltage lines electrically connected to each other included in the first-voltage line may be set to be larger along the second direction, thereby reducing the resistance of the first-voltage line.

The second-voltage line may include at least two voltage lines electrically connected to each other, and a width of at least one voltage line of the at least two voltage lines electrically connected to each other included in the second-voltage line may be set to be larger along the second direction, thereby reducing the resistance of the second-voltage line.

As shown in FIG. 22A to FIG. 28A, V11, V21, V12, V22 and EN all extend in the vertical direction.

The width of V11 along the horizontal direction is greater than the width of V21 along the horizontal direction.

The width of V12 along the horizontal direction is greater than the width of V22 along the horizontal direction.

In at least one embodiment of the present disclosure, CT7 and CT8 are transistors electrically connected to the n-th stage driving output terminal, and an orthographic projection of an active pattern AT7 of CT7 onto the base substrate at least partially overlaps with an orthographic projection of V11 onto the base substrate; an orthographic projection of an active pattern AT8 of CT8 onto the base substrate at least partially overlaps with the orthographic projection of V11 onto the base substrate; the orthographic projection of the active pattern AT7 of CT7 onto the base substrate at least partially overlaps with the orthographic projection of V12 onto the base substrate; the orthographic projection of the active pattern AT8 of CT8 onto the base substrate at least partially overlaps with the orthographic projection of V12 onto the base substrate; the width of V11 along the horizontal direction is set to be larger, and the width of V12 along the horizontal direction is set to be larger, thereby reducing the resistance of V11 and the resistance of V12, and reducing IR Drop (which is a voltage drop caused by current and resistance) of the high-voltage line and the IR Drop of the low-voltage line.

Optionally, the first first-voltage line, the first second-voltage line, the second first-voltage line, the enable signal line and the second second-voltage line are arranged in sequence along a direction away from the display area.

As shown in FIG. 22A to FIG. 28A, V11, V12, V22, EN and V22 are arranged in sequence in a direction away from the display area.

As shown in FIG. 22A to FIG. 28A, V11, V12, V22, EN and V22 may all be formed in the second remote metal layer.

In at least one embodiment of the present disclosure, the transistor included in the third control circuit is arranged on a side of the transistor included in the first control circuit close to the display area.

The transistor included in the third control circuit is arranged on a side of the transistor included in the second control circuit close to the display area; the transistor included in the third control circuit is electrically connected to the n-th stage driving output terminal, and the transistor included in the third control circuit is arranged close to the display area, which facilitates the transistor included in the third control circuit to be electrically connected to the pixel circuit in the display area through the n-th stage driving output terminal.

The transistor included in the control signal generating circuit is arranged on a side of the control circuit away from the display area.

As shown in FIG. 22A to FIG. 28A, CT7 and CT8 are arranged on a side of CT1 close to the display area, CT7 and CT8 are arranged on a side of CT2 close to the display area, CT7 and CT8 are arranged on a side of CT3 close to the display area, and CT7 and CT8 are arranged on a side of CT4 close to the display area.

Optionally, the second-voltage line further includes a third second-voltage line.

An orthographic projection of the third second-voltage line onto the base substrate at least partially overlaps with an orthographic projection of an active pattern of at least one transistor included in the output inverter circuit onto the base substrate.

As shown in FIG. 22A to FIG. 28A, the low-voltage line further includes a third low-voltage line V32.

An orthographic projection of the third low-voltage line V32 onto the base substrate at least partially overlaps with an orthographic projection of an active pattern AT13 of CT13 onto the base substrate.

The orthographic projection of the third low-voltage line V32 onto the base substrate at least partially overlaps with an orthographic projection of an active pattern AT14 of CT14 onto the base substrate.

In at least one embodiment of the present disclosure, the first-voltage line includes a third first-voltage line and a fourth first-voltage line, and the second-voltage line includes a third second-voltage line and a fourth second-voltage line.

An orthographic projection of the third second-voltage line onto the base substrate at least partially overlaps with the orthographic projection of the active pattern of at least one transistor included in the output circuit onto the base substrate.

An orthographic projection of the third first-voltage line onto the base substrate at least partially overlap with the orthographic projections of the active pattern of at least one transistor included in the output circuit on the base substrate.

An orthographic projection of the third first-voltage line onto the base substrate at least partially overlaps with the orthographic projection of the electrode plate of the capacitor included in the potential maintaining circuit onto the base substrate.

An orthographic projection of the fourth first-voltage line onto the base substrate at least partially overlaps with an orthographic projection of active patterns of at least part of transistors included in the second output node control circuit onto the base substrate.

As shown in FIG. 22A to FIG. 28A, the high-voltage line includes a third high-voltage line V31 and a fourth high-voltage line V41, and the low-voltage line includes a third low-voltage line V32 and a fourth low-voltage line V42.

An orthographic projection of V32 onto the base substrate at least partially overlaps with an orthographic projection of an active pattern A15 of T15 onto the base substrate; the orthographic projection of V32 onto the base substrate at least partially overlaps with an orthographic projection of an active pattern A16 of T16 onto the base substrate.

An orthographic projection of V31 onto the base substrate at least partially overlaps with the orthographic projection of the active pattern A15 of T15 onto the base substrate; the orthographic projection of V31 onto the base substrate at least partially overlaps with the orthographic projection of the active pattern A16 of T16 onto the base substrate.

The orthographic projection of V31 onto the base substrate at least partially overlaps with an orthographic projection of the first electrode plate C51 of C5 onto the base substrate; the orthographic projection of V31 onto the base substrate at least partially overlaps with an orthographic projection of the second electrode plate C52 of C5 onto the base substrate.

An orthographic projection of V41 onto the base substrate at least partially overlaps with the orthographic projection of the active pattern A5 of T5 onto the base substrate.

The orthographic projection of V41 onto the base substrate at least partially overlaps with the orthographic projection of the active pattern A6 of T6 onto the base substrate.

The orthographic projection of V41 onto the base substrate at least partially overlaps with the orthographic projection of the active pattern A7 of T7 onto the base substrate.

In at least one embodiment shown in FIG. 22A to FIG. 28A, each signal line and the active pattern of the corresponding transistor are arranged so that their orthographic projections onto the base substrate at least partially overlap, and the signal line and the electrode plate of the corresponding capacitor are arranged so that their orthographic projections onto the base substrate at least partially overlap, thereby facilitating realization of a narrow frame.

Optionally, the orthographic projection of the fourth second-voltage line onto the base substrate at least partially overlaps with an orthographic projection of the electrode plate of the capacitor included in the second node control circuit onto the base substrate.

The orthographic projection of the fourth second-voltage line onto the base substrate at least partially overlaps with the orthographic projection of the active patterns of at least part of transistors included in the first node control circuit onto the base substrate.

The orthographic projection of the fourth second-voltage line onto the base substrate at least partially overlaps with the orthographic projection of the active patterns of at least part of transistors included in the second node control circuit onto the base substrate.

The orthographic projection of the fourth second-voltage line onto the base substrate at least partially overlaps with an orthographic projection of active patterns of at least part of transistors included in the second output node control circuit onto the base substrate.

As shown in FIG. 22A to FIG. 28A, the orthographic projection of V42 onto the base substrate at least partially overlaps with the orthographic projection of the first electrode plate C31 of C3 onto the base substrate; the orthographic projection of V42 onto the base substrate at least partially overlaps with the orthographic projection of the second electrode plate C32 of C3 onto the base substrate.

The orthographic projection of V42 onto the base substrate at least partially overlaps with the orthographic projection of the active pattern A4 of T4 onto the base substrate.

The orthographic projection of V42 onto the base substrate at least partially overlaps with the orthographic projection of the active pattern A1 of T1 onto the base substrate.

The orthographic projection of V42 onto the base substrate at least partially overlaps with the orthographic projection of the active pattern A8 of T8 onto the base substrate.

In at least one embodiment shown in FIG. 22A to FIG. 28A, each signal line and the active pattern of the corresponding transistor are arranged so that their orthographic projections onto the base substrate at least partially overlap, thereby facilitating realization of a narrow frame.

As shown in FIG. 22A to FIG. 28A, an orthographic projection of an active pattern A10 of T10 onto the base substrate is arranged on a side of an orthographic projection of V42 onto the base substrate away from the display area.

An orthographic projection of the active pattern A11 of T11 onto the base substrate is arranged on a side of the orthographic projection of V42 onto the base substrate away from the display area.

An orthographic projection of the active pattern A2 of T2 onto the base substrate is arranged between the orthographic projection of V42 onto the base substrate and the orthographic projection of CB onto the base substrate.

An orthographic projection of the active pattern A3 of T3 onto the base substrate is arranged between the orthographic projection of V42 onto the base substrate and the orthographic projection of CB onto the base substrate.

In at least one embodiment of the present disclosure, the orthographic projection of the first clock signal line onto the base substrate at least partially overlaps with the orthographic projection of the electrode plate of the capacitor included in the first output node control circuit onto the base substrate.

The orthographic projection of the second clock signal line onto the base substrate at least partially overlaps with the orthographic projection of the electrode plate of the capacitor included in the first output node control circuit onto the base substrate.

The orthographic projection of the second clock signal line onto the base substrate at least partially overlaps with the orthographic projection of the electrode plate of the capacitor included in the second node control circuit onto the base substrate.

As shown in FIG. 22A to FIG. 28A, the orthographic projection of CK onto the base substrate at least partially overlaps with the orthographic projection of the first electrode plate C41 of C4 onto the base substrate; the orthographic projection of CK onto the base substrate at least partially overlaps with the orthographic projection of the second electrode plate C42 of C4 onto the base substrate.

The orthographic projection of CB onto the base substrate at least partially overlaps with the orthographic projection of the first electrode plate C41 of C4 onto the base substrate; the orthographic projection of CB onto the base substrate at least partially overlaps with the orthographic projection of the second electrode plate C42 of C4 onto the base substrate.

The orthographic projection of CB onto the base substrate at least partially overlaps with the orthographic projection of the first electrode plate C31 of C3 onto the base substrate; the orthographic projection of CB onto the base substrate at least partially overlaps with the orthographic projection of the second electrode plate C32 of C3 onto the base substrate.

In at least one embodiment shown in FIG. 22A to FIG. 28A, each signal line and the electrode plate of the corresponding capacitor are arranged so that their orthographic projections onto the base substrate at least partially overlap, thereby facilitating realization of a narrow frame.

Optionally, the third second-voltage line, the third first-voltage line, the control voltage line, the fourth first-voltage line, the first clock signal line, the second clock signal line and the fourth second-voltage line are arranged in sequence along a direction away from the display area.

As shown in FIG. 22A to FIG. 28A, V32, V31, VEL, V41, CK, CB and V42 are arranged in sequence in a direction away from the display area.

V32, V31, VEL, V41, CK, CB and V42 all extend in the vertical direction.

Optionally, the output inverting circuit and the output circuit are arranged along a first direction.

The potential maintaining circuit and the output circuit are arranged along a first direction.

The output inverting circuit and the potential maintaining circuit are arranged along a second direction.

Transistors included in the output circuit are arranged in sequence along a first direction.

As shown in FIG. 22A to FIG. 28A, CT14, CT13, T15 and T16 are arranged in sequence along the vertical direction; C5, T15 and T16 are arranged in sequence along the vertical direction; CT13 and C5 are arranged in the horizontal direction, and CT14 and C5 are arranged in the horizontal direction; T15 and T16 are arranged in the vertical direction; the space in the vertical direction is used to set the transistors, thereby reducing the lateral space occupied by the driving circuit, which is conducive to achieving a narrow frame.

In FIG. 22A to 53A, an active pattern of CT1 is labeled AT1, an active pattern of CT2 is labeled AT2, an active pattern of CT3 is labeled AT3, an active pattern of CT4 is labeled AT4, an active pattern of CT5 is labeled AT5, an active pattern of CT6 is labeled AT6, an active pattern of CT7 is labeled AT7, an active pattern of CT8 is labeled AT8, an active pattern of CT9 is labeled AT9, an active pattern of CT10 is labeled AT10, an active pattern of CT11 is labeled AT11, an active pattern of CT12 is labeled AT12, an active pattern of CT13 is labeled AT13, and an active pattern of CT14 is labeled AT14.

The first electrode plate of CC1 is labeled CC11, and the second electrode plate of CC1 is labeled CC12; the first electrode plate of CC2 is labeled CC21, and the second electrode plate of CC2 is labeled CC22.

A1 represents an active pattern of T1, A2 represents an active pattern of T2, A3 represents an active pattern of T3, A4 represents an active pattern of T4, A5 represents an active pattern of T5, A6 represents an active pattern of T6, A7 represents an active pattern of T7, A8 represents an active pattern of T8, A9 represents an active pattern of T9, A10 represents an active pattern of T10, A11 represents an active pattern of T11, A12 represents an active pattern of T12, A13 represents an active pattern of T13, A14 represents an active pattern of T14, A15 represents an active pattern of T15, and A16 represents an active pattern of T16.

The first electrode plate of C3 is labeled C31, and the second electrode plate of C3 is labeled C32.

The first electrode plate of C4 is labeled C41, and the second electrode plate of C4 is labeled C42.

The first electrode plate of C5 is labeled C51, and the second electrode plate of C5 is labeled C52.

In FIG. 24, the gate electrode of CT7 is labeled GT7, and the gate electrode of CT8 is labeled GT8.

The gate electrode of T15 is labeled G15, and the gate electrode of T16 is labeled G16.

In FIG. 26, NTn represents the n-th stage first scanning terminal, ST8 represents the source electrode of CT8, DT8 represents the drain electrode of CT8, DT7 represents the drain electrode of CT7, and ST7 represents the source electrode of CT7.

ST8, DT7 and NTn are electrically connected to each other.

As shown in FIG. 27, V11, V12, V21, EN, V22, V32, V31, VEL and V42 are all disposed in the second source-drain metal layer.

As shown in FIG. 28A, V41, CK and CB are all disposed in the third source-drain metal layer.

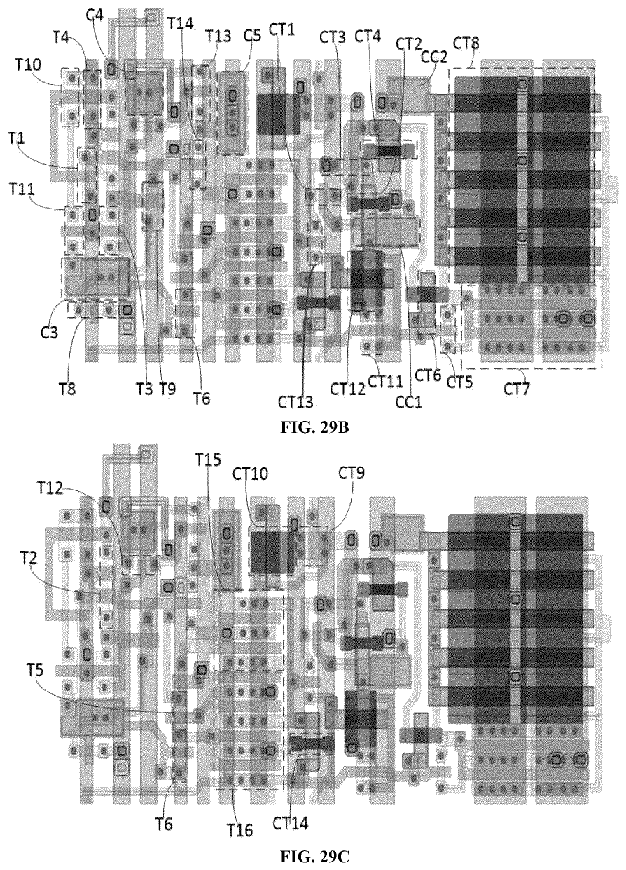

FIG. 29A, FIG. 29B and FIG. 29C are second layout diagrams of a display substrate including at least one embodiment of the driving circuit shown in FIG. 12.

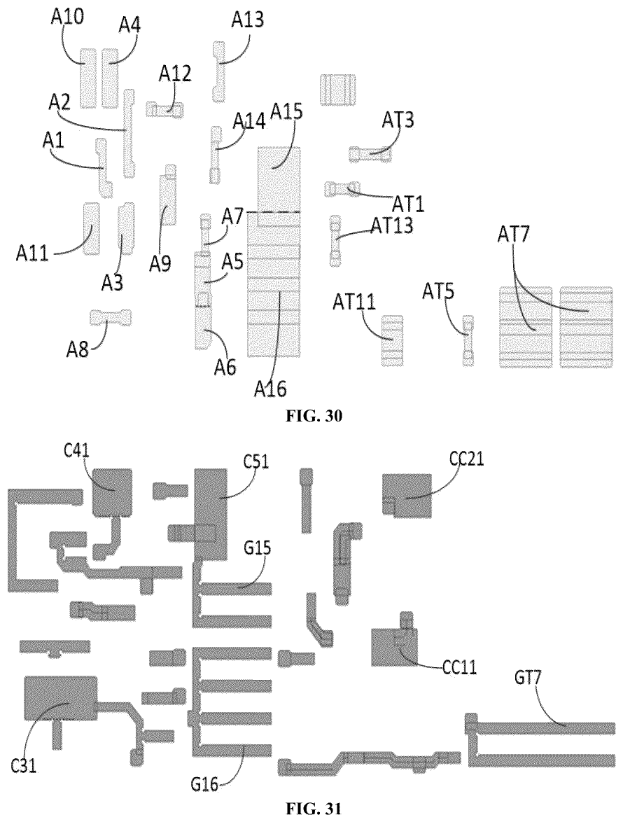

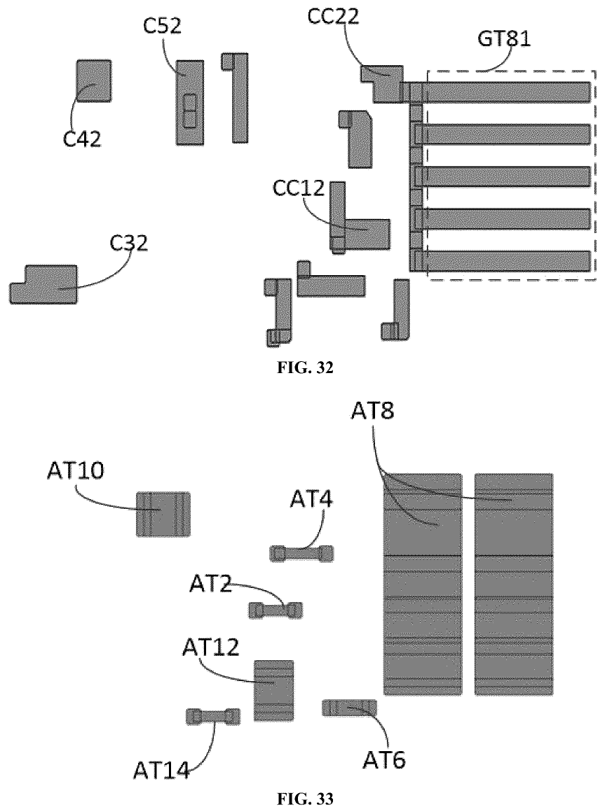

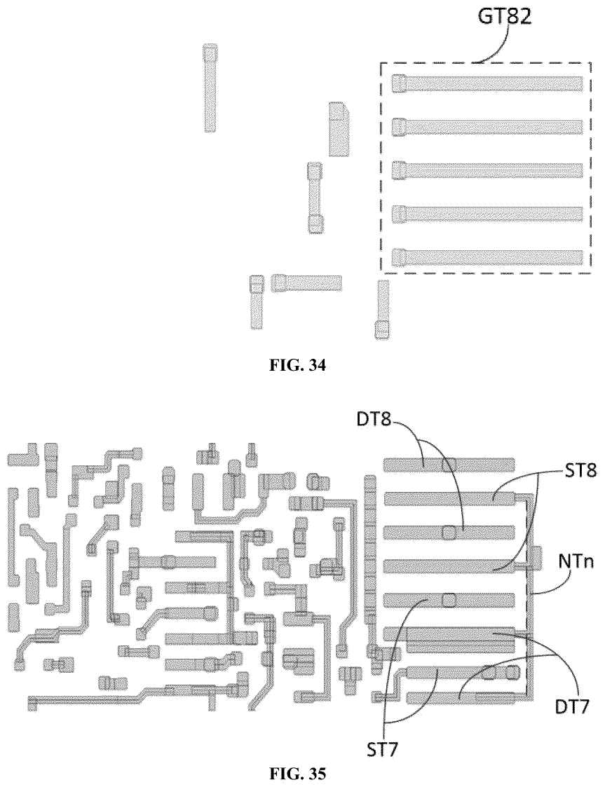

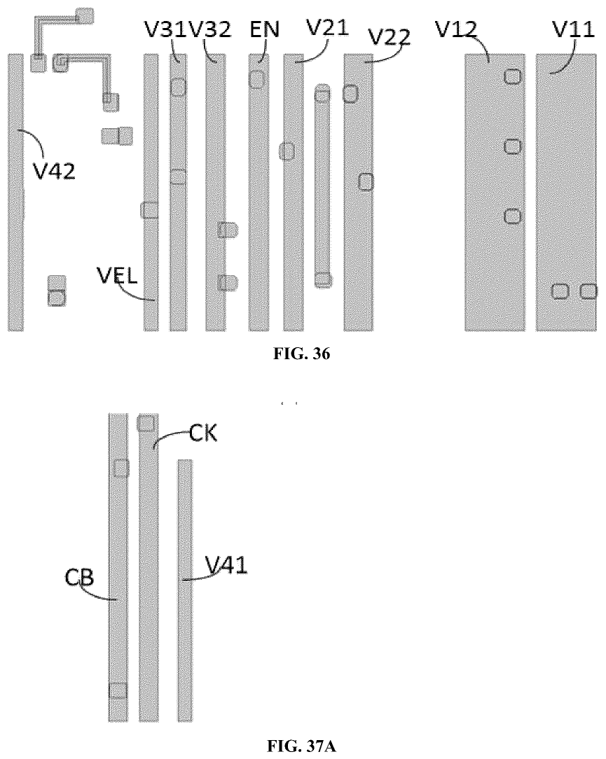

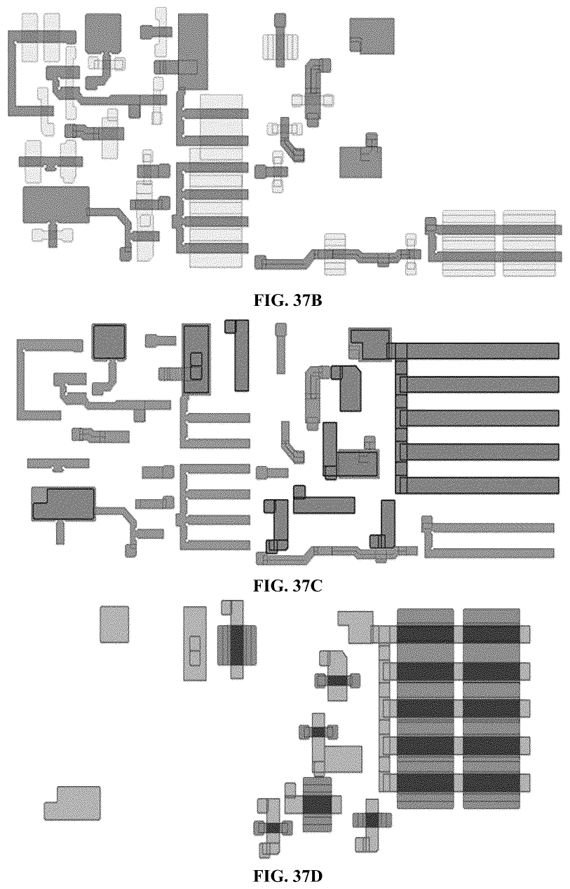

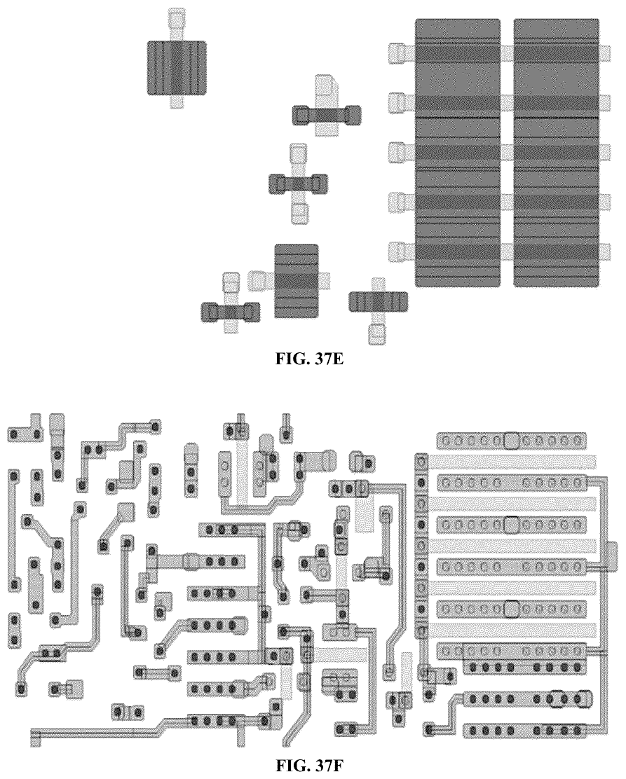

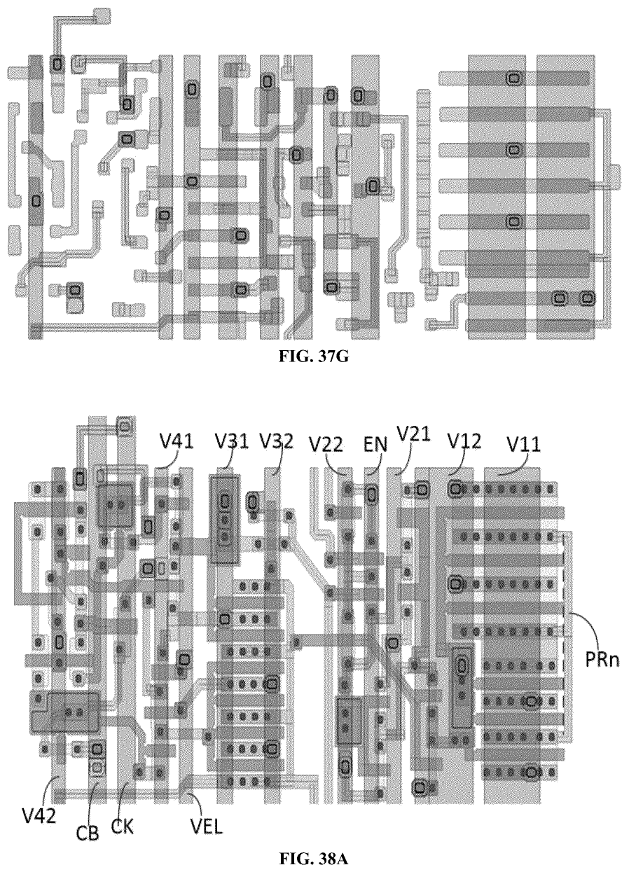

FIG. 30 is a layout diagram of a first semiconductor layer in FIG. 29A, FIG. 31 is a layout diagram of a first gate metal layer in FIG. 29A, FIG. 32 is a layout diagram of a second gate metal layer in FIG. 29A, FIG. 33 is a layout diagram of a second semiconductor layer in FIG. 29A, FIG. 34 is a layout diagram of a third gate metal layer in FIG. 29A, FIG. 35 is a layout diagram of a first source-drain metal layer in FIG. 29A, FIG. 36 is a layout diagram of a second source-drain metal layer in FIG. 29A, and FIG. 37A is a layout diagram of a third source-drain metal layer in FIG. 29A.

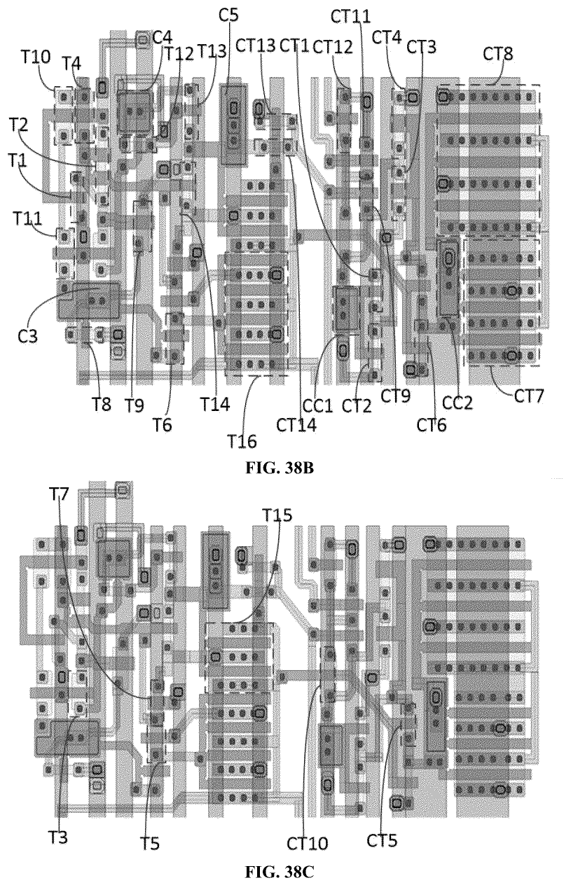

FIG. 37B is a superimposed diagram of the first semiconductor layer and the first gate metal layer in FIG. 29A, FIG. 37C is a superimposed diagram of the first gate metal layer and the second gate metal layer in FIG. 29A, FIG. 37D is a superimposed diagram of the second gate metal layer and the second semiconductor layer in FIG. 29A, FIG. 37E is a superimposed diagram of the third gate metal layer and the second semiconductor layer in FIG. 29A, FIG. 37F is a layout diagram of the third gate metal layer and the first source-drain metal layer in FIG. 29A, and FIG. 38G is a layout diagram of the first source-drain metal layer and the second source-drain metal layer in FIG. 29A.

In at least one embodiment of the display substrate shown in FIG. 29A, the first semiconductor layer, the first gate metal layer, the second gate metal layer, the second semiconductor layer, the third gate metal layer, the first source-drain metal layer, the second source-drain metal layer and the third source-drain metal layer are arranged in sequence along the direction away from the base substrate.

At least one embodiment of the display substrate shown in FIG. 29A is a driving circuit manufactured by using a low temperature polycrystalline oxide (LTPO) process.

In at least one embodiment of the present disclosure, the first-voltage line includes a first first-voltage line and a second first-voltage line.

An orthographic projection of the first first-voltage line onto the base substrate at least partially overlaps with an orthographic projection of active patterns of at least part of transistors included in the third control circuit onto the base substrate.

An orthographic projection of the second first-voltage line onto the base substrate at least partially overlaps with an orthographic projection of active patterns of some transistors included in the first control circuit onto the base substrate.

The orthographic projection of the second first-voltage line onto the base substrate at least partially overlaps with the orthographic projection of active patterns of some transistors included in the control signal generating circuit onto the base substrate;

At least part of the orthographic projection of the active patterns of at least part of transistors included in the output inverting circuit onto the base substrate is arranged between the orthographic projection of the second first-voltage line onto the base substrate and the orthographic projection of the enable signal line onto the base substrate.

As shown in FIG. 29A to FIG. 37A, the high-voltage line includes a first high-voltage line V11 and a second high-voltage line V21.

An orthographic projection of V11 onto the base substrate at least partially overlaps with an orthographic projection of AT8 onto the base substrate.

The orthographic projection of V11 onto the base substrate at least partially overlaps with an orthographic projection of AT7 onto the base substrate.

An orthographic projection of V21 onto the base substrate at least partially overlaps with the orthographic projection of AT1 onto the base substrate.

The orthographic projection of V21 onto the base substrate at least partially overlaps with the orthographic projection of AT9 onto the base substrate; at least part of the orthographic projection of AT13 onto the base substrate is arranged between the orthographic projections of the second high-voltage line V21 and the enable signal line EN onto the base substrate, thereby facilitating the arrangement of CT13 and CT14 in the space between V21 and EN, and then facilitating the realization of a narrow frame.

In at least one embodiment of the present disclosure, the active pattern of at least part of the transistors included in the third control circuit includes at least two active pattern portions that are independent of each other.

As shown in FIG. 29A to FIG. 37A, the active pattern AT8 of CT8 includes two independent active pattern portions, and the active pattern AT7 of CT7 includes two independent active pattern portions. The two independent active pattern portions are spaced a certain distance apart to facilitate heat dissipation, thereby improving the performance of the transistor while ensuring the area of the active pattern.

As shown in FIG. 29A to FIG. 37A, V11, V21, V12, V22 and EN all extend in the vertical direction.

A width of V11 along the horizontal direction is greater than a width of V21 along the horizontal direction.

A width of V12 along the horizontal direction is greater than a width of V22 along the horizontal direction.

In at least one embodiment of the present disclosure, the second-voltage line includes a first second-voltage line, a second second-voltage line, and a third second-voltage line.

An orthographic projection of the first second-voltage line onto the base substrate at least partially overlaps with an orthographic projection of active patterns of at least part of the transistors included in the third control circuit onto the base substrate.

An orthographic projection of the second second-voltage line onto the base substrate at least partially overlaps with an orthographic projection of active patterns of at least part of the transistors included in the first control circuit onto the base substrate.

The orthographic projection of the second second-voltage line onto the base substrate at least partially overlaps with the orthographic projection of the active pattern of at least part of the transistors included in the control signal generating circuit onto the base substrate.

The orthographic projection of the second second-voltage line onto the base substrate at least partially overlaps with the orthographic projection of the electrode plate of the capacitor included in the first energy storage circuit onto the base substrate.

The orthographic projection of the second second-voltage line onto the base substrate at least partially overlaps with the orthographic projection of the electrode plate of the capacitor included in the second energy storage circuit onto the base substrate.

The orthographic projection of the third second-voltage line onto the base substrate at least partially overlaps with the orthographic projection of active patterns of some transistors included in the control signal generating circuit onto the base substrate.

The orthographic projection of the third second-voltage line onto the base substrate at least partially overlaps with an orthographic projection of active patterns of at least part of transistors included in the output circuit onto the base substrate.

As shown in FIG. 29A to FIG. 37A, the low-voltage lines include a first low-voltage line V12, a second low-voltage line V22, and a third low-voltage line V32.

An orthographic projection of V12 onto the base substrate at least partially overlaps with the orthographic projection of AT7 onto the base substrate; the orthographic projection of V22 onto the base substrate at least partially overlaps with the orthographic projection of AT4 onto the base substrate.

The orthographic projection of V22 onto the base substrate at least partially overlaps with the orthographic projection of AT12 onto the base substrate; the orthographic projection of V22 onto the base substrate at least partially overlaps with the orthographic projection of AT11 onto the base substrate; the orthographic projection of V22 onto the base substrate at least partially overlaps with the orthographic projection of CC11 onto the base substrate; the orthographic projection of V22 onto the base substrate at least partially overlaps with the orthographic projection of CC12 onto the base substrate; the orthographic projection of V22 onto the base substrate at least partially overlaps with the orthographic projection of CC21 onto the base substrate; the orthographic projection of V22 onto the base substrate at least partially overlaps with the orthographic projection of CC22 onto the base substrate.

The orthographic projection of V32 onto the base substrate at least partially overlaps with the orthographic projection of A15 onto the base substrate; the orthographic projection of V32 onto the base substrate at least partially overlaps with the orthographic projection of A16 onto the base substrate; the orthographic projection of V32 onto the base substrate at least partially overlaps with the orthographic projection of AT10 onto the base substrate.

In at least one embodiment of the present disclosure, the orthographic projection of each signal line onto the base substrate at least partially overlaps with the orthographic projection of the active pattern of the corresponding transistor onto the base substrate, and the signal line and the electrode plate of the corresponding capacitor are arranged so that their orthographic projections onto the base substrate at least partially overlap, thereby reducing the lateral space occupied by the driving circuit and facilitating realization of a narrow frame.

Optionally, the first-voltage line includes a first first-voltage line, a second first-voltage line, a third first-voltage line and a fourth first-voltage line, and the second-voltage line includes a first second-voltage line, a second second-voltage line, a third second-voltage line and a fourth second-voltage line.

The first first-voltage line, the first second-voltage line, the second second-voltage line, the second first-voltage line, the enable signal line, the third second-voltage line, the third first-voltage line, the control voltage line, the fourth first-voltage line, the first clock signal line, the second clock signal line and the fourth second-voltage line are arranged in sequence along a direction away from the display area.

As shown in FIG. 29A to FIG. 37A, the high-voltage lines include a first high-voltage line V11, a second high-voltage line V21, a third high-voltage line V31, and a fourth high-voltage line V41; and the low-voltage lines include a first low-voltage line V12, a second low-voltage line V22, a third low-voltage line V32, and a fourth low-voltage line V42.

V11, V12, V22, V21, EN, V32, V31, VEL, V41, CK, CB and V42 are arranged in sequence in a direction away from the display area.

As shown in FIG. 29A to FIG. 37A, the first high-voltage line V11, the first low-voltage line V12, the second low-voltage line V22, the second high-voltage line V21, the enable signal line EN, the third low-voltage line V32, the third high-voltage line V31, the control voltage line VEL, the fourth high-voltage line V41, the first clock signal line CK, the second clock signal line CB and the fourth low-voltage line V42 all extend in the vertical direction.

In FIG. 29A to FIG. 37A, the n-th stage first scanning terminal is labeled NTn, and the n-th stage first scanning terminal NTn is electrically connected to the source electrode ST8 of CT8 and the drain electrode DT7 of CT7 respectively.

CT5 and CT6 are set between V12 and V22.

CT3 is set between V22 and V21.

An orthographic projection of at least part of the active pattern of CT13 onto the base substrate is arranged between the orthographic projection of V21 onto the base substrate and the orthographic projection of EN onto the base substrate.

The orthographic projection of V21 onto the base substrate at least partially overlaps with the orthographic projection of AT1 onto the base substrate; the orthographic projection of V21 onto the base substrate at least partially overlaps with the orthographic projection of AT9 onto the base substrate; the orthographic projection of EN onto the base substrate at least partially overlaps with the orthographic projection of AT9 onto the base substrate.

The orthographic projection of V32 onto the base substrate at least partially overlaps with the orthographic projection of A15 onto the base substrate; the orthographic projection of V32 onto the base substrate at least partially overlaps with the orthographic projection of A16 onto the base substrate.

The orthographic projection of V31 onto the base substrate at least partially overlaps with the orthographic projection of A15 onto the base substrate; the orthographic projection of V31 onto the base substrate at least partially overlaps with the orthographic projection of A16 onto the base substrate.

In FIG. 31, the gate electrode of CT7 is labeled GT7.

In FIG. 31, the gate electrode of T15 is labeled G15, and the gate electrode of T16 is labeled G16.

In FIG. 32, the first gate electrode of CT8 is labeled GT81; and in FIG. 34, the second gate electrode of CT8 is labeled GT82; the gate electrode of CT8 includes a first gate electrode GT81 of CT8 and a second gate electrode GT82 of CT8 which are electrically connected to each other. CT8 is a dual-gate transistor to reduce leakage.

In at least one embodiment of the present disclosure, when the driving circuit is manufactured by using the LTPO process, the n-type transistor included in the driving circuit may be a dual-gate transistor to reduce leakage, which is not limited thereto.

In FIG. 35, NTn represents the n-th stage first scanning terminal, ST8 represents the source electrode of CT8, DT8 represents the drain electrode of CT8, DT7 represents the drain electrode of CT7, and ST7 represents the source electrode of CT7.

ST8, DT7 and NTn are electrically connected to each other.

As shown in FIG. 36, V11, V12, V22, V21, EN, V32, V31, VEL and V42 are all disposed in the second source-drain metal layer.

As shown in FIG. 37A, V41, CK and CB are all disposed in the first source-drain metal layer.

FIG. 38A, FIG. 38B and FIG. 38C are first layout diagrams of a display substrate including at least one embodiment of the driving circuit shown in FIG. 15.

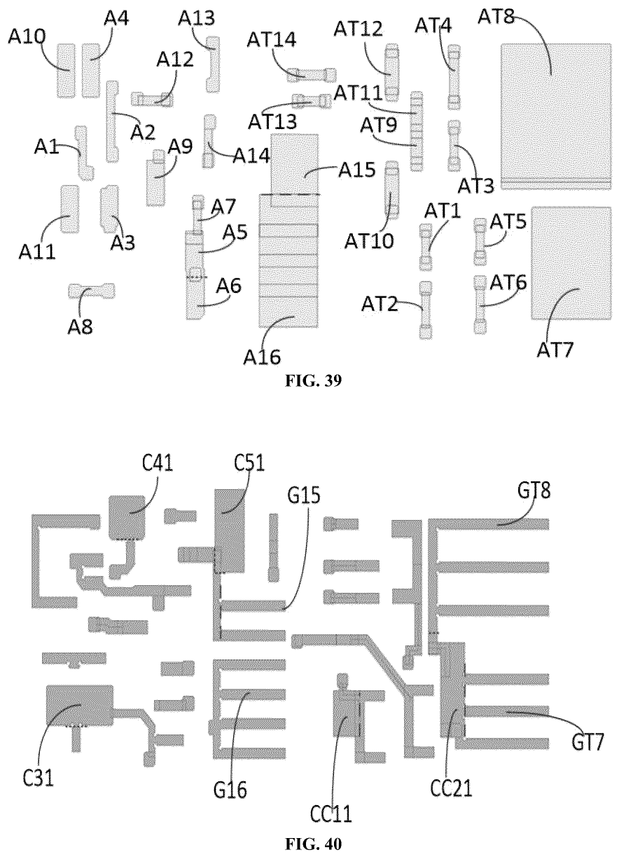

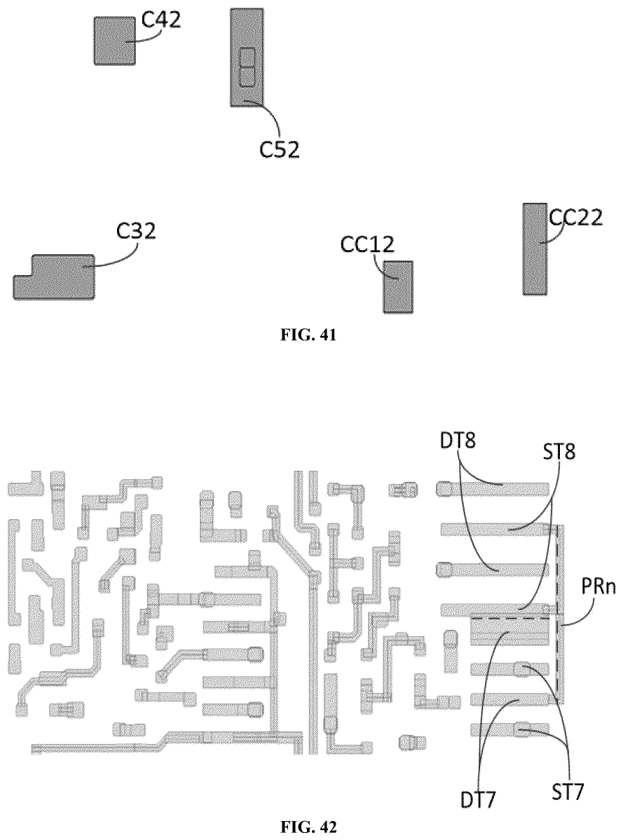

FIG. 39 is a layout diagram of a first semiconductor layer in FIG. 38A, FIG. 40 is a layout diagram of a first gate metal layer in FIG. 38A, FIG. 41 is a layout diagram of a second gate metal layer in FIG. 38A, FIG. 42 is a layout diagram of a first source-drain metal layer in FIG. 38A, FIG. 3 is a layout diagram of a second source-drain metal layer in FIG. 38A, and FIG. 44A is a layout diagram of a third source-drain metal layer in FIG. 38A.

FIG. 44B is a superimposed diagram of the first semiconductor layer and the first gate metal layer in FIG. 38A, FIG. 44C is a superimposed diagram of the first gate metal layer and the second gate metal layer in FIG. 38A, FIG. 4D is a superimposed diagram of the second gate metal layer and the first source-drain metal layer in FIG. 38A, and FIG. 44E is a superimposed diagram of the first source-drain metal layer and the second source-drain metal layer in FIG. 38A.

In at least one embodiment of the display substrate shown in FIG. 38A, the first semiconductor layer, the first gate metal layer, the second gate metal layer, the first source-drain metal layer, the second source-drain metal layer and the third source-drain metal layer are arranged in sequence in a direction away from the base substrate.

At least one embodiment of the display substrate shown in FIG. 38A is a display substrate manufactured by using a CMOS process.

As shown in FIG. 38A to FIG. 44A, the high-voltage lines include a first high-voltage line V11 and a second high-voltage line V21, and the low-voltage lines include a first low-voltage line V12 and a second low-voltage line V22; an orthographic projection of V11 onto the base substrate at least partially overlaps with an orthographic projection of AT8 onto the base substrate; an orthographic projection of V11 onto the base substrate at least partially overlaps with an orthographic projection of the active pattern AT7 of CT7 onto the base substrate.

The orthographic projection of V12 onto the base substrate at least partially overlaps with the orthographic projection of CC21 onto the base substrate; the orthographic projection of V12 onto the base substrate at least partially overlaps with the orthographic projection of CC22 onto the base substrate.

The orthographic projection of V12 onto the base substrate at least partially overlaps with the orthographic projection of AT5 onto the base substrate; the orthographic projection of V12 onto the base substrate at least partially overlaps with the orthographic projection of AT6 onto the base substrate.

The orthographic projection of EN onto the base substrate at least partially overlaps with the orthographic projection of AT11 onto the base substrate; the orthographic projection of EN onto the base substrate at least partially overlaps with the orthographic projection of AT9 onto the base substrate.

At least a portion of the orthographic projection of AT1 onto the base substrate and at least a portion of the orthographic projection of AT1 onto the base substrate are disposed between the orthographic projection of V21 onto the base substrate and the orthographic projection of EN onto the base substrate.

The orthographic projection of V22 onto the base substrate at least partially overlaps with the orthographic projection of AT12 onto the base substrate; the orthographic projection of V22 onto the base substrate at least partially overlaps with the orthographic projection of the active pattern AT10 onto the base substrate;

The orthographic projection of V22 onto the base substrate at least partially overlaps with the orthographic projection of CC11 onto the base substrate; the orthographic projection of V22 onto the base substrate at least partially overlaps with the orthographic projection of CC12 onto the base substrate.

In FIG. 38A to FIG. 44A, PRn denotes the n-th stage first reset terminal.

As shown in FIG. 38A to FIG. 44A, V11, V12, V21, EN and V22 all extend in the vertical direction, and V11, V12 V21, EN and V22 are arranged in sequence in a direction away from the display area.

As shown in FIG. 38A to FIG. 44A, the low-voltage lines further include a third low-voltage line V32 and a fourth low-voltage line V42, and the high-voltage lines further include a third high-voltage line V31 and a fourth high-voltage line V41.

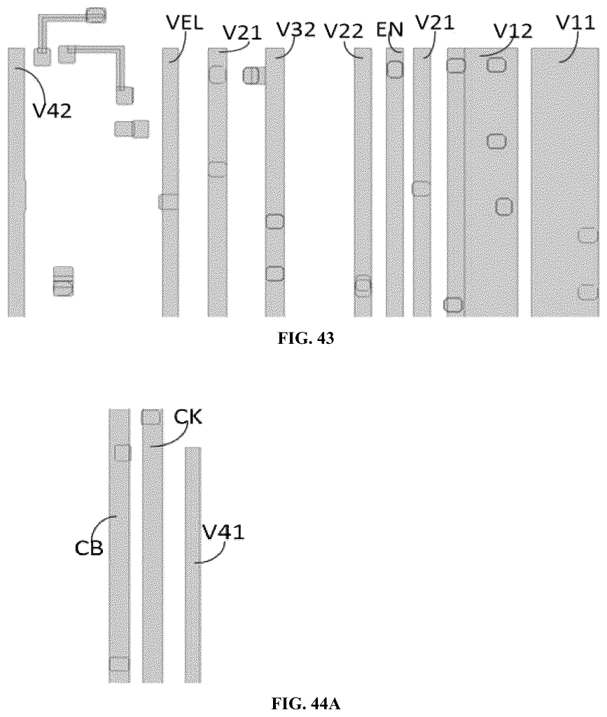

In FIG. 42, PRn represents the n-th stage first reset terminal of, ST8 represents the source electrode of CT8, DT8 represents the drain electrode of CT8, ST7 represents the source electrode of CT7, and DT7 represents the drain electrode of CT7; as shown in FIG. 43, V11, V12, V21, EN, V22, V32, V31, VEL and V42 are all arranged in the second source-drain metal layer.

As shown in FIG. 44A, V41, CK and CB are set in the third source-drain metal layer.

As shown in FIG. 38A to FIG. 44A, V11, V21, V12, V22 and EN all extend in the vertical direction.

A width of V11 along the horizontal direction is greater than the width of V21 along the horizontal direction.

A width of V12 along the horizontal direction is greater than the width of V22 along the horizontal direction.

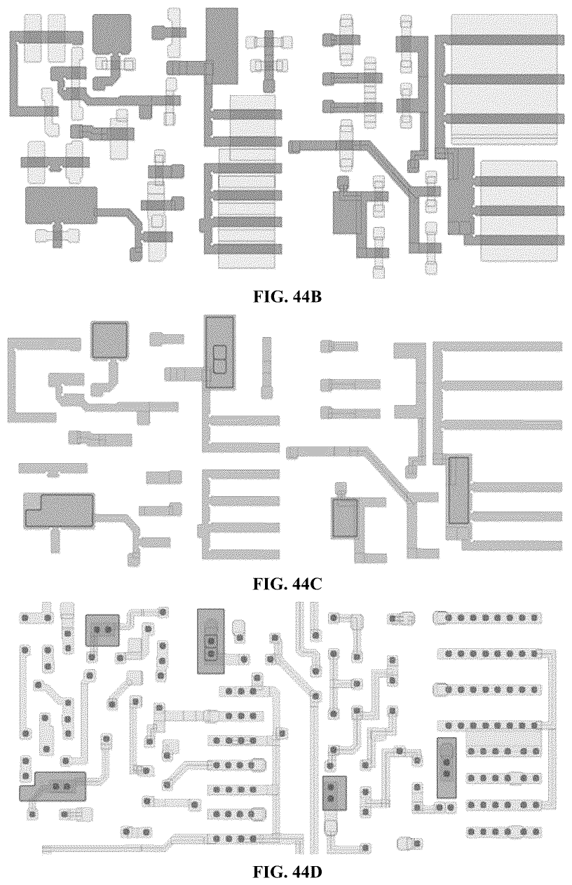

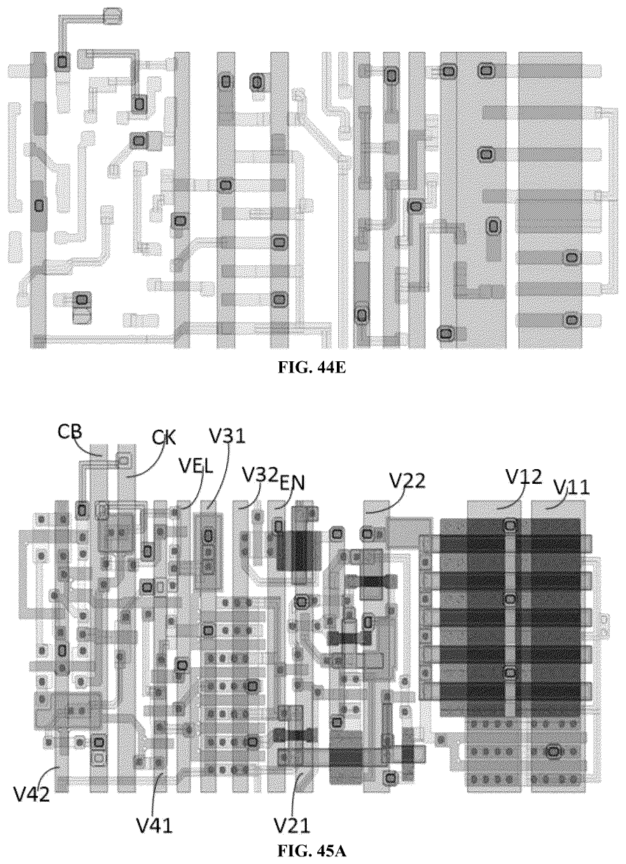

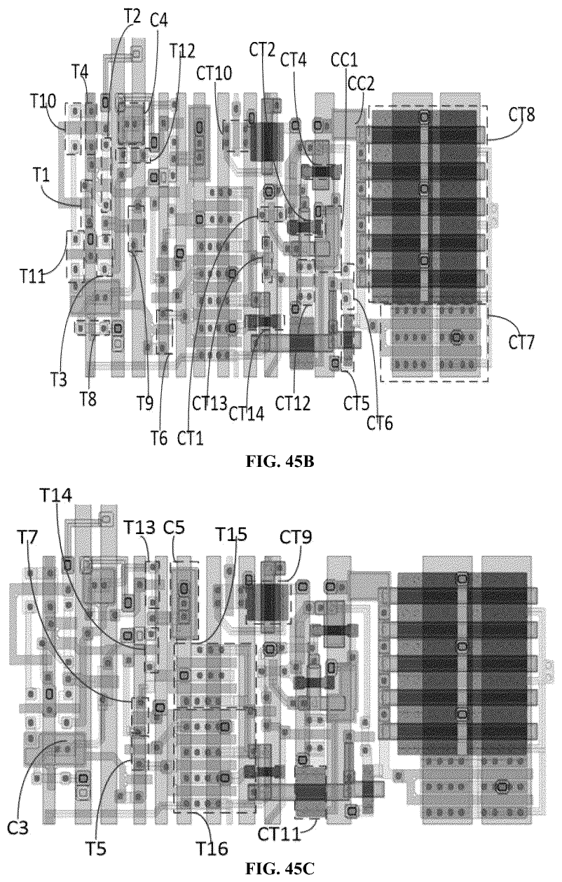

FIG. 45A, FIG. 45B and FIG. 45C are second layout diagrams of a display substrate including at least one embodiment of the driving circuit shown in FIG. 15.

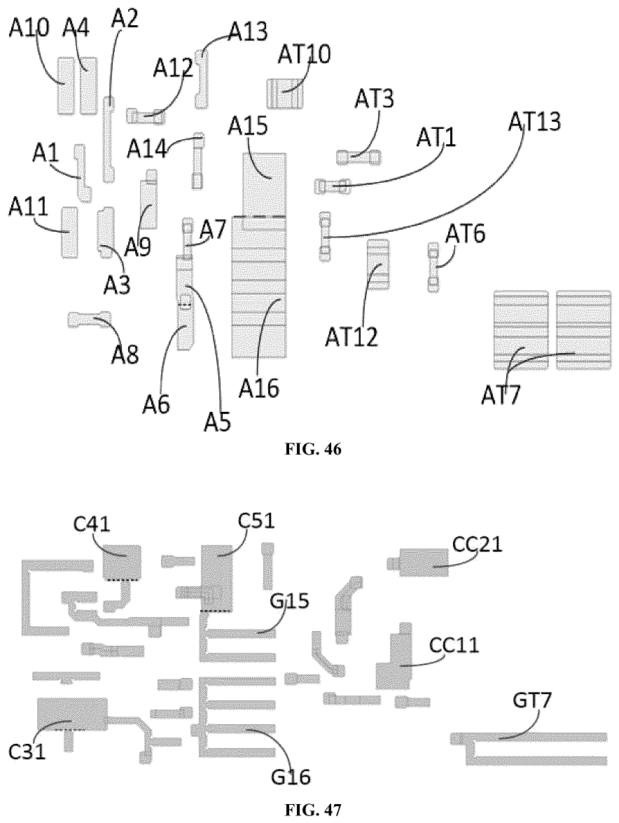

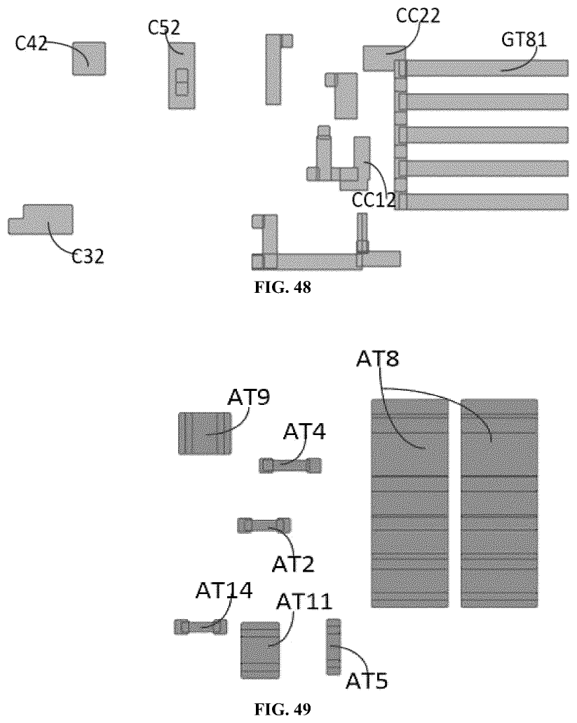

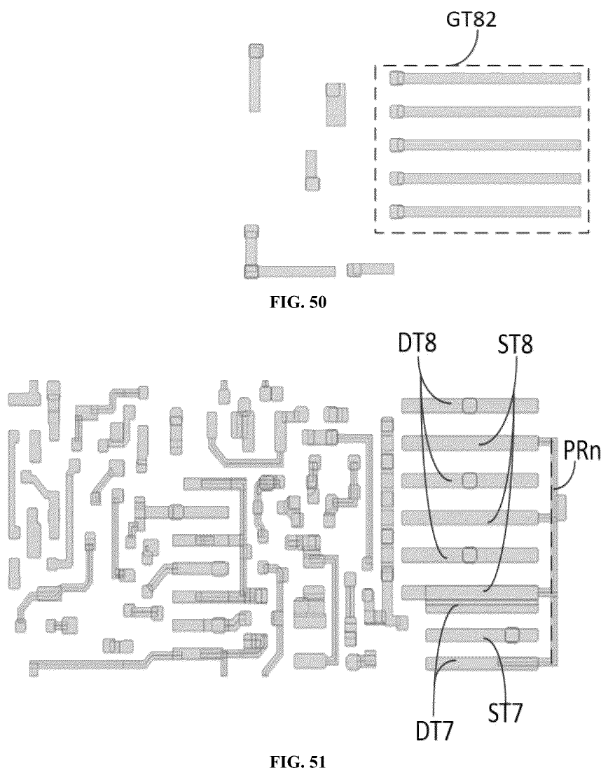

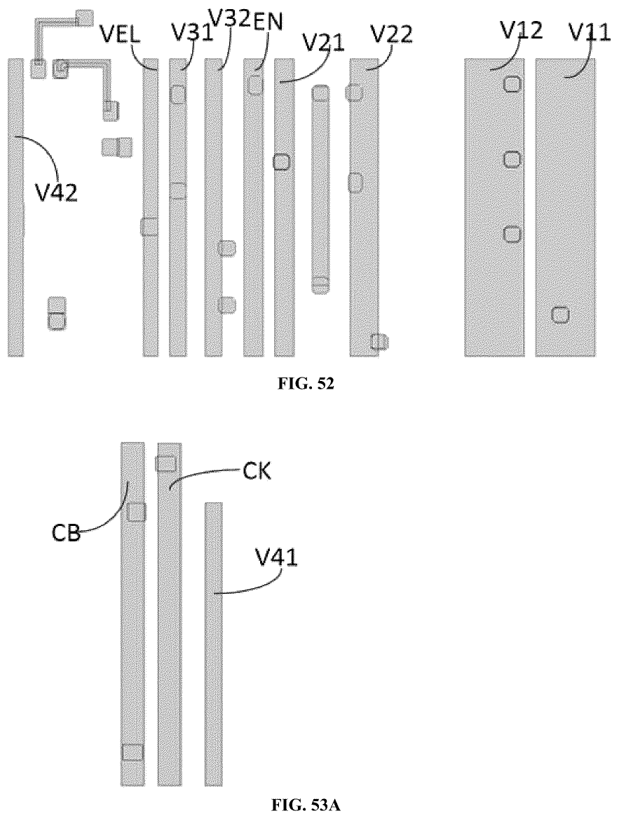

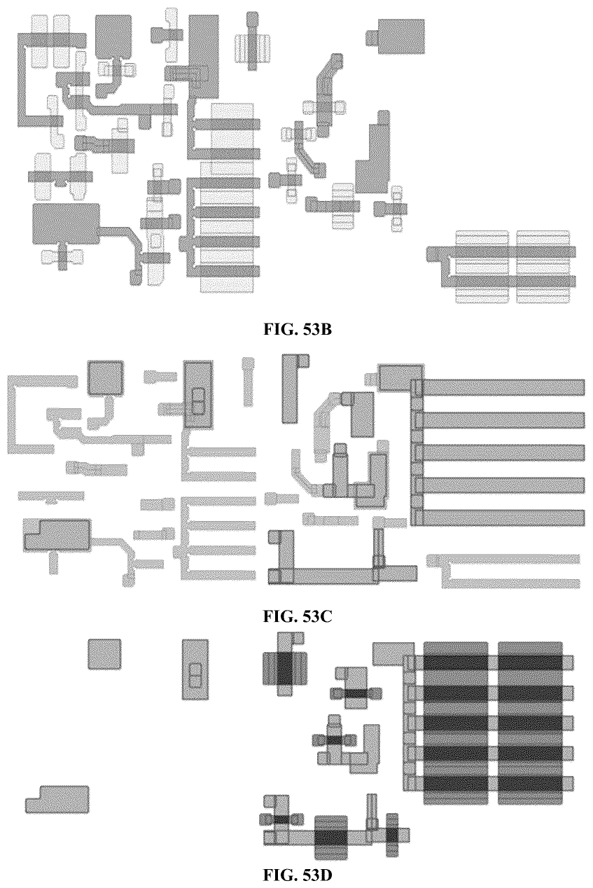

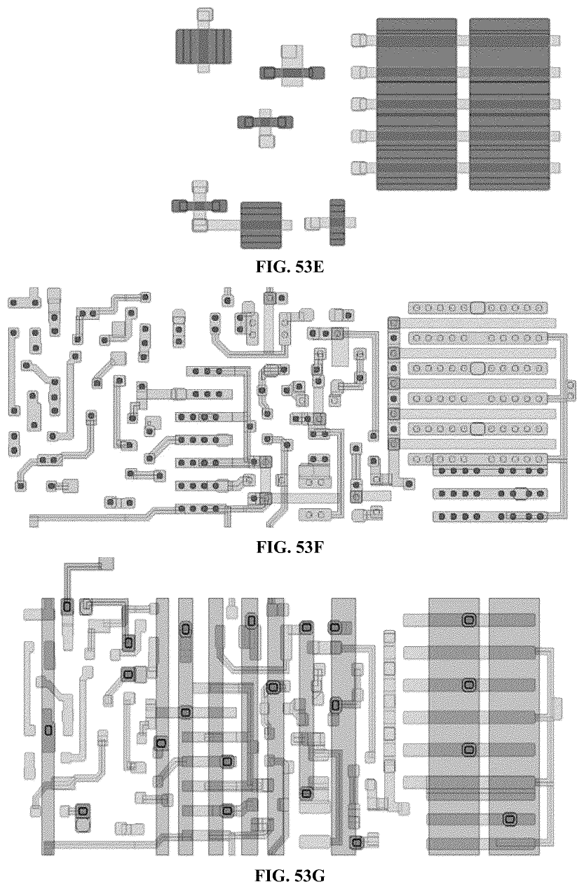

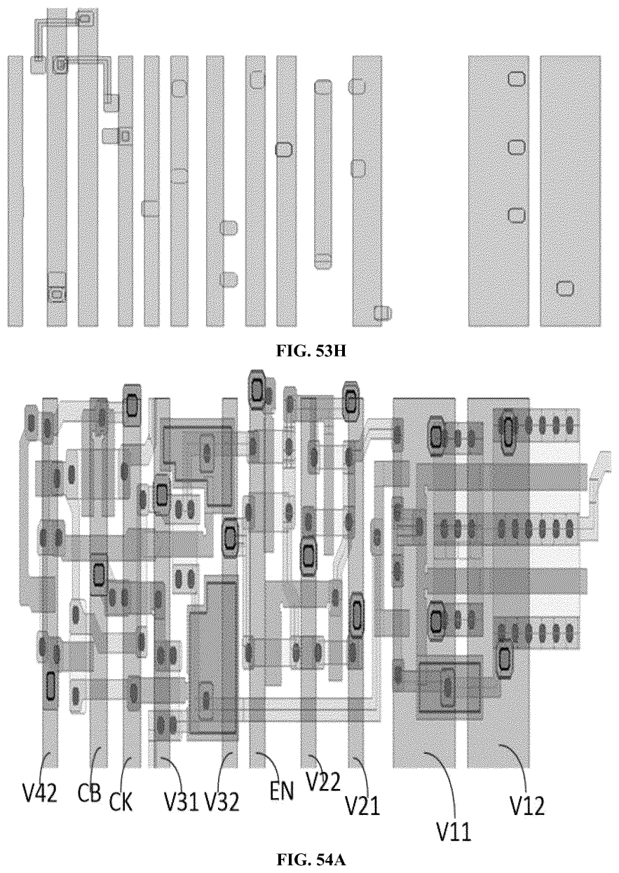

FIG. 46 is a layout diagram of a first semiconductor layer in FIG. 45A, FIG. 47 is a layout diagram of a first gate metal layer in FIG. 45A, FIG. 48 is a layout diagram of a second gate metal layer in FIG. 45A, FIG. 49 is a layout diagram of a second semiconductor layer in FIG. 45A, FIG. 50 is a layout diagram of a third gate metal layer in FIG. 45A, FIG. 51 is a layout diagram of a first source-drain metal layer in FIG. 45A, FIG. 52 is a layout diagram of a second source-drain metal layer in FIG. 45A, and FIG. 53A is a layout diagram of a third source-drain metal layer in FIG. 45A.

FIG. 53B is a superimposed diagram of the first semiconductor layer and the first gate metal layer in FIG. 45A, FIG. 53C is a superimposed diagram of the first gate metal layer and the second gate metal layer in FIG. 45A, FIG. 53D is a superimposed diagram of the second gate metal layer and the second semiconductor layer in FIG. 45A, FIG. 53E is a superimposed diagram of the third gate metal layer and the second semiconductor layer in FIG. 45A, FIG. 53F is a superimposed diagram of the third gate metal layer and the first source-drain metal layer in FIG. 45A, FIG. 53G is a superimposed diagram of the first source-drain metal layer and the second source-drain metal layer in FIG. 45A, and FIG. 53H is a superimposed diagram of the second source-drain metal layer and the third source-drain metal layer in FIG. 45A.

In at least one embodiment of the display substrate shown in FIG. 45A, the first semiconductor layer, the first gate metal layer, the second gate metal layer, the second semiconductor layer, the third gate metal layer, the first source-drain metal layer, the second source-drain metal layer and the third source-drain metal layer are arranged in sequence along the direction away from the base substrate.

At least one embodiment of the display substrate shown in FIG. 45A is a display substrate manufactured by using the LTPO process.

In FIG. 45A to FIG. 53A, an n-th stage first reset terminal is labeled PRn.

As shown in FIG. 45A to FIG. 53A, the high-voltage line includes a first high-voltage line V11 and a second high-voltage line V21, and the low-voltage line includes a first low-voltage line V12 and a second low-voltage line V22.

An orthographic projection of V11 onto the base substrate at least partially overlaps with the orthographic projection of AT7 onto the base substrate; an orthographic projection of V12 onto the base substrate at least partially overlaps with the orthographic projection of AT7 onto the base substrate; the orthographic projection of V11 onto the base substrate at least partially overlaps with the orthographic projection of AT8 onto the base substrate.

The orthographic projection of V12 onto the base substrate at least partially overlaps with the orthographic projection of AT8 onto the base substrate.

At least part of the orthographic projection of CC21 onto the base substrate and at least part of the orthographic projection of CC22 onto the base substrate are arranged between the orthographic projection of V12 onto the base substrate and the orthographic projection of V22 onto the base substrate, and CC2 is arranged using the space between V12 and V22.

The orthographic projection of V22 onto the base substrate at least partially overlaps with the orthographic projection of the active pattern AT4 of CT4 onto the base substrate.

The orthographic projection of V22 onto the base substrate at least partially overlaps with the orthographic projection of CC11 onto the base substrate; the orthographic projection of V22 onto the base substrate at least partially overlaps with the orthographic projection of CC12 onto the base substrate.

CT3 is set between V22 and V21.

At least a part of the orthographic projection of AT12 onto the base substrate is disposed between the orthographic projection of V22 onto the base substrate and the orthographic projection of V21 onto the base substrate.

At least part of the orthographic projection of AT11 onto the base substrate is disposed between the orthographic projection of V22 onto the base substrate and the orthographic projection of V21 onto the base substrate.

The orthographic projection of V21 onto the base substrate at least partially overlaps with the orthographic projection of AT1 onto the base substrate; the orthographic projection of V21 onto the base substrate at least partially overlaps with the orthographic projection of AT13 onto the base substrate; the orthographic projection of V21 onto the base substrate at least partially overlaps with the orthographic projection of AT14 onto the base substrate; the orthographic projection of V21 onto the base substrate at least partially overlaps with the orthographic projection of AT9 onto the base substrate.

As shown in FIG. 45A to FIG. 53A, the high-voltage lines may further include a third high-voltage line V31 and a fourth high-voltage line V41, and the low-voltage lines may include a third low-voltage line V32 and a fourth low-voltage line V42.

In FIG. 47, a gate electrode of CT7 is labeled GT7, a gate electrode of T15 is labeled G15, and a gate electrode of T16 is labeled G16.

In FIG. 48, a first gate electrode of CT8 is labeled GT81, and in FIG. 50, a second gate electrode of CT8 is labeled GT82; a gate electrode of CT8 includes a first gate electrode GT81 of CT8 and a second gate electrode GT82 of CT8 which are electrically connected to each other. CT8 is a dual-gate transistor to reduce leakage.

In FIG. 51, PRn represents an n-th stage first reset terminal, ST8 represents a source electrode of CT8, DT8 represents a drain electrode of CT8, DT7 represents a drain electrode of CT7, and ST7 represents a source electrode of CT7.

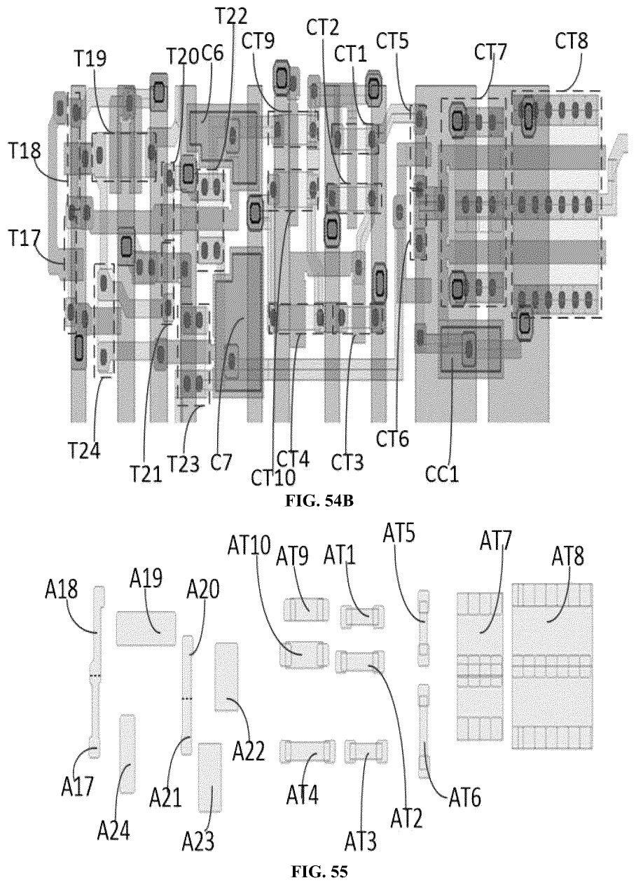

FIG. 54A and FIG. 54B are first layout diagrams of a display substrate including at least one embodiment of the driving circuit shown in FIG. 18.

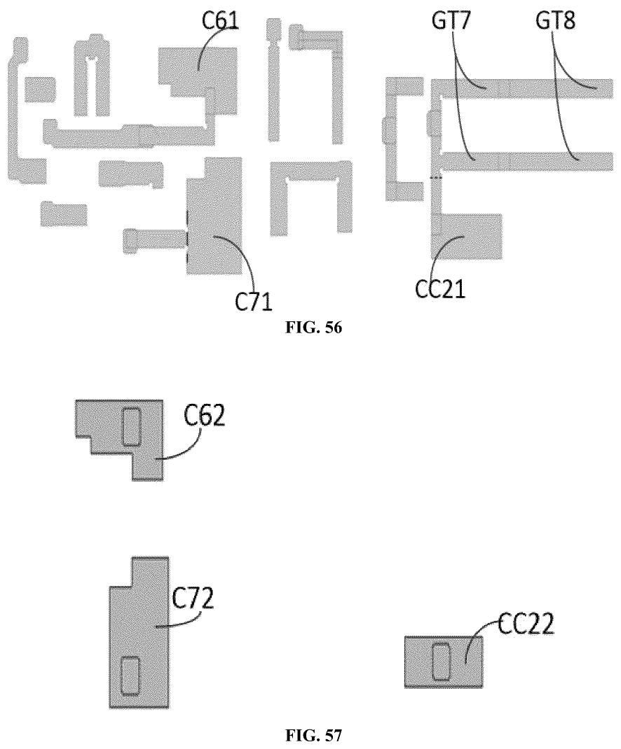

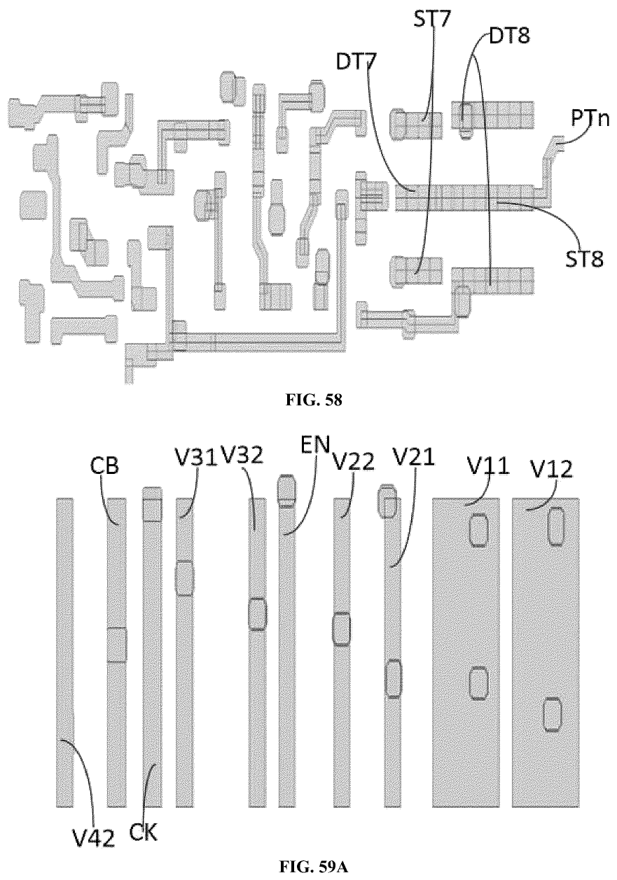

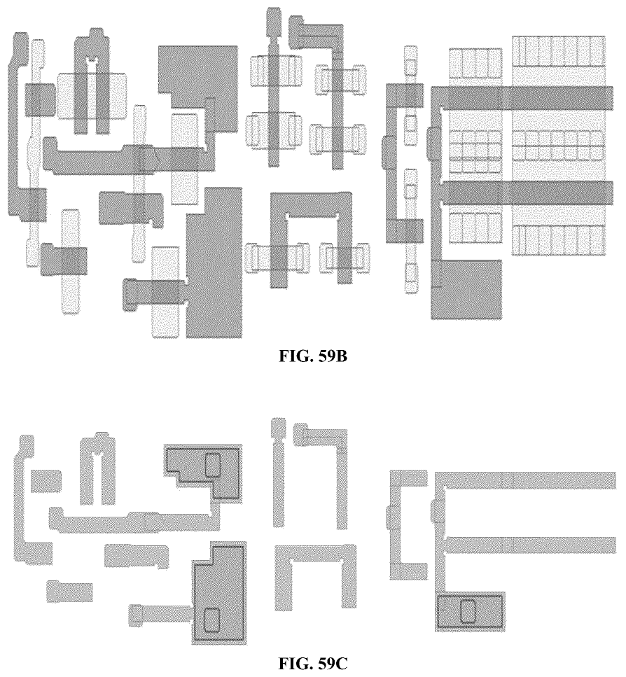

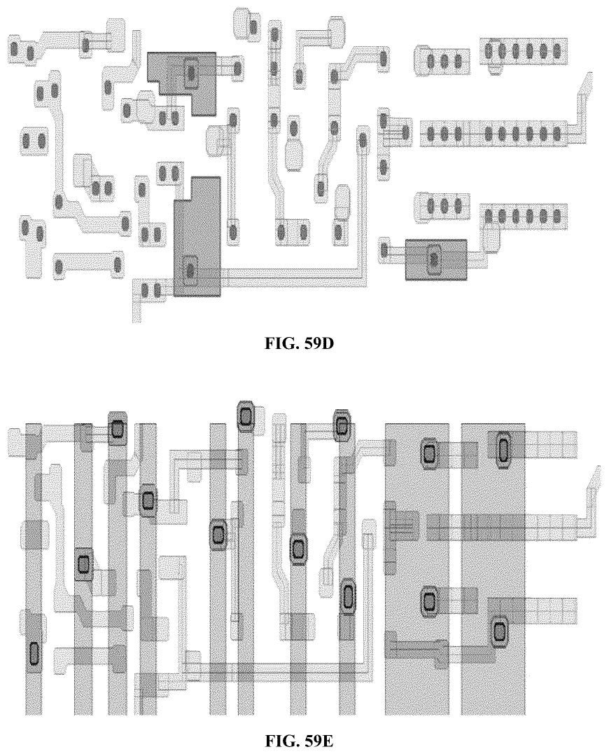

FIG. 55 is a layout diagram of a first semiconductor layer in FIG. 54A, FIG. 56 is a layout diagram of a first gate metal layer in FIG. 54A, FIG. 57 is a layout diagram of a second gate metal layer in FIG. 54A, FIG. 58 is a layout diagram of a first source-drain metal layer in FIG. 54A, and FIG. 59A is a layout diagram of a second source-drain metal layer in FIG. 54A.

FIG. 59B is a superimposed diagram of the first semiconductor layer and the first gate metal layer in FIG. 54A, FIG. 59C is a layout diagram of the first gate metal layer and the second gate metal layer in FIG. 54A, FIG. 59D is a layout diagram of the second gate metal layer and the first source-drain metal layer in FIG. 54A, and FIG. 59E is a layout diagram of the first source-drain metal layer and the second source-drain metal layer in FIG. 54A.

In at least one embodiment of the display substrate shown in FIG. 54A, the first semiconductor layer, the first gate metal layer, the second gate metal layer, the first source-drain metal layer, and the second source-drain metal layer are arranged in sequence in a direction away from the base substrate.

At least one embodiment of the display substrate shown in FIG. 54A is a display substrate manufactured by using a CMOS process.

In FIG. 54A to FIG. 67A, AT1 represents an active pattern of CT1, AT2 represents an active pattern of CT2, AT3 represents an active pattern of CT3, AT4 represents an active pattern of CT4, AT5 represents an active pattern of CT5, AT6 represents an active pattern of CT6, AT7 represents an active pattern of CT7, AT8 represents an active pattern of CT8, AT9 represents an active pattern of CT9, and AT10 represents an active pattern of CT10.

The first electrode plate of CC2 is labeled CC21, and the second electrode plate of CC2 is labeled CC22.

A17 represents the active pattern of T17, A18 represents the active pattern of A18, A19 represents the active pattern of T19, A20 represents the active pattern of T20, A21 represents the active pattern of T21, A22 represents the active pattern of T22, A23 represents the active pattern of T23, and A24 represents the active pattern of T24.

The first electrode plate of C6 is labeled C61, and the second electrode plate of C6 is labeled C62.

The first electrode plate of C7 is labeled C71, and the second electrode plate of C7 is labeled C72.

In at least one embodiment of the present disclosure, the first-voltage line includes a first first-voltage line, and the second-voltage line includes a first second-voltage line.

An orthographic projection of the first second-voltage line onto the base substrate at least partially overlaps with the orthographic projection of the active pattern of at least part of the transistors included in the third control circuit onto the base substrate.

An orthographic projection of the first first-voltage line onto the base substrate at least partially overlaps with the orthographic projection of the active pattern of at least part of the transistors included in the third control circuit onto the base substrate.

The orthographic projection of the first first-voltage line onto the base substrate at least partially overlaps with the orthographic projection of the active pattern of at least part of the transistors included in the second control circuit onto the base substrate.

The orthographic projection of the first first-voltage line onto the base substrate at least partially overlaps with the orthographic projection of the electrode plate of the capacitor included in the second energy storage circuit onto the base substrate.

As shown in FIG. 54 to FIG. 59A, the high-voltage line includes a first high-voltage line V11, and the low-voltage line includes a first low-voltage line V12.

An orthographic projection of V12 onto the base substrate at least partially overlaps with the orthographic projection of AT8 onto the base substrate; the orthographic projection of V12 onto the base substrate at least partially overlaps with the orthographic projection of AT7 onto the base substrate.

An orthographic projection of V11 onto the base substrate at least partially overlaps with the orthographic projection of AT7 onto the base substrate; the orthographic projection of V11 onto the base substrate at least partially overlaps with the orthographic projection of AT5 onto the base substrate; the orthographic projection of V11 onto the base substrate at least partially overlaps with the orthographic projection of AT6 onto the base substrate.

The orthographic projection of V11 onto the base substrate at least partially overlaps with the orthographic projection of CC21 onto the base substrate; the orthographic projection of V11 onto the base substrate at least partially overlaps with the orthographic projection of CC22 onto the base substrate; the orthographic projection of V12 onto the base substrate at least partially overlaps with the orthographic projection of CC21 onto the base substrate; the orthographic projection of V12 onto the base substrate at least partially overlaps with the orthographic projection of CC22 onto the base substrate.

In at least one embodiment of the display substrate shown in FIG. 54A to FIG. 67A, the orthographic projection of each signal line onto the base substrate at least partially overlaps with the orthographic projection of the active pattern of the corresponding transistor onto the base substrate, and the signal line and the electrode plate of the corresponding capacitor are arranged so that their orthographic projections onto the base substrate at least partially overlap, thereby reducing the lateral space occupied by the driving circuit and facilitating the realization of a narrow frame.

Optionally, an orthographic projection of the enable signal line onto the base substrate at least partially overlaps with an orthographic projection of active patterns of at least part of transistors included in the control signal generating circuit onto the base substrate.

As shown in FIG. 54A to FIG. 59A, the orthographic projection of EN onto the base substrate at least partially overlaps with the orthographic projection of AT9 onto the base substrate; the orthographic projection of EN onto the base substrate at least partially overlaps with the orthographic projection of AT10 onto the base substrate.

Optionally, the first-voltage line includes a first first-voltage line and a second first-voltage line, and the second-voltage line includes a first second-voltage line and a second second-voltage line.

The first second-voltage line, the first first-voltage line, the second first-voltage line, the second second-voltage line and the enable signal line are arranged in sequence along a direction away from a display area.

As shown in FIG. 54A to FIG. 59A, the high-voltage line includes a first high-voltage line V11 and a second high-voltage line V21, and the low-voltage line includes a first low-voltage line V12 and a second low-voltage line V22.

V12, V11, V21, V22 and EN are arranged in sequence in a direction away from the display area.

In at least one embodiment of the present disclosure, the first-voltage line includes a first first-voltage line and a second first-voltage line, and the second-voltage line includes a first second-voltage line and a second second-voltage line.

The first first-voltage line, the second first-voltage line, the first second-voltage line and the second second-voltage line all extend along a first direction.

A width of the first first-voltage line along the second direction is greater than a width of the second first-voltage line along the second direction.

A width of the first second-voltage line along the second direction is greater than a width of the second second-voltage line along the second direction.

The first direction crosses the second direction.

Optionally, the first direction may be a vertical direction, and the second direction may be a horizontal direction.

As shown in FIG. 54A to FIG. 59A, the width of V11 along the horizontal direction is greater than the width of V21 along the horizontal direction, and the width of V21 along the horizontal direction is greater than the width of V22 along the horizontal direction. In at least one embodiment of the present disclosure, the width of V11 along the horizontal direction is set to be larger, and the width of V12 along the horizontal direction is set to be larger, thereby reducing the resistance of V11 and the resistance of V12, and reducing the IR Drop (voltage drop) of the high-voltage line and the IR Drop of the low-voltage line.

Optionally, the at least two transistors included in the third control circuit are arranged sequentially along the second direction.

The at least one transistor included in the third control circuit and the capacitor included in the second energy storage circuit are arranged in sequence along the first direction.

As shown in FIG. 54A to FIG. 59A, CT7 and CT8 are arranged in sequence along the horizontal direction, and CT7 and CC2 are arranged in sequence along the vertical direction.

In at least one embodiment of the present disclosure, the first-voltage line includes a third first-voltage line, and the second-voltage line includes a third second-voltage line and a fourth second-voltage line.

An orthographic projection of the third second-voltage line onto the base substrate at least partially overlaps with the orthographic projection of the electrode plate of the capacitor included in the first output node control circuit onto the base substrate.

An orthographic projection of the third second-voltage line onto the base substrate at least partially overlaps with the orthographic projection of the electrode plate of the capacitor included in the third energy storage circuit onto the base substrate.

An orthographic projection of the fourth second-voltage line onto the base substrate at least partially overlaps with an orthographic projection of active patterns of at least part of transistors included in the first output node control circuit onto the base substrate.

As shown in FIG. 54A to FIG. 59A, the high-voltage line includes a third high-voltage line V31, and the low-voltage line includes a third low-voltage line V32 and a fourth low-voltage line V42.

An orthographic projection of V32 onto the base substrate at least partially overlaps with the orthographic projection of C61 onto the base substrate; the orthographic projection of V32 onto the base substrate at least partially overlaps with the orthographic projection of C62 onto the base substrate.

The orthographic projection of V32 onto the base substrate at least partially overlaps with the orthographic projection of C71 onto the base substrate; the orthographic projection of V32 onto the base substrate at least partially overlaps with the orthographic projection of C72 onto the base substrate.

An orthographic projection of V42 onto the base substrate at least partially overlaps with the orthographic projection of A17 onto the base substrate; the orthographic projection of V42 onto the base substrate at least partially overlaps with the orthographic projection of A18 onto the base substrate.

Optionally, the orthographic projection of the first clock signal line onto the base substrate at least partially overlaps with the orthographic projection of active patterns of at least part of transistors included in the second output node control circuit onto the base substrate.

An orthographic projection of the second clock signal line onto the base substrate at least partially overlaps with an orthographic projection of active patterns of at least part of transistors included in the second output node control circuit onto the base substrate.

As shown in FIG. 54A to FIG. 59A, the orthographic projection of CK onto the base substrate at least partially overlaps with the orthographic projection of A20 onto the base substrate; the orthographic projection of CK onto the base substrate at least partially overlaps with the orthographic projection of A21 onto the base substrate.

The orthographic projection of CB onto the base substrate at least partially overlaps with the orthographic projection of A19 onto the base substrate.

Optionally, the first-voltage line includes a third first-voltage line, and the second-voltage line includes a third second-voltage line and a fourth second-voltage line.

At least a portion of an electrode plate of a capacitor included in the first output node control circuit is disposed between the third second-voltage line and the third first-voltage line.

At least a portion of an electrode plate of a capacitor included in the third energy storage circuit is disposed between the third second-voltage line and the third first-voltage line.

As shown in FIG. 54A to FIG. 59A, at least a portion of the orthographic projection of C61 onto the base substrate, at least a portion of the orthographic projection of C62 onto the base substrate, at least a portion of the orthographic projection of C71 onto the base substrate, and at least a portion of the orthographic projection of C72 onto the base substrate are arranged between the orthographic projection of V32 onto the base substrate and the orthographic projection of V31 onto the base substrate, thereby utilizing the space between V31 and V32 to set the seventh capacitor and the eighth capacitor and reasonably layout the signal lines and capacitors.

In at least one embodiment of the present disclosure, the first-voltage line includes a third first-voltage line, and the second-voltage line includes a third second-voltage line and a fourth second-voltage line.

The third second-voltage line, the third first-voltage line, the first clock signal line, the second clock signal line and the fourth second-voltage line are arranged in sequence along a direction away from the display area.

As shown in FIG. 54A to FIG. 59A, V32, V31, CK, CB and V42 are arranged in sequence in a direction away from the display area.

In FIG. 56, a gate electrode of CT7 is labeled GT7, and a gate electrode of CT8 is labeled GT8.

In FIG. 58, PTn represent an n-th stage second scanning terminal, DT7 represents a drain electrode of CT7, ST8 represents a source electrode of CT8, ST7 represents a source electrode of CT7, and DT8 represents a drain electrode of CT8.

As shown in FIG. 59A, V12, V11, V21, V22, EN, V32, V31, CK, CB and V42 are all arranged in the second source-drain metal layer, V12, V11, V21, V22, EN, V32, V31, CK, CB and V42 are arranged in sequence along the direction away from the display area, and V12, V11, V21, V22, EN, V32, V31, CK, CB and V42 all extend in the vertical direction.

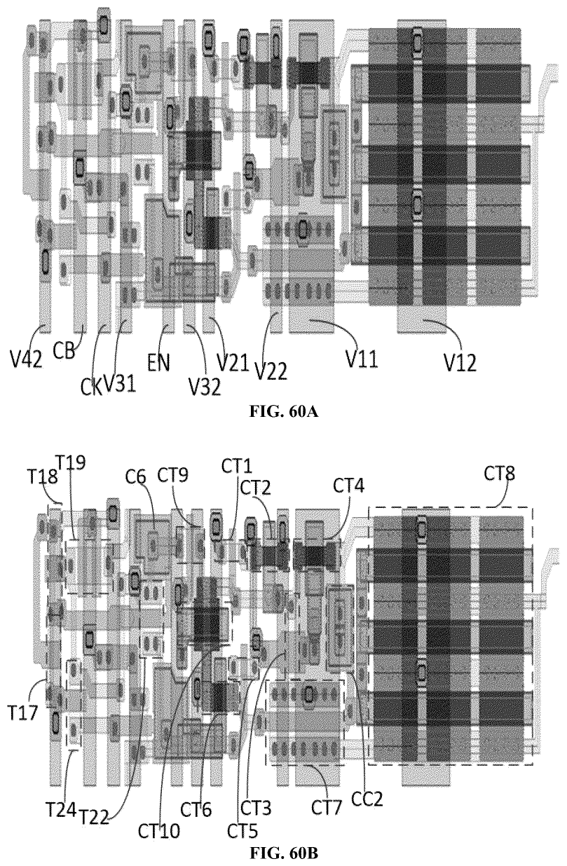

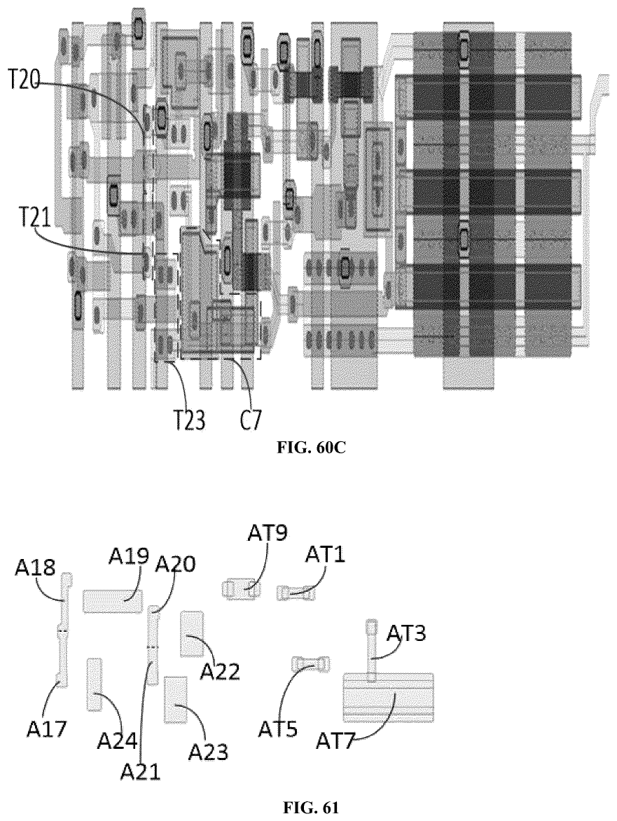

FIG. 60A, FIG. 60B and FIG. 60C are second layout diagrams of a display substrate including at least one embodiment of the driving circuit shown in FIG. 18.

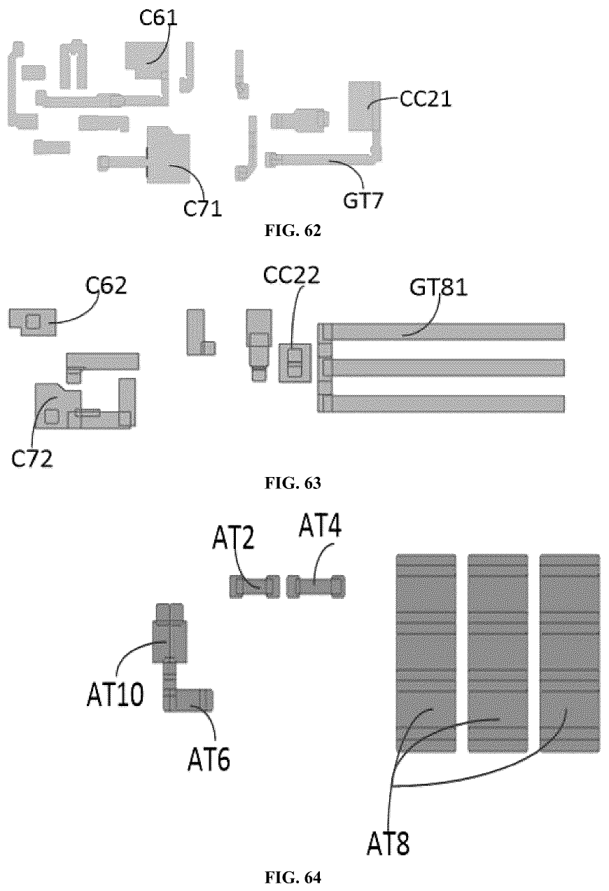

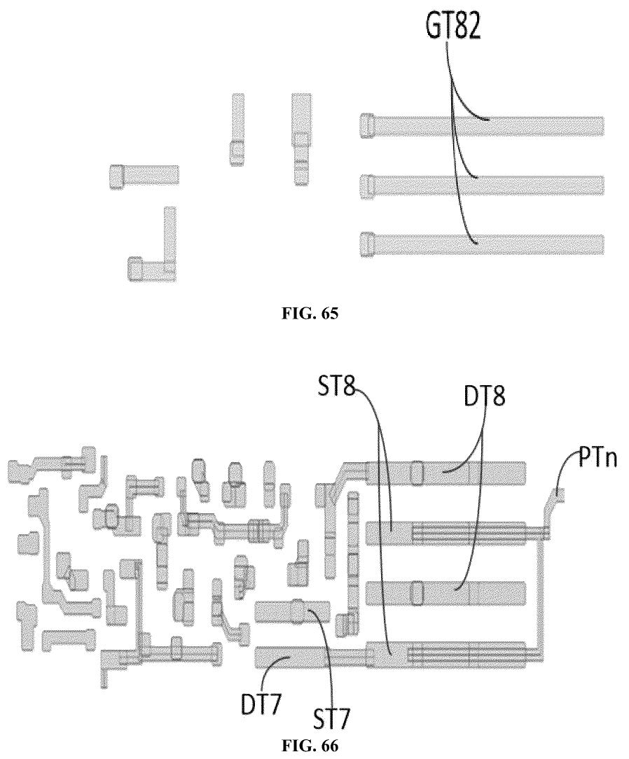

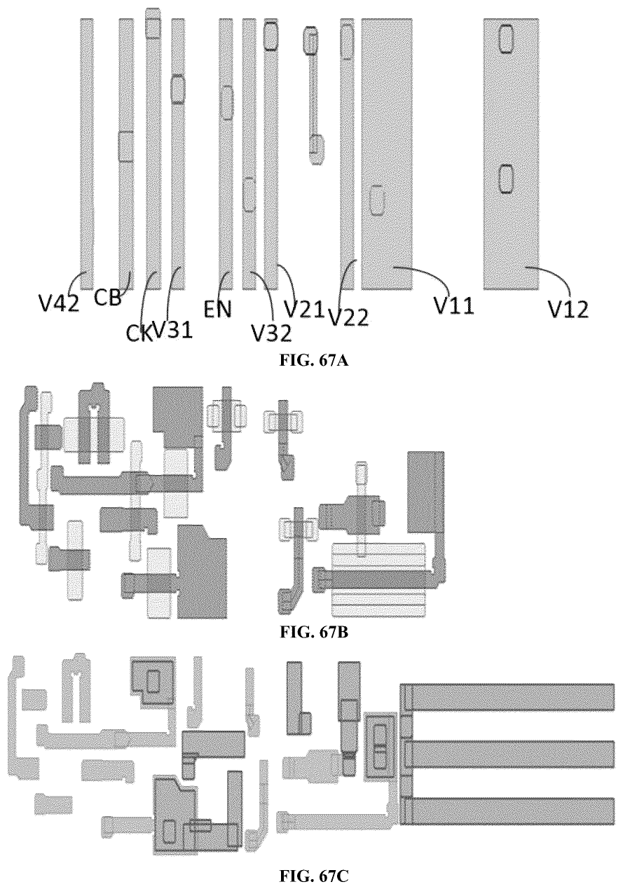

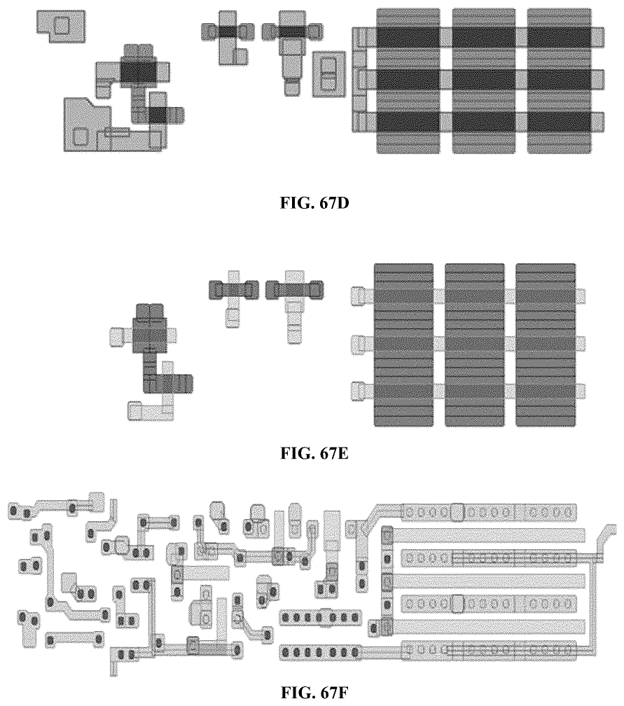

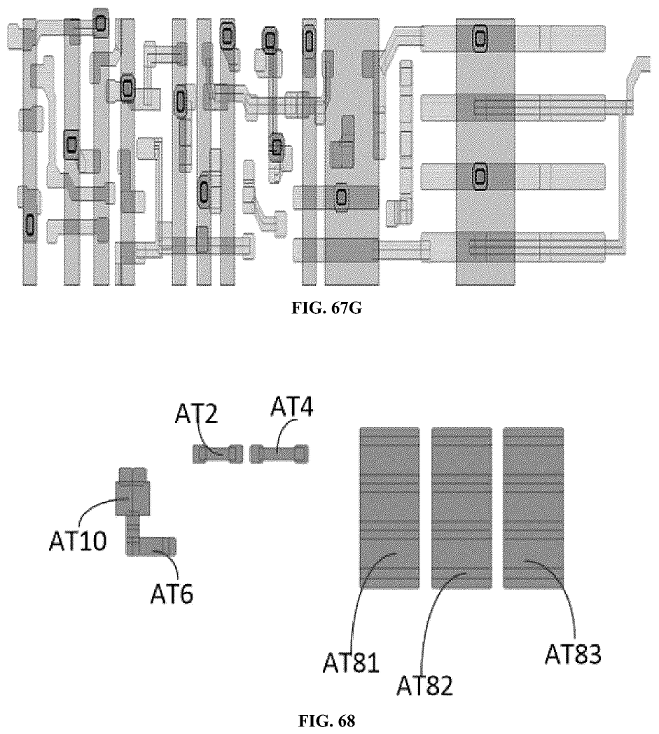

FIG. 61 is a layout diagram of a first semiconductor layer in FIG. 60A, FIG. 62 is a layout diagram of a first gate metal layer in FIG. 60A, FIG. 63 is a layout diagram of a second gate metal layer in FIG. 60A, FIG. 64 is a layout diagram of a second semiconductor layer in FIG. 60A, FIG. 65 is a layout diagram of a third gate metal layer in FIG. 60A, FIG. 66 is a layout diagram of a first source-drain metal layer in FIG. 60A, and FIG. 67A is a layout diagram of a second source-drain metal layer in FIG. 60A.

FIG. 67B is a layout diagram of the first semiconductor layer and the first gate metal layer in FIG. 60A, FIG. 67C is a layout diagram of the first gate metal layer and the second gate metal layer in FIG. 60A, FIG. 67D is a layout diagram of the second gate metal layer and the second semiconductor layer in FIG. 60A, FIG. 67E is a layout diagram of the third gate metal layer and the second semiconductor layer in FIG. 60A, FIG. 67F is a layout diagram of the third gate metal layer and the first source-drain metal layer in FIG. 60A, and FIG. 67G is a layout diagram of the first source-drain metal layer and the second source-drain metal layer in FIG. 60A.

In at least one embodiment of the display substrate shown in FIG. 60A, the first semiconductor layer, the first gate metal layer, the second gate metal layer, the second semiconductor layer, the third gate metal layer, the first source-drain metal layer and the second source-drain metal layer are arranged in sequence along the direction away from the base substrate.

At least one embodiment of the display substrate shown in FIG. 60A is a display substrate manufactured by using the LTPO process.

Optionally, the second-voltage line includes a first second-voltage line.

An orthographic projection of the first second-voltage line onto the base substrate at least partially overlaps with the orthographic projection of active patterns of at least part of transistors included in the third control circuit onto the base substrate.

As shown in FIG. 60A to FIG. 67A, the low-voltage lines include a first low-voltage line V12.

An orthographic projection of V12 onto the base substrate at least partially overlaps with the orthographic projection of the active pattern AT8 of CT8 onto the base substrate.

Optionally, the third control circuit includes an eighth control transistor.

An orthographic projection of the first second-voltage line onto the base substrate partially overlaps with the active pattern of the eighth control transistor.

A gate electrode of the eighth control transistor is electrically connected to the second control output terminal, a first electrode of the eighth control transistor is electrically connected to the n-th stage driving output terminal, and a second electrode of the eighth control transistor is electrically connected to the second-voltage line.

The active pattern of the eighth control transistor includes at least two active pattern parts independent of each other.

The at least two mutually independent active pattern portions are arranged in sequence along the second direction.

As shown in FIG. 60A to FIG. 67A, the active pattern AT8 of CT8 includes three independent active pattern portions.

FIG. 68 is a layout diagram of a second semiconductor layer in FIG. 60A; in FIG. 68, AT81 represents a first active pattern portion included in the active pattern of CT8, AT82 represents a second active pattern portion included in the active pattern of CT8, and AT83 represent a third active pattern portion included in the active pattern of CT8.

AT81, AT82 and AT83 are independent of each other.

AT81, AT82 and AT83 are arranged in sequence along the horizontal direction; a certain distance is set between AT81, AT82 and AT83 to facilitate heat dissipation, thereby improving the stability of CT8 while ensuring an area of the active pattern of CT8.

In at least one embodiment of the present disclosure, the first-voltage line includes a first first-voltage line.

An orthographic projection of the first first-voltage line onto the base substrate at least partially overlaps with the orthographic projection of the electrode plate of the capacitor included in the second energy storage circuit onto the base substrate.

The orthographic projection of the first first-voltage line onto the base substrate at least partially overlaps with the orthographic projection of the active pattern of at least part of the transistors included in the first control circuit onto the base substrate.

The orthographic projection of the first first-voltage line onto the base substrate at least partially overlaps with an orthographic projection of active patterns of at least part of transistors included in the third control circuit onto the base substrate.

As shown in FIG. 60A to FIG. 67A, the high-voltage lines include a first high-voltage line V11.

An orthographic projection of V11 onto the base substrate at least partially overlaps with the orthographic projection of CC21 onto the base substrate; the orthographic projection of V11 onto the base substrate at least partially overlaps with the orthographic projection of CC22 onto the base substrate.

The orthographic projection of V11 onto the base substrate at least partially overlaps with the orthographic projection of AT4 onto the base substrate; the orthographic projection of V11 onto the base substrate at least partially overlaps with the orthographic projection of AT7 on the base substrate.

Optionally, the first-voltage line further includes a second first-voltage line and a third first-voltage line.

The first first-voltage line, the second first-voltage line and the third first-voltage line all extend along a first direction.

A width of the first first-voltage line along a second direction is greater than a width of the second first-voltage line along the second direction.

A width of the first first-voltage line along the second direction is greater than a width of the third first-voltage line along the second direction.

The first direction crosses the second direction.

As shown in FIG. 60A to FIG. 67A, the high-voltage lines further include a second high-voltage line V21 and a third high-voltage line V31.

A width of V11 along the horizontal direction is greater than a width of V21 along the horizontal direction; the width of V11 along the horizontal direction is greater than the width of V31 along the horizontal direction.

In at least one embodiment shown in FIG. 60A to FIG. 67A, the width of V11 in the horizontal direction is set to be larger to reduce the resistance of V11.

In at least one embodiment of the present disclosure, the second-voltage line includes a second second-voltage line and a third second-voltage line, and the first-voltage line includes a second first-voltage line.

An orthographic projection of the second second-voltage line onto the base substrate at least partially overlaps with the orthographic projection of the active pattern of at least part of the transistors included in the third control circuit onto the base substrate.

The orthographic projection of the second first-voltage line onto the base substrate at least partially overlaps with the orthographic projection of the active pattern of at least part of the transistors included in the control signal generating circuit onto the base substrate.

The orthographic projection of the second first-voltage line onto the base substrate at least partially overlaps with the orthographic projection of the active pattern of at least part of the transistors included in the second control circuit onto the base substrate.

The orthographic projection of the third second-voltage line onto the base substrate at least partially overlaps with the orthographic projection of the active pattern of at least part of the transistors included in the control signal generating circuit onto the base substrate.

The orthographic projection of the enable signal line onto the base substrate at least partially overlaps with the orthographic projection of the electrode plate of the capacitor included in the third energy storage circuit onto the base substrate.

As shown in FIG. 60A to FIG. 67A, the low-voltage line includes a second low-voltage line V22 and a third low-voltage line V32, and the high-voltage line includes a second high-voltage line V21.

An orthographic projection of V22 onto the base substrate at least partially overlaps with the orthographic projection of AT7 onto the base substrate.

An orthographic projection of V21 onto the base substrate at least partially overlaps with the orthographic projection of AT10 onto the base substrate.

The orthographic projection of V21 onto the base substrate at least partially overlaps with the orthographic projection of AT6 onto the base substrate.

The orthographic projection of V32 onto the base substrate at least partially overlaps with the orthographic projection of AT10 onto the base substrate.

The orthographic projection of EN onto the base substrate at least partially overlaps with the orthographic projection of C71 onto the base substrate, and the orthographic projection of EN onto the base substrate at least partially overlaps with the orthographic projection of C72 onto the base substrate.

Optionally, a width of the first second-voltage line along the second direction is greater than a width of the second second-voltage line along the second direction.

The width of the first second-voltage line along the second direction is greater than the width of the third second-voltage line along the second direction.

The first direction crosses the second direction.

As shown in FIG. 60A to FIG. 67A, the width of V12 along the horizontal direction is greater than the width of V22 along the horizontal direction, and the width of V12 along the horizontal direction is greater than the width of V32 along the horizontal direction.

In at least one embodiment shown in FIG. 60A to FIG. 67A, the width of V12 along the horizontal direction is set to be larger to reduce the resistance of V12.

Optionally, the first-voltage line further includes a third first-voltage line.

At least a portion of an electrode plate of a capacitor included in the first output node control circuit is disposed between the enable signal line and the third first-voltage line.

At least a portion of an electrode plate of a capacitor included in the third energy storage circuit is disposed between the enable signal line and the third first-voltage line.

As shown in FIG. 60A to 67A, a part of the orthographic projection of C61 onto the base substrate is arranged between the orthographic projection of EN onto the base substrate and the orthographic projection of V31 onto the base substrate, and a part of the orthographic projection of C62 onto the base substrate is arranged between the orthographic projection of EN onto the base substrate and the orthographic projection of V31 onto the base substrate; a part of the orthographic projection of C71 onto the base substrate is arranged between the orthographic projection of EN onto the base substrate and the orthographic projection of V31 onto the base substrate, and a part of the orthographic projection of C72 onto the base substrate is arranged between the orthographic projection of EN onto the base substrate and the orthographic projection of V31 onto the base substrate; so as to reasonably layout the capacitors by utilizing the space between EN and V31.

In at least one embodiment of the present disclosure, the first-voltage line includes a first first-voltage line, a second first-voltage line, and a third first-voltage line, and the second-voltage line includes a first second-voltage line, a second second-voltage line, a third first-voltage line, and a fourth first-voltage line.

The first second-voltage line, the first first-voltage line, the second second-voltage line, the second first-voltage line, the third second-voltage line, the enable signal line, the third first-voltage line, the first clock signal line, the second clock signal line and the fourth second-voltage line are arranged in sequence along a direction away from the display area.

As shown in FIG. 60A to FIG. 67A, V12, V11, V22, V21, V32, EN, V31, CK, CB and V42 all extend in the vertical direction, and V12, V11, V22, V21, V32, EN, V31, CK, CB and V42 are arranged in sequence in the direction away from the display area.

In FIG. 63, GT81 represents a first gate electrode of CT8, and in FIG. 65, GT82 represents a second gate electrode of CT8; the gate electrode of CT8 includes a first gate GT81 of CT8 and a second gate GT82 of CT8 which are electrically connected to each other, and CT8 is a dual-gate transistor to reduce leakage.

In FIG. 62, GT7 represents a gate electrode of CT7.

In FIG. 66, PTn represents an n-th stage second scanning terminal, DT7 represents a drain electrode of CT7, ST8 represents a source electrode of CT8, ST7 represents a source electrode of CT7, and DT8 represents a drain electrode of CT8.

As shown in FIG. 67A, V12, V11, V22, V21, V32, EN, V31, CK, CB, and V42 are all disposed in the second source-drain metal layer.

In at least one embodiment of the display substrate shown in FIG. 22A to FIG. 68, the display area may be disposed on a right side of the driving circuit, which is not limited thereto.

In at least one embodiment of the present disclosure, the active pattern of the transistor included in the driving circuit is formed in the first semiconductor layer; or,

the active pattern of the p-type transistor included in the driving circuit is formed in the first semiconductor layer, and the active pattern of the n-type transistor included in the driving circuit is formed in the second semiconductor layer.

The display device in the embodiment of the present disclosure includes the above display substrate.

The above is a preferred embodiment of the present disclosure. It is to be pointed out that for those skilled in the art, several improvements and modifications can be made without departing from the principles described in the present disclosure. These improvements and modifications should also be regarded as falling in the protection scope of the present disclosure.

1. A driving circuit, comprises: a driving signal generating circuit, a control signal generating circuit and a control circuit;
wherein the driving signal generating circuit is electrically connected to an n-th stage driving signal output terminal, and is used to generate and output an n-th stage driving signal through the n-th stage driving signal output terminal; n is a positive integer;
the control signal generating circuit is electrically connected to an enable signal line and a control signal terminal, and is used to generate a control signal according to an enable signal provided by the enable signal line and output the control signal through the control signal terminal;
the control circuit is electrically connected to the control signal terminal, the n-th stage driving signal output terminal and an n-th stage driving output terminal respectively, and is used to output the n-th stage driving signal or invalid voltage signal to the n-th stage driving output terminal under control of the control signal.

2. The driving circuit according to claim 1, further comprising an output inverting circuit;
wherein the output inverting circuit is electrically connected to the n-th stage driving signal output terminal and the n-th stage inverting signal output terminal respectively, and is used to invert the n-th stage driving signal to obtain and output an n-th stage inverting driving signal through the n-th stage inverting signal output terminal;
or,
wherein the control circuit includes a first control circuit, a second control circuit, a third control circuit, a fourth control circuit, and a second energy storage circuit; the first control circuit is electrically connected to the control signal terminal, a first-voltage line, a second-voltage line and a first control output terminal respectively, and is used to invert the control signal to obtain an inverting control signal, and output the inverting control signal through the first control output terminal; the second control circuit is electrically connected to the n-th stage driving signal output terminal, the first control output terminal, a second control output terminal and a second-voltage line respectively, and is used to control the second control output terminal to be connected to the second-voltage line or the first control output terminal under control of the n-th stage driving signal; the third control circuit is electrically connected to the second control output terminal, the first-voltage line, the second-voltage line and the n-th stage driving output terminal respectively, and is used to invert a signal output by the second control output terminal, and output an inverting signal through the n-th stage driving output terminal; the second energy storage circuit is electrically connected to the second control output terminal, and is used to maintain a potential of the second control output terminal.

3. The driving circuit according to claim 2, wherein the control circuit includes a first control circuit, a second control circuit, a third control circuit, a first energy storage circuit, and a second energy storage circuit;
the first control circuit is electrically connected to the control signal terminal, a first-voltage line, a second-voltage line and a first control output terminal respectively, and is used to invert the control signal to obtain an inverting control signal, and output the inverting control signal through the first control output terminal;
the second control circuit is electrically connected to the n-th stage driving signal output terminal, the first-voltage line, the first control output terminal and the second control output terminal respectively, and is used to control the second control output terminal to be coupled to the first-voltage line or the first control output terminal under control of the n-th stage driving signal; or, the second control circuit is electrically connected to the n-th stage driving signal output terminal, the first control output terminal, the second control output terminal and the second-voltage line respectively, and is used to control the second control output terminal to be coupled to the second-voltage line or the first control output terminal under control of the n-th stage driving signal;
the third control circuit is electrically connected to the second control output terminal, the first-voltage line, the second-voltage line and the n-th stage driving output terminal respectively, and is used to invert a signal output by the second control output terminal, and output an inverting signal through the n-th stage driving output terminal;
the first energy storage circuit is electrically connected to the control signal terminal and is used to maintain a potential of the control signal terminal;
the second energy storage circuit is electrically connected to the second control output terminal, and is used to maintain a potential of the second control output terminal;
or,
wherein the control signal generating circuit is used to invert the enable signal to generate an inverting enable signal, and output the inverting enable signal through the control signal terminal;
or,
wherein the output inverting circuit includes a thirteenth control transistor and a fourteenth control transistor; a gate electrode of the thirteenth control transistor is electrically connected to the n-th stage driving signal output terminal, a first electrode of the thirteenth control transistor is electrically connected to the first-voltage line, and a second electrode of the thirteenth control transistor is electrically connected to the n-th stage inverting signal output terminal; a gate electrode of the fourteenth control transistor is electrically connected to the n-th stage driving signal output terminal, a first electrode of the fourteenth control transistor is electrically connected to the n-th stage inverting signal output terminal, and a second electrode of the fourteenth control transistor is electrically connected to the second-voltage line; the thirteenth control transistor is a p-type transistor, and the fourteenth control transistor is an n-type transistor;
or,
wherein the driving signal generating circuit includes a first output node control circuit, a second output node control circuit, a third energy storage circuit and an output circuit; the first output node control circuit is electrically connected to the first clock signal line, the second-voltage line, and the second output node, respectively, and is used to control connection between the first output node and the second-voltage line under control of the first clock signal provided by the first clock signal line, and control connection between the first output node and the first clock signal line under control of the potential of the second output node, and is used to maintain the potential of the first output node; the second output node control circuit is electrically connected to the second output node, the first clock signal line, the input terminal, the second clock signal line, the first output node and the first-voltage line respectively, and is used to control connection between the second output node and the input terminal under control of the first clock signal, and control connection between the second output node and the first-voltage line under control of the potential of the first output node and a second clock signal provided by the second clock signal line; a first end of the third energy storage circuit is electrically connected to the second output node, a second end of the third energy storage circuit is electrically connected to the n-th stage driving signal output terminal, and the third energy storage circuit is used to store electric energy; the output circuit is electrically connected to the first output node, the second output node, the first-voltage line, the second clock signal and the n-th stage driving signal output terminal, respectively, and is used to control connection between the n-th stage driving signal output terminal and the first-voltage line under control of the potential of the first output node, and to control connection between the n-th stage driving signal output terminal and the second clock signal line under control of the potential of the second output node.

4. (canceled)

5. The driving circuit according to claim 3, wherein the control signal generating circuit is further electrically connected to a (n−1)-th stage driving signal output terminal, a (n−1)-th stage inverting signal output terminal, an n-th stage driving signal output terminal and an n-th stage inverting signal output terminal, respectively, and is used to control connection or disconnection between the enable signal line and the control signal terminal under control of a (n−1)-th stage driving signal, a (n−1)-th stage inverting driving signal, an n-th stage driving signal and an n-th stage inverting driving signal;
or,
wherein the first control circuit includes a first control transistor, a second control transistor, a third control transistor and a fourth control transistor; the second control circuit includes a fifth control transistor and a sixth control transistor; the third control circuit includes a seventh control transistor and an eighth control transistor; and the second energy storage circuit includes a second capacitor; a gate electrode of the first control transistor is electrically connected to the control signal terminal, a first electrode of the first control transistor is electrically connected to the first-voltage line, and a second electrode of the first control transistor is electrically connected to the first control output terminal; a gate electrode of the second control transistor is electrically connected to the control signal terminal, a first electrode of the second control transistor is electrically connected to the first control output terminal, and a second electrode of the second control transistor is electrically connected to the second-voltage line; a gate electrode of the third control transistor is electrically connected to the first control output terminal, a first electrode of the third control transistor is electrically connected to the first-voltage line, and a second electrode of the third control transistor is electrically connected to the control signal terminal; a gate electrode of the fourth control transistor is electrically connected to the first control output terminal, a first electrode of the fourth control transistor is electrically connected to the control signal terminal, and a second electrode of the fourth control transistor is electrically connected to the second-voltage line; a gate electrode of the fifth control transistor and a gate electrode of the sixth control transistor are both electrically connected to the n-th stage driving signal output terminal, a first electrode of the fifth control transistor is electrically connected to the first control output terminal, and a second electrode of the fifth control transistor is electrically connected to the second control output terminal; a first electrode of the sixth control transistor is electrically connected to the second control output terminal, and a second electrode of the sixth control transistor is electrically connected to the second-voltage line; a gate electrode of the seventh control transistor is electrically connected to the second control output terminal; a first electrode of the seventh control transistor is electrically connected to the first-voltage line, and a second electrode of the seventh control transistor is electrically connected to the n-th stage driving output terminal; a gate electrode of the eighth control transistor is electrically connected to the second control output terminal, a first electrode of the eighth control transistor is electrically connected to the n-th stage driving output terminal, and a second electrode of the eighth control transistor is electrically connected to the second-voltage line; a first electrode plate of the second capacitor is electrically connected to the second control output terminal, and a second electrode plate of the second capacitor is electrically connected to the second-voltage line; the first control transistor, the third control transistor, the fifth control transistor and the seventh control transistor are all p-type transistors, and the second control transistor, the fourth control transistor, the sixth control transistor and the eighth control transistor are all n-type transistors;
or,
wherein the driving signal generating circuit includes a first node control circuit, a second node control circuit, a first output node control circuit, a second output node control circuit, a potential maintaining circuit and an output circuit; the first node control circuit is electrically connected to a first node, a first clock signal line, a second-voltage line and a second output node, respectively, and is used to control connection between the first node and the second-voltage line under control of a first clock signal provided by the first clock signal line, and to control connection or disconnection between the first node and the first clock signal line under control of a potential of the second output node; the second node control circuit is electrically connected to the first node, a first intermediate node, a first-voltage line, a second clock signal line, a second node, an input terminal and a second-voltage line respectively, and is used to control connection between the first intermediate node and the first-voltage line under control of the potential of the first node, control connection between the first intermediate node and the second clock signal line under control of a potential of the second node, and control the potential of the second node according to the potential of the first intermediate node, and control connection between the input terminal and the second node under control of a second clock signal provided by the second clock signal line and a second-voltage signal provided by the second-voltage line; the first output node control circuit is electrically connected to a first output node, the first node, the second clock signal line, a second intermediate node, a second output node and the first-voltage line respectively, and is used to control connection between the second intermediate node and the second clock signal line under control of a potential of the first node, control a potential of the second intermediate node according to the potential of the first node, control connection between the second intermediate node and the first output node under control of the second clock signal provided by the second clock signal line, and control connection between the first output node and the first-voltage line under control of a potential of the second output node; the second output node control circuit is electrically connected to the second clock signal line, the input terminal, a control voltage line, the first-voltage line, the second node, and the second output node, respectively, and is used to control connection between the second output node and the input terminal under control of the second clock signal provided by the second clock signal line, and control the potential of the second output node according to the potential of the second node, and control connection between the second output node and the first-voltage line under control of a control voltage provided by the control voltage line; the potential maintaining circuit is electrically connected to the first output node, and is used to maintain a potential of the first output node; the output circuit is electrically connected to the first output node, the second output node, the first-voltage line, the second-voltage line and the n-th stage driving signal output terminal, respectively, and is used to control connection between the n-th stage driving signal output terminal and the first-voltage line under control of the potential of the first output node, and to control connection between the n-th stage driving signal output terminal and the second-voltage line under control of the potential of the second output node;
or,
wherein the first output node control circuit includes a seventeenth transistor, an eighteenth transistor and a sixth capacitor; a gate electrode of the seventeenth transistor is electrically connected to the first clock signal line, a first electrode of the seventeenth transistor is electrically connected to the second-voltage line, and a second electrode of the seventeenth transistor is electrically connected to the first output node; a gate electrode of the eighteenth transistor is electrically connected to the second output node, a first electrode of the eighteenth transistor is electrically connected to the first clock signal line, and a second electrode of the eighteenth transistor is electrically connected to the first output node; a first electrode plate of the sixth capacitor is electrically connected to the first output node, and a second electrode plate of the sixth capacitor is electrically connected to the first-voltage line; the second output node control circuit includes a nineteenth transistor, a twentieth transistor, and a twenty-first transistor; the third energy storage circuit includes a seventh capacitor; a gate electrode of the nineteenth transistor is electrically connected to the first clock signal line, a first electrode of the nineteenth transistor is electrically connected to the input terminal, and a second electrode of the nineteenth transistor is electrically connected to the second output node; a gate electrode of the twentieth transistor is electrically connected to the first output node, a first electrode of the twentieth transistor is electrically connected to the first-voltage line, and a second electrode of the twentieth transistor is electrically connected to a first electrode of the twenty-first transistor; a gate electrode of the twenty-first transistor is electrically connected to the second clock signal line, and a second electrode of the twenty-first transistor is electrically connected to the second output node; a first electrode plate of the seventh capacitor is electrically connected to the second output node, and a second electrode plate of the seventh capacitor is electrically connected to the n-th stage driving signal output terminal; the output circuit includes a twenty-second transistor and a twenty-third transistor; a gate electrode of the twenty-second transistor is electrically connected to the first output node, a first electrode of the twenty-second transistor is electrically connected to the first-voltage line, and a second electrode of the twenty-second transistor is electrically connected to the n-th stage driving signal output terminal; a gate electrode of the twenty-third transistor is electrically connected to the second output node, a first electrode of the twenty-third transistor is electrically connected to the n-th stage driving signal output terminal, and a second electrode of the twenty-third transistor is electrically connected to the second clock signal line; the driving circuit further includes a twenty-fourth transistor; a second electrode of the twenty-first transistor is electrically connected to the second output node through the twenty-fourth transistor; a gate electrode of the twenty-fourth transistor is electrically connected to the second-voltage line, a first electrode of the twenty-fourth transistor is electrically connected to the second electrode of the twenty-first transistor, and the second electrode of the twenty-fourth transistor is electrically connected to the second output node.

6. The driving circuit according to claim 5, wherein the first control circuit includes a first control transistor, a second control transistor, a third control transistor and a fourth control transistor; the second control circuit includes a fifth control transistor and a sixth control transistor; the third control circuit includes a seventh control transistor and an eighth control transistor; the first energy storage circuit includes a first capacitor; and the second energy storage circuit includes a second capacitor;
a gate electrode of the first control transistor is electrically connected to the control signal terminal, a first electrode of the first control transistor is electrically connected to the first-voltage line, and a second electrode of the first control transistor is electrically connected to the first control output terminal;
a gate electrode of the second control transistor is electrically connected to the control signal terminal, a first electrode of the second control transistor is electrically connected to the first control output terminal, and a second electrode of the second control transistor is electrically connected to the second-voltage line;
a gate electrode of the third control transistor is electrically connected to the first control output terminal, a first electrode of the third control transistor is electrically connected to the first-voltage line, and a second electrode of the third control transistor is electrically connected to the control signal terminal;
a gate electrode of the fourth control transistor is electrically connected to the first control output terminal, a first electrode of the fourth control transistor is electrically connected to the control signal terminal, and a second electrode of the fourth control transistor is electrically connected to the second-voltage line;
a gate electrode of the fifth control transistor and a gate electrode of the sixth control transistor are both electrically connected to an n-th stage driving signal output terminal, a first electrode of the fifth control transistor is electrically connected to the first-voltage line, and a second electrode of the fifth control transistor is electrically connected to the second control output terminal;
a first electrode of the sixth control transistor is electrically connected to the second control output terminal, and a second electrode of the sixth control transistor is electrically connected to the first control output terminal;
a gate electrode of the seventh control transistor is electrically connected to the second control output terminal, a first electrode of the seventh control transistor is electrically connected to the first-voltage line, and a second electrode of the seventh control transistor is electrically connected to the n-th stage driving output terminal;
a gate electrode of the eighth control transistor is electrically connected to the second control output terminal, a first electrode of the eighth control transistor is electrically connected to the n-th stage driving output terminal, and a second electrode of the eighth control transistor is electrically connected to the second-voltage line;
a first electrode plate of the first capacitor is electrically connected to the second-voltage line, and a second electrode plate of the first capacitor is electrically connected to the control signal terminal;
a first electrode plate of the second capacitor is electrically connected to the second control output terminal, and a second electrode plate of the second capacitor is electrically connected to the second-voltage line;
the first control transistor, the third control transistor, the fifth control transistor and the seventh control transistor are all p-type transistors, and the second control transistor, the fourth control transistor, the sixth control transistor and the eighth control transistor are all n-type transistors;
or,
wherein the first control circuit includes a first control transistor, a second control transistor, a third control transistor and a fourth control transistor; the second control circuit includes a fifth control transistor and a sixth control transistor; the third control circuit includes a seventh control transistor and an eighth control transistor; the first energy storage circuit includes a first capacitor; and the second energy storage circuit includes a second capacitor; a gate electrode of the first control transistor is electrically connected to the control signal terminal, a first electrode of the first control transistor is electrically connected to the first-voltage line, and a second electrode of the first control transistor is electrically connected to the first control output terminal; a gate electrode of the second control transistor is electrically connected to the control signal terminal, a first electrode of the second control transistor is electrically connected to the first control output terminal, and a second electrode of the second control transistor is electrically connected to the second-voltage line; a gate electrode of the third control transistor is electrically connected to the first control output terminal, a first electrode of the third control transistor is electrically connected to the first-voltage line, and a second electrode of the third control transistor is electrically connected to the control signal terminal; a gate electrode of the fourth control transistor is electrically connected to the first control output terminal, a first electrode of the fourth control transistor is electrically connected to the control signal terminal, and a second electrode of the fourth control transistor is electrically connected to the second-voltage line; a gate electrode of the fifth control transistor and a gate electrode of the sixth control transistor are both electrically connected to the n-th stage driving signal output terminal, a first electrode of the fifth control transistor is electrically connected to the first control output terminal, and a second electrode of the fifth control transistor is electrically connected to the second control output terminal; a first electrode of the sixth control transistor is electrically connected to the second control output terminal, and a second electrode of the sixth control transistor is electrically connected to the second-voltage line; a gate electrode of the seventh control transistor is electrically connected to the second control output terminal, a first electrode of the seventh control transistor is electrically connected to the first-voltage line, and a second electrode of the seventh control transistor is electrically connected to the n-th stage driving output terminal; a gate electrode of the eighth control transistor is electrically connected to the second control output terminal, a first electrode of the eighth control transistor is electrically connected to the n-th stage driving output terminal, and a second electrode of the eighth control transistor is electrically connected to the second-voltage line; a first electrode plate of the first capacitor is electrically connected to the second-voltage line, and a second electrode plate of the first capacitor is electrically connected to the control signal terminal; a first electrode plate of the second capacitor is electrically connected to the second control output terminal, and a second electrode plate of the second capacitor is electrically connected to the second-voltage line; the first control transistor, the third control transistor, the fifth control transistor and the seventh control transistor are all p-type transistors, and the second control transistor, the fourth control transistor, the sixth control transistor and the eighth control transistor are all n-type transistors;
or,
wherein the control signal generating circuit includes a ninth control transistor and a tenth control transistor; a gate electrode of the ninth control transistor is electrically connected to the enable signal line, a first electrode of the ninth control transistor is electrically connected to the first-voltage line, and a second electrode of the ninth control transistor is electrically connected to the control signal terminal; a gate electrode of the tenth control transistor is electrically connected to the enable signal line, a first electrode of the tenth control transistor is electrically connected to the control signal terminal, and a second electrode of the tenth control transistor is electrically connected to the second-voltage line; the ninth control transistor is a p-type transistor, and the tenth control transistor is an n-type transistor;
or,
wherein the first node control circuit includes a first transistor, a second transistor and a third transistor; the second output node control circuit includes a fourth transistor, a fifth transistor, a sixth transistor and a seventh transistor; a gate electrode of the first transistor is electrically connected to the first clock signal line, a first electrode of the first transistor is electrically connected to the second-voltage line, and a second electrode of the first transistor is electrically connected to a first electrode of the third transistor; a gate electrode of the second transistor is electrically connected to a second electrode of the fourth transistor, a first electrode of the second transistor is electrically connected to the first clock signal line, and a second electrode of the second transistor is electrically connected to a first electrode of the third transistor; a gate electrode of the third transistor is electrically connected to the second-voltage line, and a second electrode of the third transistor is electrically connected to the first node; a gate electrode of the fourth transistor is electrically connected to the first clock signal line, and a first electrode of the fourth transistor is electrically connected to the input terminal; a gate electrode of the fifth transistor is electrically connected to the second-voltage line, a first electrode of the fifth transistor is electrically connected to a second electrode of the fourth transistor, and a second electrode of the fifth transistor is electrically connected to the second output node; a gate electrode of the sixth transistor and a first electrode of the sixth transistor are both electrically connected to the second node, and a second electrode of the sixth transistor is electrically connected to the second output node; a gate electrode of the seventh transistor is electrically connected to the control voltage line, a first electrode of the seventh transistor is electrically connected to the first-voltage line, and a second electrode of the seventh transistor is electrically connected to the first electrode of the fifth transistor; the second node control circuit includes an eighth transistor, a ninth transistor, a tenth transistor, an eleventh transistor and a third capacitor; a gate electrode of the eighth transistor is electrically connected to the second node, a first electrode of the eighth transistor is electrically connected to the second clock signal line, and a second electrode of the eighth transistor is electrically connected to the first intermediate node; a gate electrode of the ninth transistor is electrically connected to the second electrode of the first transistor, a first electrode of the ninth transistor is electrically connected to the first-voltage line, and a second electrode of the ninth transistor is electrically connected to the first intermediate node; a gate electrode of the tenth transistor is electrically connected to the first clock signal line, a first electrode of the tenth transistor is electrically connected to the input terminal, and a second electrode of the tenth transistor is electrically connected to a first electrode of the eleventh transistor; a gate electrode of the eleventh transistor is electrically connected to the second-voltage line, and a second electrode of the eleventh transistor is electrically connected to the second node; a first electrode plate of the third capacitor is electrically connected to the second node, and a second electrode plate of the third capacitor is electrically connected to the first intermediate node; the first output node control circuit includes a twelfth transistor, a thirteenth transistor, a fourteenth transistor and a fourth capacitor; a gate electrode of the twelfth transistor is electrically connected to the first node, a first electrode of the twelfth transistor is electrically connected to the second clock signal line, and a second electrode of the twelfth transistor is electrically connected to the second intermediate node; a gate electrode of the thirteenth transistor is electrically connected to the second clock signal line, a first electrode of the thirteenth transistor is electrically connected to the second intermediate node, and a second electrode of the thirteenth transistor is electrically connected to the first output node; a gate electrode of the fourteenth transistor is electrically connected to the first electrode of the fifth transistor, a first electrode of the fourteenth transistor is electrically connected to the first-voltage line, and a second electrode of the fourteenth transistor is electrically connected to the first output node; a first electrode plate of the fourth capacitor is electrically connected to the first node, and a second electrode plate of the fourth capacitor is electrically connected to the second intermediate node; the potential maintaining circuit includes a fifth capacitor; a first electrode plate of the fifth capacitor is electrically connected to the first output node, and a second electrode plate of the fifth capacitor is electrically connected to the first-voltage line; the output circuit includes a fifteenth transistor and a sixteenth transistor; a gate electrode of the fifteenth transistor is electrically connected to the first output node, a first electrode of the fifteenth transistor is electrically connected to the first-voltage line, and a second electrode of the fifteenth transistor is electrically connected to the n-th stage driving signal output terminal; a gate electrode of the sixteenth transistor is electrically connected to the second output node, a first electrode of the sixteenth transistor is electrically connected to the n-th stage driving signal output terminal, and a second electrode of the sixteenth transistor is electrically connected to the second-voltage line.

7. The driving circuit according to claim 6, wherein the control signal generating circuit includes a ninth control transistor, a tenth control transistor, an eleventh control transistor and a twelfth control transistor;
a gate electrode of the ninth control transistor is electrically connected to the (n−1)-th stage inverting signal output terminal, a first electrode of the ninth control transistor is electrically connected to the enable signal line, and a second electrode of the ninth control transistor is electrically connected to a first electrode of the eleventh control transistor;
a gate electrode of the tenth control transistor is electrically connected to the (n−1)-th stage driving signal output terminal, a first electrode of the tenth control transistor is electrically connected to the enable signal line, and a second electrode of the tenth control transistor is electrically connected to a first electrode of the eleventh control transistor;
a gate electrode of the eleventh control transistor is electrically connected to the n-th stage driving signal output terminal, and a second electrode of the eleventh control transistor is electrically connected to the control signal terminal;
a gate electrode of the twelfth control transistor is electrically connected to the n-th stage inverting signal output terminal, a first electrode of the twelfth control transistor is electrically connected to a first electrode of the eleventh control transistor, and a second electrode of the twelfth control transistor is electrically connected to the control signal terminal;
the ninth control transistor and the eleventh control transistor are p-type transistors, and the tenth control transistor and the twelfth control transistor are n-type transistors;
or,
wherein the control signal generating circuit includes a ninth control transistor, a tenth control transistor, an eleventh control transistor and a twelfth control transistor; a gate electrode of the ninth control transistor is electrically connected to the n-th stage inverting signal output terminal, a first electrode of the ninth control transistor is electrically connected to the enable signal line, and a second electrode of the ninth control transistor is electrically connected to a first electrode of the eleventh control transistor; a gate electrode of the tenth control transistor is electrically connected to the n-th stage driving signal output terminal, a first electrode of the tenth control transistor is electrically connected to the enable signal line, and a second electrode of the tenth control transistor is electrically connected to a first electrode of the eleventh control transistor; a gate electrode of the eleventh control transistor is electrically connected to the (n−1)-th stage driving signal output terminal, and a second electrode of the eleventh control transistor is electrically connected to the control signal terminal; a gate electrode of the twelfth control transistor is electrically connected to the (n−1)-th stage inverting signal output terminal, a first electrode of the twelfth control transistor is electrically connected to the first electrode of the eleventh control transistor, and a second electrode of the twelfth control transistor is electrically connected to the control signal terminal; the ninth control transistor and the eleventh control transistor are p-type transistors, and the tenth control transistor and the twelfth control transistor are n-type transistors.

8.-17. (canceled)

18. A display substrate, comprising: a base substrate and a driving circuit arranged on the base substrate;
wherein the display substrate includes a display area and a peripheral area; the driving circuit is arranged in the peripheral area;
wherein the driving circuit includes: a driving signal generating circuit, a control signal generating circuit and a control circuit;
wherein the driving signal generating circuit is electrically connected to an n-th stage driving signal output terminal, and is used to generate and output an n-th stage driving signal through the n-th stage driving signal output terminal; n is a positive integer;
the control signal generating circuit is electrically connected to an enable signal line and a control signal terminal, and is used to generate a control signal according to an enable signal provided by the enable signal line and output the control signal through the control signal terminal;
the control circuit is electrically connected to the control signal terminal, the n-th stage driving signal output terminal and an n-th stage driving output terminal respectively, and is used to output the n-th stage driving signal or invalid voltage signal to the n-th stage driving output terminal under control of the control signal.

19. The display substrate according to claim 18, wherein the driving circuit further includes an output inverting circuit;
the output inverting circuit is electrically connected to the n-th stage driving signal output terminal and an n-th stage inverting signal output terminal respectively, and is used to invert the n-th stage driving signal to obtain and output an n-th stage inverting driving signal through the n-th stage inverting signal output terminal;
the control signal generating circuit is further electrically connected to a (n−1)-th stage driving signal output terminal, an n-th stage inverting signal output terminal, an n-th stage driving signal output terminal and an n-th stage inverting signal output terminal, respectively, and is used to generate the control signal according to the enable signal under control of a (n−1)-th stage driving signal, a (n−1)-th stage inverting driving signal, an n-th stage driving signal and an n-th stage inverting driving signal;
the (n−1)-th stage driving signal output terminal is used to provide the (n−1)-th stage driving signal, and the (n−1)-th stage inverting signal output terminal is used to provide the (n−1)-th stage inverting driving signal;
or,
wherein the control signal generating circuit and the control circuit are arranged on a side of the driving signal generating circuit close to the display area.

20. The display substrate according to claim 19, wherein the control circuit in the driving circuit includes a first control circuit, a second control circuit, a third control circuit, a first energy storage circuit, and a second energy storage circuit;
the first control circuit is electrically connected to the control signal terminal, a first-voltage line, a second-voltage line and a first control output terminal respectively, and is used to invert the control signal to obtain an inverting control signal, and output the inverting control signal through the first control output terminal;
the second control circuit is electrically connected to the n-th stage driving signal output terminal, the first-voltage line, the first control output terminal and the second control output terminal respectively, and is used to control the second control output terminal to be coupled to the first-voltage line or the first control output terminal under control of the n-th stage driving signal; or, the second control circuit is electrically connected to the n-th stage driving signal output terminal, the first control output terminal, the second control output terminal and the second-voltage line respectively, and is used to control the second control output terminal to be coupled to the second-voltage line or the first control output terminal under control of the n-th stage driving signal;
the third control circuit is electrically connected to the second control output terminal, the first-voltage line, the second-voltage line and the n-th stage driving output terminal respectively, and is used to invert a signal output by the second control output terminal, and output an inverting signal through the n-th stage driving output terminal;
the first energy storage circuit is electrically connected to the control signal terminal and is used to maintain a potential of the control signal terminal;
the second energy storage circuit is electrically connected to the second control output terminal, and is used to maintain a potential of the second control output terminal;
or,
wherein the control circuit in the driving circuit includes a first control circuit, a second control circuit, a third control circuit, a fourth control circuit, and a second energy storage circuit;
the first control circuit is electrically connected to the control signal terminal, a first-voltage line, a second-voltage line and a first control output terminal respectively, and is used to invert the control signal to obtain an inverting control signal, and output the inverting control signal through the first control output terminal;
the second control circuit is electrically connected to the n-th stage driving signal output terminal, the first control output terminal, a second control output terminal and a second-voltage line respectively, and is used to control the second control output terminal to be connected to the second-voltage line or the first control output terminal under control of the n-th stage driving signal;
the third control circuit is electrically connected to the second control output terminal, the first-voltage line, the second-voltage line and the n-th stage driving output terminal respectively, and is used to invert a signal output by the second control output terminal, and output an inverting signal through the n-th stage driving output terminal;
the second energy storage circuit is electrically connected to the second control output terminal, and is used to maintain a potential of the second control output terminal.

21. (canceled)

22. The display substrate according to claim 20, wherein the driving signal generating circuit includes a first node control circuit, a second node control circuit, a first output node control circuit, a second output node control circuit, a potential maintaining circuit and an output circuit;
the first node control circuit is electrically connected to a first node, a first clock signal line, a second-voltage line and a second output node, respectively, and is used to control connection between the first node and the second-voltage line under control of a first clock signal provided by the first clock signal line, and to control connection or disconnection between the first node and the first clock signal line under control of a potential of the second output node;
the second node control circuit is electrically connected to the first node, a first intermediate node, a first-voltage line, a second clock signal line, a second node, an input terminal and a second-voltage line respectively, and is used to control connection between the first intermediate node and the first-voltage line under control of the potential of the first node, control connection between the first intermediate node and the second clock signal line under control of a potential of the second node, and control the potential of the second node according to the potential of the first intermediate node, and control connection between the input terminal and the second node under control of a second clock signal provided by the second clock signal line and a second-voltage signal provided by the second-voltage line;
the first output node control circuit is electrically connected to a first output node, the first node, the second clock signal line, a second intermediate node, a second output node and the first-voltage line respectively, and is used to control connection between the second intermediate node and the second clock signal line under control of a potential of the first node, control a potential of the second intermediate node according to the potential of the first node, control connection between the second intermediate node and the first output node under control of the second clock signal provided by the second clock signal line, and control connection between the first output node and the first-voltage line under control of a potential of the second output node;
the second output node control circuit is electrically connected to the second clock signal line, the input terminal, a control voltage line, the first-voltage line, the second node, and the second output node, respectively, and is used to control connection between the second output node and the input terminal under control of the second clock signal provided by the second clock signal line, and control the potential of the second output node according to the potential of the second node, and control connection between the second output node and the first-voltage line under control of a control voltage provided by the control voltage line;
the potential maintaining circuit is electrically connected to the first output node, and is used to maintain a potential of the first output node;
the output circuit is electrically connected to the first output node, the second output node, the first-voltage line, the second-voltage line and the n-th stage driving signal output terminal, respectively, and is used to control connection between the n-th stage driving signal output terminal and the first-voltage line under control of the potential of the first output node, and to control connection between the n-th stage driving signal output terminal and the second-voltage line under control of the potential of the second output node;
or,
wherein the driving signal generating circuit includes a first output node control circuit, a second output node control circuit, a third energy storage circuit and an output circuit;
the first output node control circuit is electrically connected to the first clock signal line, the second-voltage line, and the second output node, respectively, and is used to control connection between the first output node and the second-voltage line under control of the first clock signal provided by the first clock signal line, and control connection between the first output node and the first clock signal line under control of the potential of the second output node, and is used to maintain the potential of the first output node;
the second output node control circuit is electrically connected to the second output node, the first clock signal line, the input terminal, the second clock signal line, the first output node and the first-voltage line respectively, and is used to control connection between the second output node and the input terminal under control of the first clock signal, and control connection between the second output node and the first-voltage line under control of the potential of the first output node and a second clock signal provided by the second clock signal line;
a first end of the third energy storage circuit is electrically connected to the second output node, a second end of the third energy storage circuit is electrically connected to the n-th stage driving signal output terminal, and the third energy storage circuit is used to store electric energy;
the output circuit is electrically connected to the first output node, the second output node, the first-voltage line, the second clock signal and the n-th stage driving signal output terminal, respectively, and is used to control connection between the n-th stage driving signal output terminal and the first-voltage line under control of the potential of the first output node, and to control connection between the n-th stage driving signal output terminal and the second clock signal line under control of the potential of the second output node;
or,
wherein the first-voltage line includes a first first-voltage line and a second first-voltage line, and the second-voltage line includes a first second-voltage line and a second second-voltage line; an orthographic projection of at least part of active patterns of transistors included in the third control circuit onto the base substrate at least partially overlaps with an orthographic projection of the first first-voltage line onto the base substrate; the orthographic projection of at least part of active patterns of transistors included in the third control circuit onto the base substrate at least partially overlaps with an orthographic projection of the first second-voltage line onto the base substrate; the orthographic projection of the first second-voltage line onto the base substrate at least partially overlaps with an orthographic projection of active patterns of at least part of transistors included in the second control circuit onto the base substrate; the orthographic projection of the first second-voltage line onto the base substrate at least partially overlaps with an orthographic projection of an electrode plate of a capacitor included in the second energy storage circuit onto the base substrate; an orthographic projection of the second second-voltage line onto the base substrate at least partially overlaps with an orthographic projection of an electrode plate of a capacitor included in the first energy storage circuit onto the base substrate; the orthographic projection of the second second-voltage line onto the base substrate at least partially overlaps with an orthographic projection of active patterns of at least part of transistors included in the control signal generating circuit onto the base substrate; an orthographic projection of the enable signal line onto the base substrate at least partially overlaps with an orthographic projection of active patterns of at least part of transistors included in the control signal generating circuit onto the base substrate;
or,
wherein the second-voltage line further includes a third second-voltage line; an orthographic projection of the third second-voltage line onto the base substrate at least partially overlaps with an orthographic projection of an active pattern of at least one transistor included in the output inverter circuit onto the base substrate;
or,
wherein the first-voltage line includes a first first-voltage line and a second first-voltage line; an orthographic projection of the first first-voltage line onto the base substrate at least partially overlaps with an orthographic projection of active patterns of at least part of transistors included in the third control circuit onto the base substrate; an orthographic projection of the second first-voltage line onto the base substrate at least partially overlaps with an orthographic projection of active patterns of some transistors included in the first control circuit onto the base substrate; the orthographic projection of the second first-voltage line onto the base substrate at least partially overlaps with an orthographic projection of active patterns of some transistors included in the control signal generating circuit onto the base substrate; at least part of an orthographic projection of active patterns of at least part of transistors included in the output inverting circuit onto the base substrate is arranged between an orthographic projection of the second first-voltage line onto the base substrate and an orthographic projection of the enable signal line onto the base substrate;
or,
wherein an active pattern of at least part of transistors included in the third control circuit includes at least two active pattern portions that are independent of each other.

23.-25. (canceled)

26. The display substrate according to claim 22, wherein the first first-voltage line, the second first-voltage line, the first second-voltage line, the second second-voltage line and the enable signal line all extend along a first direction;
a width of the first first-voltage line along a second direction is greater than a width of the second first-voltage line along the second direction;
a width of the first second-voltage line along the second direction is greater than a width of the second second-voltage line along the second direction;
the first direction crosses the second direction;
or,
wherein the transistor included in the third control circuit is arranged on a side of the transistor included in the first control circuit close to the display area;
the transistor included in the third control circuit is arranged on a side of the transistor included in the second control circuit close to the display area; and
the transistor included in the control signal generating circuit is arranged on a side of the control circuit away from the display area;
or,
wherein the first-voltage line includes a third first-voltage line and a fourth first-voltage line; and the second-voltage line includes a third second-voltage line and a fourth second-voltage line; an orthographic projection of the third second-voltage line onto the base substrate at least partially overlaps with the orthographic projection of the active pattern of at least one transistor included in the output circuit onto the base substrate; an orthographic projection of the third first-voltage line onto the base substrate at least partially overlap with the orthographic projection of the active pattern of at least one transistor included in the output circuit on the base substrate; the orthographic projection of the third first-voltage line onto the base substrate at least partially overlaps with an orthographic projection of an electrode plate of a capacitor included in the potential maintaining circuit onto the base substrate; an orthographic projection of the fourth first-voltage line onto the base substrate at least partially overlaps with an orthographic projection of active patterns of at least part of transistors included in the second output node control circuit onto the base substrate;
or,
wherein an orthographic projection of the first clock signal line onto the base substrate at least partially overlaps with an orthographic projection of an electrode plate of a capacitor included in the first output node control circuit onto the base substrate; an orthographic projection of the second clock signal line onto the base substrate at least partially overlaps with an orthographic projection of an electrode plate of a capacitor included in the first output node control circuit onto the base substrate; the orthographic projection of the second clock signal line onto the base substrate at least partially overlaps with an orthographic projection of an electrode plate of a capacitor included in the second node control circuit onto the base substrate;
or,
wherein the output inverting circuit and the output circuit are arranged along a first direction; the potential maintaining circuit and the output circuit are arranged along the first direction; the output inverting circuit and the potential maintaining circuit are arranged along a second direction; transistors included in the output circuit are arranged in sequence along the first direction;
or,
wherein the second-voltage line includes a first second-voltage line, a second second-voltage line, and a third second-voltage line; an orthographic projection of the first second-voltage line onto the base substrate at least partially overlaps with an orthographic projection of active patterns of at least part of transistors included in the third control circuit onto the base substrate; an orthographic projection of the second second-voltage line onto the base substrate at least partially overlaps with an orthographic projection of active patterns of at least part of transistors included in the first control circuit onto the base substrate; the orthographic projection of the second second-voltage line onto the base substrate at least partially overlaps with an orthographic projection of an active pattern of at least part of transistors included in the control signal generating circuit onto the base substrate; the orthographic projection of the second second-voltage line onto the base substrate at least partially overlaps with an orthographic projection of an electrode plate of a capacitor included in the first energy storage circuit onto the base substrate; the orthographic projection of the second second-voltage line onto the base substrate at least partially overlaps with an orthographic projection of an electrode plate of a capacitor included in the second energy storage circuit onto the base substrate; an orthographic projection of the third second-voltage line onto the base substrate at least partially overlaps with an orthographic projection of active patterns of some transistors included in the control signal generating circuit onto the base substrate; the orthographic projection of the third second-voltage line onto the base substrate at least partially overlaps with an orthographic projection of active patterns of at least part of transistors included in the output circuit onto the base substrate.

27.-29. (canceled)

30. The display substrate according to claim 26, wherein
an orthographic projection of the fourth second-voltage line onto the base substrate at least partially overlaps with an orthographic projection of an electrode plate of a capacitor included in the second node control circuit onto the base substrate;
the orthographic projection of the fourth second-voltage line onto the base substrate at least partially overlaps with an orthographic projection of active patterns of at least part of transistors included in the first node control circuit onto the base substrate;
the orthographic projection of the fourth second-voltage line onto the base substrate at least partially overlaps with an orthographic projection of active patterns of at least part of transistors included in the second node control circuit onto the base substrate;
the orthographic projection of the fourth second-voltage line onto the base substrate at least partially overlaps with an orthographic projection of active patterns of at least part of transistors included in the second output node control circuit onto the base substrate.

31.-35. (canceled)

36. The display substrate according to claim 20, wherein the first-voltage line includes a first first-voltage line, and the second-voltage line includes a first second-voltage line;
an orthographic projection of the first second-voltage line onto the base substrate at least partially overlaps with an orthographic projection of an active pattern of at least part of transistors included in the third control circuit onto the base substrate;
an orthographic projection of the first first-voltage line onto the base substrate at least partially overlaps with an orthographic projection of an active pattern of at least part of transistors included in the third control circuit onto the base substrate;
the orthographic projection of the first first-voltage line onto the base substrate at least partially overlaps with an orthographic projection of an active pattern of at least part of transistors included in the second control circuit onto the base substrate;
the orthographic projection of the first first-voltage line onto the base substrate at least partially overlaps with an orthographic projection of an electrode plate of a capacitor included in the second energy storage circuit onto the base substrate;
or,
wherein the first-voltage line includes a first first-voltage line and a second first-voltage line, and the second-voltage line includes a first second-voltage line and a second second-voltage line; the first first-voltage line, the second first-voltage line, the first second-voltage line, and the second second-voltage line are arranged in sequence along a direction away from a display area; a width of the first first-voltage line along a second direction is greater than a width of the second first-voltage line along the second direction; a width of the first second-voltage line along the second direction is greater than a width of the second second-voltage line along the second direction; the first direction crosses the second direction;
or,
wherein at least two transistors included in the third control circuit are arranged sequentially along the second direction; at least one transistor included in the third control circuit and a capacitor included in the second energy storage circuit are arranged in sequence along the first direction.

37. The display substrate according to claim 36, wherein an orthographic projection of the enable signal line onto the base substrate at least partially overlaps with an orthographic projection of active patterns of at least part of transistors included in the control signal generating circuit onto the base substrate.

38.-39. (canceled)

40. The display substrate according to claim 22, wherein the first-voltage line includes a third first-voltage line, and the second-voltage line includes a third second-voltage line and a fourth second-voltage line;
an orthographic projection of the third second-voltage line onto the base substrate at least partially overlaps with an orthographic projection of an electrode plate of a capacitor included in the first output node control circuit onto the base substrate;
the orthographic projection of the third second-voltage line onto the base substrate at least partially overlaps with an orthographic projection of an electrode plate of a capacitor included in the third energy storage circuit onto the base substrate;
an orthographic projection of the fourth second-voltage line onto the base substrate at least partially overlaps with an orthographic projection of active patterns of at least part of transistors included in the first output node control circuit onto the base substrate;
or,
wherein an orthographic projection of the first clock signal line onto the base substrate at least partially overlaps with an orthographic projection of active patterns of at least part of transistors included in the second output node control circuit onto the base substrate;
an orthographic projection of the second clock signal line onto the base substrate at least partially overlaps with an orthographic projection of active patterns of at least part of transistors included in the second output node control circuit onto the base substrate;
or,
wherein the first-voltage line includes a third first-voltage line, and the second-voltage line includes a third second-voltage line and a fourth second-voltage line;
at least a portion of an electrode plate of a capacitor included in the first output node control circuit is disposed between the third second-voltage line and the third first-voltage line;
at least a portion of an electrode plate of a capacitor included in the third energy storage circuit is disposed between the third second-voltage line and the third first-voltage line;
or,
wherein the second-voltage line includes a first second-voltage line;
an orthographic projection of the first second-voltage line onto the base substrate at least partially overlaps with an orthographic projection of active patterns of at least part of transistors included in the third control circuit onto the base substrate;
or,
wherein the third control circuit includes an eighth control transistor;
the orthographic projection of the first second-voltage line onto the base substrate partially overlaps with an active pattern of the eighth control transistor;
a gate electrode of the eighth control transistor is electrically connected to the second control output terminal, a first electrode of the eighth control transistor is electrically connected to the n-th stage driving output terminal, and a second electrode of the eighth control transistor is electrically connected to the second-voltage line;
the active pattern of the eighth control transistor includes at least two active pattern parts independent of each other;
the at least two mutually independent active pattern portions are arranged in sequence along the second direction;
or,
wherein the first-voltage line includes a first first-voltage line;
an orthographic projection of the first first-voltage line onto the base substrate at least partially overlaps with an orthographic projection of an electrode plate of a capacitor included in the second energy storage circuit onto the base substrate;
the orthographic projection of the first first-voltage line onto the base substrate at least partially overlaps with an orthographic projection of an active pattern of at least part of transistors included in the first control circuit onto the base substrate;
the orthographic projection of the first first-voltage line onto the base substrate at least partially overlaps with an orthographic projection of active patterns of at least part of transistors included in the third control circuit onto the base substrate.

41.-45. (canceled)

46. The display substrate according to claim 40, wherein the first-voltage line further includes a second first-voltage line and a third first-voltage line;
the first first-voltage line, the second first-voltage line and the third first-voltage line all extend along a first direction;
a width of the first first-voltage line along a second direction is greater than a width of the second first-voltage line along the second direction;
a width of the first first-voltage line along the second direction is greater than a width of the third first-voltage line along the second direction;
the first direction crosses the second direction.

47. The display substrate according to claim 22, wherein the second-voltage line includes a second second-voltage line and a third second-voltage line, and the first-voltage line includes a second first-voltage line;
an orthographic projection of the second second-voltage line onto the base substrate at least partially overlaps with an orthographic projection of an active pattern of at least part of transistors included in the third control circuit onto the base substrate;
the orthographic projection of the second first-voltage line onto the base substrate at least partially overlaps with an orthographic projection of an active pattern of at least part of transistors included in the control signal generating circuit onto the base substrate;
the orthographic projection of the second first-voltage line onto the base substrate at least partially overlaps with an orthographic projection of an active pattern of at least part of transistors included in the second control circuit onto the base substrate;
an orthographic projection of the third second-voltage line onto the base substrate at least partially overlaps with an orthographic projection of an active pattern of at least part of transistors included in the control signal generating circuit onto the base substrate;
an orthographic projection of the enable signal line onto the base substrate at least partially overlaps with an orthographic projection of the electrode plate of the capacitor included in the third energy storage circuit onto the base substrate.

48. The display substrate according to claim 47, wherein the second-voltage line includes a first second-voltage line;
a width of the first second-voltage line along the second direction is greater than a width of the second second-voltage line along the second direction;
a width of the first second-voltage line along the second direction is greater than a width of the third second-voltage line along the second direction;
the first direction crosses the second direction;
or,
wherein the first-voltage line further includes a third first-voltage line;
at least a portion of an electrode plate of a capacitor included in the first output node control circuit is disposed between the enable signal line and the third first-voltage line;
at least a portion of an electrode plate of a capacitor included in the third energy storage circuit is disposed between the enable signal line and the third first-voltage line.

49. (canceled)

50. The display substrate according to claim 18, wherein an active pattern of a transistor included in the driving circuit is formed in a first semiconductor layer; or,
an active pattern of a p-type transistor included in the driving circuit is formed in a first semiconductor layer, and an active pattern of an n-type transistor included in the driving circuit is formed in a second semiconductor layer.

51. (canceled)

52. A display device, comprising: the display substrate according to claim 18.
